(19) United States
(12) Patent Application Publication
(10) Pub. No.: US 2024/0172785 A1
(43) Pub. Date: May 30, 2024

(54) METHODS OF USING PROTEIN INGREDIENTS TO MAKE DOUGHS, BAKED PRODUCTS, SOUPS, BEVERAGES, AND SNACKS

(71) Applicant: Cella Farms Inc., San Ramon, CA (US)

(72) Inventors: Baljit GHOTRA, San Ramon, CA (US); Monica BHATIA, San Ramon, CA (US); Shantanu AGARWAL, Schaumburg, IL (US); Simarata DHILLON, Tracy, CA (US); Sebastien CANONNE, Lake Zurich, IL (US)

(21) Appl. No.: 18/517,543

(22) Filed: Nov. 22, 2023

Related U.S. Application Data
(60) Provisional application No. 63/428,014, filed on Nov. 25, 2022.

(51) Int. Cl. A23L 31/10; A21D 2/26; A21D 13/064; A23L 33/14

(52) U.S. Cl. CPC A23L 31/10; A21D 2/267; A21D 13/064; A23L 33/14

(57) ABSTRACT

Provided are compositions comprising microbially derived proteins obtained from the fermentation of biomass and methods for producing high-protein food compositions derived from said compositions. The disclosure also provides compositions and methods to increase the protein nutritional quality score of a food composition while maintaining traditional food forms. Also disclosed are methods for producing protein powders with tailored water holding capacity to provide properties similar to conventional food ingredients.

### CROSS-REFERENCE TO RELATED APPLICATIONS

This application claims benefit of priority to U.S. Provisional Patent Application No. 63/428,014, filed Nov. 25, 2022, the disclosure of which is incorporated herein by reference in its entirety for all purposes.

### FIELD

The field of this disclosure is directed to food compositions comprising fermented plant biomass and microbially derived proteins that increase the protein nutritional quality score of said food composition while maintaining traditional food organoleptic properties. Also disclosed are methods for producing protein powders with tailored physical properties, e.g., water holding capacity of proteins, to provide properties similar to conventional comestibles.

### BACKGROUND

Dietary protein is an essential nutrient for human health and growth. The World Health Organization (WHO) recommends that dietary protein should contribute approximately 10 to 15% of energy intake when in energy balance and weight stable. Average daily protein intakes in various countries indicate that these recommendations are consistent with the amount of protein being consumed worldwide. Meals with an average of 20 to 30% of energy from protein are representative of high-protein diets when consumed in energy balance.

The human body cannot synthesize certain amino acids that are necessary for health and growth, and instead must obtain them from food. These amino acids, called “essential amino acids” (EAA), are Histidine (H), Isoleucine (I), Leucine (L), Lysine (K), Methionine (M), Phenylalanine (F), Threonine (T), Tryptophan (W), and Valine (V). Other categories of amino acids are “non-essential amino acid” (NEAA) and “conditionally essential amino acid” (CEAA). A NEAA is an amino acid selected from Alanine (A), Arginine (R), Asparagine (N), Aspartic Acid (D), Glutamine (Q), Glutamic Acid (E), Glycine (G), Proline (P), and Serine (S). A CEAA is an amino acid selected from Cysteine (C) and Tyrosine (Y).

The minimum fractions of each essential amino acid that make up a healthy adult diet provide a metric against which dietary protein sources can be measured. For example, the fractions can be used to measure how well a dietary protein source meets the nutritional protein needs of humans, by targeting nutritionally balanced amino acid percentages. The World Health Organization (WHO) has developed a method for ranking the nutritional quality of a protein that compares the amino acid profile of the specific food protein against the amino acid requirements for human health. This method assigns a nutritional value to the protein called the “Protein Digestibility Corrected Amino Acid Score” (PDCAAS). The WHO has slightly revised the PDCAAS standard, giving the revised standard the name “Digestible Indispensable Amino Acid Score (DIAAS)”.

Dietary proteins that provide all the essential amino acids are referred to as “high quality” proteins. Animal foods such as meat, fish, poultry, eggs, and dairy products are generally regarded as high-quality protein sources that provide a good balance of essential amino acids. The current methods to produce high quality protein, as found in animal food, generally involve a high carbon footprint, large land use, and significant consumption of water resources.

In contrast, foods that do not provide a good balance of essential amino acids are referred to as “low quality” proteins. Most fruits and vegetables are poor sources of protein and generally require less resources to produce compared to animal foods. While some plant foods, including beans, peas, lentils, nuts and grains (such as wheat) are better sources of protein, many of these foods are high in carbohydrates.

Much of the world's population receives caloric intake through food products that are rich in carbohydrates and low in protein, such as breads, rice, sandwiches, pitas, pizzas, pastas, doughs, desserts, and processed foods. Many of these foods are traditional and culturally important. Consequently, a gap exists to provide high quality protein in a way that does not consume significant resources and maintains traditional food forms.

### SUMMARY

The present disclosure solves the aforementioned problem of providing high quality protein in traditionally consumed food products.

In one aspect, provided herein is method for producing a protein powder using an aqueous extraction method comprising: (a) mixing a protein of interest obtained from a biomass in water at a defined ratio to generate a slurry comprising the protein of interest; and (b) subjecting the slurry to one or more of: (i) adding an acid or base to adjust the pH of the slurry to a desired pH; (ii) altering the temperature of the slurry to a desired temperature; (iii) adding a salt to the slurry to a desired % of salt in the slurry; (iv) milling the slurry in order to shear the protein of interest in the slurry; or (v) adding one or more hydrolases to the slurry in order to hydrolyze biological components of the slurry that include the protein of interest and carbohydrates, thereby generating a protein powder comprising a modified protein. In one embodiment, the method for producing the protein powder using an aqueous extraction method comprises: (a) mixing a protein of interest obtained from a biomass in water at a defined ratio to generate a slurry comprising the protein of interest; and (b) subjecting the slurry to one or more of: (i) adding an acid or base to adjust the pH of the slurry to a desired pH; (ii) altering the temperature of the slurry to a desired temperature; (iii) adding a salt to the slurry to a desired % of salt in the slurry; (iv) milling the slurry in order to shear the protein of interest in the slurry; (v) adding one or more hydrolases to the slurry in order to hydrolyze biological components of the slurry that include the protein of interest and carbohydrates or (vi) mixing the slurry with an oil in order to coat the protein with the oil, thereby generating a protein powder comprising a modified protein. In some cases, the desired pH is from pH 3 to 10.5. In some cases, the desired temperature is 70, 75, 80, 85, 90 or 95 degrees Celsius. In some cases, the slurry is incubated at the desired temperature for at least 30 minutes. In some cases, the desired % of salt is 5% w/w, wherein the salt is sodium chloride or sodium sulfate. In some cases, the one or more hydrolases is/are selected from the group consisting of amylase, protease, xylanase, cellulase and any combination thereof. In some cases, the slurry is incubated with the one or more hydrolases for at least 1 hour. In some cases, the method further comprises testing the water holding capacity (WHC) of the modified protein and repeating steps (a) and (b) until a desired WHC of the modified protein is achieved. In some cases, the desired WHC is from 80 g to 300 g of water per 100 g of the modified protein. In some cases, the method further comprises filtering the slurry to recover solids comprising the modified protein and drying the modified protein following the filtering in order to produce the protein powder comprising the modified protein. In some cases, the defined ratio of protein to water is 1:1, or 1:2, 1:3, 1:4, 1:5, 1:6, 1:7, 1:8, 1:9, 1:10, 1:11, 1:12, 1:13, 1:14, 1:15 or 1:16, 1:17, 1:18, 1:19, or 1:20 w/w. In some cases, the defined ratio of protein to water is 1:10 w/w. In some cases, the protein of interest is selected from the group consisting of an animal protein, a plant protein, a microbial protein and any combination thereof. In some cases, the protein of interest is an animal protein selected from the group consisting of a diary protein, gelatin, eggs and muscle. In some cases, the protein of interest is an animal protein obtained, derived or isolated from a mammal, an insect, a reptile, a bird or a fish. In some cases, the protein of interest is a plant protein obtained, derived or isolated from an angiosperm, gymnosperm, fern or multicellular algae. In some cases, the protein obtained from the biomass is a microbial protein obtained from a microbe in a microbial biomass. In some cases, the microbial protein is obtained from the microbial biomass following the fermentation of a plant biomass by the microbe in the microbial biomass. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae, Saccheromycopsis filbugera, and Kluyveromyces marxianus. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a species of bacterium selected from the group consisting of Lactobacillus, Bacillus, Bifidobacterium, Clostridium, Enterococcus, Corynebacterium and any combination thereof. In some cases, the bacterium is Corynebacterium glutamicum. In some cases, the bacterium is Clostridium acetobutylicum. In some cases, the biomass is a plant biomass. In some cases, the plant biomass is selected from the group consisting of a food crop, an extract of a food crop, seaweed, plankton, phytoplankton, grass crops, agricultural crop waste and residues, spent grain from ethanol production, or spent grain from breweries, spent yeast or microbial biomass from fermented products manufacturing facilities, trees, woody energy crops and wood waste and residue. In some cases, the food crop is selected from the group consisting of sugarcane, wheat, tubers, vegetables, lentils, kelp, legumes, soybeans, rice, potato, oats, pea, cassava and maize. In some cases, the agricultural crop waste and residue is selected from the group consisting of corn stover, wheat straw, rice straw and sugar cane bagasse. In some cases, the wood waste and residue is selected from the group consisting of softwood forest matter, barky wastes, sawdust, paper and pulp industry waste streams and wood fiber.

In another aspect, provided herein is a powder comprising a protein with a desired property, wherein the desired property is a water holding capacity (WHC) selected from the group consisting of at least 80 grams (g) of water per 100 g of powder, at least 85 g of water per 100 g of the powder, at least 90 g of water per 100 g of the powder, at least 95 g of water per 100 g of the powder, at least 100 g of water per 100 g of the powder, at least 105 g of water per 100 g of the powder, at least 110 g of water per 100 g of the powder, at least 115 g of water per 100 g of the powder, at least 120 g of water per 100 g of the powder, at least 125 g of water per 100 g of the powder, at least 130 g of water per 100 g of the powder and from 80 to 150 grams (g) of water per 100 g of powder. In one embodiment, provided herein is a powder comprising a protein with a desired property, wherein the desired property is a water holding capacity (WHC) of at least 80 grams (g) of water per 100 g of powder. In some cases, the protein has a WHC of at least 85 g of water per 100 g of the powder. In some cases, the protein has a WHC of at least 90 g of water per 100 g of the powder. In some cases, the protein has a WHC of at least 95 g of water per 100 g of the powder. In some cases, the protein has a WHC of at least 100 g of water per 100 g of the powder. In some cases, the protein has a WHC of at least 105 g of water per 100 g of the powder. In some cases, the protein has a WHC of at least 110 g of water per 100 g of the powder. In some cases, the protein comprises a WHC of at least 115 g of water per 100 g of the powder. In some cases, the protein comprises a WHC of at least 120 g of water per 100 g of the powder. In some cases, the protein comprises a WHC of at least 125 g of water per 100 g of the powder. In some cases, the protein comprises a WHC of at least 130 g of water per 100 g of the powder. In some cases, the protein comprises a WHC of from 80 to 150 grams (g) of water per 100 g of powder.

In some cases, the powder comprises at least 70%, at least 75%, at least 80%, at least 85%, at least 90%, at least 95%, at least 99% of the protein with the desired property by weight (w/w). In some cases, the powder consists of 100% of the protein with the desired property by weight (w/w). In some cases, the protein is selected from the group consisting of an animal protein, a plant protein, a microbial protein and any combination thereof. In some cases, the protein is an animal protein selected from the group consisting of a diary protein, gelatin, eggs and muscle. In some cases, the protein is an animal protein obtained, derived or isolated from a mammal, an insect, a reptile, a bird or a fish. In some cases, the protein is a plant protein obtained, derived or isolated from an angiosperm, gymnosperm, fern or multicellular algae. In some cases, the protein is a microbial protein obtained, derived or isolated from the fermentation of biomass by a microbe. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae, Saccheromycopsis filbugera, and Kluyveromyces marxianus. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a bacterium selected from the group consisting of a Lactobacillus bacterium, a Bacillus bacterium, a Bifidobacterium bacterium, a Clostridium bacterium, an Enterococcus bacterium, a Corynebacterium bacterium and any combination thereof. In some cases, the bacterium is Corynebacterium glutamicum, Clostridium acetobutylicum or a combination thereof. In some cases, the bacterium is Corynebacterium glutamicum. In some cases, the bacterium is Clostridium acetobutylicum. In some cases, the biomass is spent yeast or microbial biomass from fermented products manufacturing facilities. In some cases, the biomass is a plant biomass. In some cases, the plant biomass is selected from the group consisting of a food crop, an extract of a food crop, seaweed, plankton, phytoplankton, grass crops, agricultural crop waste and residues, spent grain from ethanol production, or spent grain from breweries, trees, woody energy crops and wood waste and residue. In some cases, the food crop is selected from the group consisting of sugarcane, wheat, tubers, vegetables, lentils, kelp, legumes, soybeans, rice, potato, oats, pea, cassava and maize. In some cases, the agricultural crop waste and residue is selected from the group consisting of corn stover, wheat straw, rice straw and sugar cane bagasse. In some cases, the wood waste and residue is selected from the group consisting of softwood forest matter, barky wastes, sawdust, paper and pulp industry waste streams and wood fiber. In some cases, the powder comprises 5, 6, 7, 8, 9, 10, 11, 12, 13, 14, 15, 16, 17, 18, 19, 20, 21, 22, 23, 24, 25, 26, 27, 28, 29 or 30 grams (g) of the protein per serving. In some cases, the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). In some cases, the protein comprises a Solvent Retention Capacity (SRC) of at least 60%, at least 70%, at least 80%, at least 90% or at least 100%. In some cases, the protein comprises a SRC of at least 70%. In some cases, the protein comprises a SRC of at least 100%. In some cases, the protein comprises a Protein Digestibility-Corrected Amino Acid Score (PDCAAS) of at least 0.6, at least 0.7, at least 0.8, at least 0.9 or at least 1.0. In some cases, the protein comprises a PDCAAS of 0.6. In some cases, the protein comprises a PDCAAS of 0.7. In some cases, the protein comprises a PDCAAS of 0.8. In some cases, the protein comprises a PDCAAS of 0.9. In some cases, the protein comprises a PDCAAS of 1. In some cases, the protein comprises an amino acid distribution profile of between 15% to 50% branched chain amino acids (BCAAs). In some cases, the protein comprises an amino acid distribution profile of between 20% to 50% branched chain amino acids (BCAAs). In some cases, the protein comprises an amino acid distribution profile of between 25% to 50% branched chain amino acids (BCAAs). In some cases, the protein comprises an amino acid distribution profile of between 20% to 50% essential amino acids (EAAs). In some cases, the protein comprises an amino acid distribution profile of between 25% to 50% essential amino acids (EAAs).

In yet another aspect, provided herein is a composition comprising a flour and a protein powder comprises a protein with a desired property, wherein the desired property is a water holding capacity (WHC) of at least 80 grams (g) of water per 100 g of protein powder. In some cases, the flour and the protein powder are present at a ratio of flour to protein powder of 1:0.05, 1:0.10, 1:0.15, 1:0.20, 1:0.25, 1:0.30, 1:0.35, 1:0.40, 1:0.45, 1:0.5, 1:0.6, 1:0.7, 1:0.8, 1:0.9, 1:1, 1.5:1, 2:1, 3:1, 4:1 or 5:1. In some cases, the flour and the protein powder are present at a ratio of flour to protein powder that produces a WHC that is from 100% to 150% of the WHC of the flour alone. In some cases, the composition comprises a water absorption that is 104-110% of control composition, wherein the control composition comprises the flour without the protein powder. In some cases, the protein powder is any protein powder provided herein. In some cases, the composition comprises a Solvent Retention Capacity (SRC) of at least 60%, at least 70%, at least 80%, at least 90% or at least 100%. In some cases, the composition comprises a SRC of at least 70%. In some cases, the composition comprises a SRC of at least 100%. In some cases, the method further comprises a liquid. In some cases, the liquid is water. In some cases, the liquid comprises an emulsifier. In some cases, the emulsifier or stabilizer is selected from the group consisting of acacia, acetic acid esters, ammonium phosphatide, baker's yeast glycan, brominated vegetable oil, carboxymethylcellulose, carrageenan, diacetyl tartaric acid esters, dextrin, guar gum, lactic acid esters, lecithin (soy and egg), magnesium stearate, mono and diglycerides, phosphates, polyglycerol esters, polysorbate 60, polysorbate 65, polysorbate 80 (P80), propylene glycol esters of fatty acids, sodium stearolyllactylate (SSL), sorbitan monostearate, sucrose acetate isobutyrate, sucrose fatty acid ester and xanthum gum. In some cases, the emulsifier is lecithin obtained from plant, animal or microbial sources. In some cases, the protein in the protein powder has a WHC of at least 85 g of water per 100 g of the protein powder. In some cases, the protein in the protein powder has a WHC of at least 90 g of water per 100 g of the protein powder. In some cases, the protein in the protein powder has a WHC of at least 95 g of water per 100 g of the protein powder. In some cases, the protein in the protein powder has a WHC of at least 100 g of water per 100 g of the protein powder. In some cases, the protein in the protein powder has a WHC of at least 105 g of water per 100 g of the protein powder. In some cases, the protein in the protein powder has a WHC of at least 110 g of water per 100 g of the protein powder. In some cases, the protein in the protein powder comprises a WHC of at least 115 g of water per 100 g of the protein powder. In some cases, the protein in the protein powder comprises a WHC of at least 120 g of water per 100 g of the protein powder. In some cases, the protein in the protein powder comprises a WHC of at least 125 g of water per 100 g of the protein powder. In some cases, the protein in the protein powder comprises a WHC of at least 130 g of water per 100 g of the protein powder. In some cases, the protein in the protein powder comprises a WHC of from 80 to 150 grams (g) of water per 100 g of protein powder. In some cases, the protein powder comprises at least 70%, at least 75%, at least 80%, at least 85%, at least 90%, at least 95%, at least 99% of the protein with the desired property by weight (w/w). In some cases, the protein powder consists of 100% of the protein with the desired property by weight (w/w). In some cases, the protein in the protein powder is selected from the group consisting of an animal protein, a plant protein, a microbial protein and any combination thereof. In some cases, the protein in the protein is an animal protein selected from the group consisting of a diary protein, gelatin, eggs and muscle. In some cases, the protein in the protein is an animal protein obtained, isolated or derived from a mammal, an insect, a reptile, a bird and a fish. In some cases, the protein in the protein is a plant protein obtained, derived or isolated from an angiosperm, gymnosperm, fern or multicellular algae. In some cases, the protein in the protein is a microbial protein obtained, derived or isolated from the fermentation of biomass by a microbe. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae, Saccheromycopsis filbugera, and Kluyveromyces marxianus. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a species of bacterium selected from the group consisting of Lactobacillus, Bacillus, Bifidobacterium, Clostridium, Enterococcus, Corynebacterium and any combination thereof. In some cases, the bacterium is Corynebacterium glutamicum. In some cases, the bacterium is Clostridium acetobutylicum. In some cases, the biomass is a plant biomass. In some cases, the plant biomass is selected from the group consisting of a food crop, an extract of a food crop, seaweed, plankton, phytoplankton, grass crops, agricultural crop waste and residues, spent grain from ethanol production, or spent grain from breweries, spent yeast or microbial biomass from fermented products manufacturing facilities, trees, woody energy crops and wood waste and residue. In some cases, the food crop is selected from the group consisting of sugarcane, wheat, tubers, vegetables, lentils, kelp, legumes, soybeans, rice, potato, oats, pea, cassava and maize. In some cases, the agricultural crop waste and residue is selected from the group consisting of corn stover, wheat straw, rice straw and sugar cane bagasse. In some cases, the wood waste and residue is selected from the group consisting of softwood forest matter, barky wastes, sawdust, paper and pulp industry waste streams and wood fiber. In some cases, the protein powder comprises 5, 6, 7, 8, 9, 10, 11, 12, 13, 14, 15, 16, 17, 18, 19, 20, 21, 22, 23, 24, 25, 26, 27, 28, 29 or 30 grams (g) of the protein per serving. In some cases, the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). In some cases, the protein powder comprises a Solvent Retention Capacity (SRC) of at least 60%, at least 70%, at least 80%, at least 90% or at least 100%. In some cases, the protein powder comprises a SRC of at least 70%. In some cases, the protein powder comprises a SRC of at least 100%. In some cases, the composition comprises a Solvent Retention Capacity (SRC) of at least 60%, at least 70%, at least 80%, at least 90% or at least 100%. In some cases, the composition comprises a SRC of at least 70%. In some cases, the composition comprises a SRC of at least 100%. In some cases, the protein powder comprises a Protein Digestibility-Corrected Amino Acid Score (PDCAAS) of at least 0.6, at least 0.7, at least 0.8, at least 0.9 or at least 1.0. In some cases, the protein comprises a PDCAAS of 0.6. In some cases, the protein powder comprises a PDCAAS of 0.7. In some cases, the protein powder comprises a PDCAAS of 0.8. In some cases, the protein powder comprises a PDCAAS of 0.9. In some cases, the protein powder comprises a PDCAAS of 1. In some cases, the protein powder comprises an amino acid distribution profile of between 15% to 50% branched chain amino acids (BCAAs). In some cases, the protein powder comprises an amino acid distribution profile of between 20% to 50% branched chain amino acids (BCAAs). In some cases, the protein powder comprises an amino acid distribution profile of between 25% to 50% branched chain amino acids (BCAAs). In some cases, the protein powder comprises an amino acid distribution profile of between 20% to 50% essential amino acids (EAAs). In some cases, the protein powder comprises an amino acid distribution profile of between 25% to 50% essential amino acids (EAAs). In some cases, the composition comprises a PDCAAS of 0.8. In some cases, the composition comprises a PDCAAS of 0.9. In some cases, the composition comprises a PDCAAS of 1. In some cases, the composition comprises an amino acid distribution profile of between 20% to 50% branched chain amino acids (BCAAs). In some cases, the composition comprises an amino acid distribution profile of between 25% to 50% branched chain amino acids (BCAAs). In some cases, the composition comprises an amino acid distribution profile of between 20% to 50% essential amino acids (EAAs). In some cases, the composition comprises an amino acid distribution profile of between 25% to 50% essential amino acids (EAAs).

In one aspect, provided herein is a method of producing a food product, the method comprising: (a) mixing a comestible, a liquid and a protein powder into a homogeneous composition, wherein the protein powder has a water holding capacity (WHC) that is at least 80%, at least 85%, at least 90%, at least 95%, at least 100%, at least 110%, at least 120%, at least 130%, at least 140% or at least 150% of the WHC of the comestible; (b) leavening the composition; and (c) heating the composition, thereby producing the food product, wherein the food product has organoleptic properties that are the same as a control, wherein the control is a leavened food product comprising the comestible and the liquid without the protein powder. In some cases, the protein powder has a WHC that is selected form the group consisting of 100% of the WHC of the comestible, 150% of the WHC of the comestible and from 100% to 150% of the WHC of the comestible. In some cases, the protein powder comprises a WHC that is 100% of the WHC of the comestible. In some cases, the protein powder comprises a WHC that is 150% of the WHC of the comestible. In some cases, the protein powder comprises a WHC that is from 100% to 150% of the WHC of the comestible. In some cases, the protein powder comprises protein selected from the group consisting of an animal protein, a plant protein, a microbial protein and any combination thereof. In some cases, the protein in the protein powder is a microbial protein obtained, derived or isolated from the fermentation of biomass by a microbe. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae, Saccheromycopsis filbugera, and Kluyveromyces marxianus. In some cases, the filamentous fungus is a species of filamentous fungus selected from the group consisting of Aspergillus, Fusarium, Rhizopus or Mucor. In some cases, the filamentous fungus is Aspergillus niger. In some cases, the microbe is a bacterium selected from the group consisting of a Lactobacillus bacterium, a Bacillus bacterium, a Bifidobacterium bacterium, a Clostridium bacterium, an Enterococcus bacterium, a Corynebacterium bacterium and any combination thereof. In some cases, the bacterium is Corynebacterium glutamicum. In some cases, the bacterium is Clostridium acetobutylicum. In some cases, the biomass is a plant biomass obtained from grains, seeds, tubers, roots, stalks, shoots or other agricultural byproducts. In some cases, the liquid is water. In some cases, the liquid comprises an emulsifier. In some cases, the emulsifier or stabilizer is selected from the group consisting of acacia, acetic acid esters, ammonium phosphatide, baker's yeast glycan, brominated vegetable oil, carboxymethylcellulose, carrageenan, diacetyl tartaric acid esters, dextrin, guar gum, lactic acid esters, lecithin (soy and egg), magnesium stearate, mono and diglycerides, phosphates, polyglycerol esters, polysorbate 60, polysorbate 65, polysorbate 80 (P80), propylene glycol esters of fatty acids, sodium stearolyllactylate (SSL), sorbitan monostearate, sucrose acetate isobutyrate, sucrose fatty acid ester and xanthum gum. In some cases, the emulsifier is lecithin obtained from plant, animal or microbial sources. In some cases, the food product comprises a Solvent Retention Capacity (SRC) of at least 60%, at least 70%, at least 80%, at least 90% or at least 100%. In some cases, the food product comprises a SRC of at least 70%. In some cases, the food product comprises a SRC of at least 100%. In some cases, the food product comprises a Protein Digestibility-Corrected Amino Acid Score (PDCAAS) of at least 0.6, at least 0.7, at least 0.8, at least 0.9 or at least 1.0. In some cases, the food product comprises a PDCAAS of 0.6. In some cases, the food product comprises a PDCAAS of 0.7. In some cases, the food product comprises a PDCAAS of 0.8. In some cases, the food product comprises a PDCAAS of 0.9. In some cases, the food product comprises a PDCAAS of 1. In some cases, the food product comprises an amino acid distribution profile selected from the group consisting of between 15% to 50% branched chain amino acids (BCAAs), between 25% to 50% branched chain amino acids (BCAAs), between 20% to 50% essential amino acids (EAAs) and between 25% to 50% essential amino acids (EAAs). In some cases, the food product comprises an amino acid distribution profile of between 15% to 50% branched chain amino acids (BCAAs). In some cases, the food product comprises an amino acid distribution profile of between 25% to 50% branched chain amino acids (BCAAs). In some cases, the food product comprises an amino acid distribution profile of between 20% to 50% essential amino acids (EAAs). In some cases, the food product comprises an amino acid distribution profile of between 25% to 50% essential amino acids (EAAs). In some cases, the protein powder comprises a Protein Digestibility-Corrected Amino Acid Score (PDCAAS) of at least 0.6, at least 0.7, at least 0.8, at least 0.9 or at least 1.0. In some cases, the protein comprises a PDCAAS of 0.6. In some cases, the protein powder comprises a PDCAAS of 0.7. In some cases, the protein powder comprises a PDCAAS of 0.8. In some cases, the protein powder comprises a PDCAAS of 0.9. In some cases, the protein powder comprises a PDCAAS of 1. In some cases, the protein powder comprises an amino acid distribution profile of between 15% to 50% branched chain amino acids (BCAAs). In some cases, the protein powder comprises an amino acid distribution profile of between 20% to 50% branched chain amino acids (BCAAs). In some cases, the protein powder comprises an amino acid distribution profile of between 25% to 50% branched chain amino acids (BCAAs). In some cases, the protein powder comprises an amino acid distribution profile of between 20% to 50% essential amino acids (EAAs). In some cases, the protein powder comprises an amino acid distribution profile of between 25% to 50% essential amino acids (EAAs). In some cases, the comestible and the protein powder are present at a ratio of comestible to protein powder of 1:0.05, 1:0.10, 1:0.15, 1:0.20, 1:0.25, 1:0.30, 1:0.35, 1:0.40, 1:0.45, 1:0.5, 1:0.6, 1:0.7, 1:0.8, 1:0.9, 1:1, 1.5:1, 2:1, 3:1, 4:1 or 5:1. In some cases, the food product comprises from 20% to 30% energy derived from protein per serving. In some cases, the food product comprises at least 5%, at least 10%, at least 15%, at least 20%, at least 25%, at least 30%, at least 35%, at least 40%, at least 45% or at least 50% more protein per serving than a control, wherein the control is a food product comprising the comestible and the liquid but lacking the protein powder. In some cases, the food product comprises from 5% to 50% more protein per serving than a control, wherein the control is a food product comprising the comestible and the liquid but lacking the protein powder. In some cases, the food product comprises at least 2 times, at least 3 times, at least 4 times, at least 5 time, at least 6 times, at least 7, at least 8 times, at least 9 times or at least 10 times more protein per serving than a control, wherein the control is a food product comprising the comestible and the liquid but lacking the protein powder. In some cases, the comestible is a dough or flour. In some cases, the dough is a yeast leavened or a chemically leavened dough. In some cases, the food product is a breading mix, a soup, a shake, a batter or tortilla. In some cases, the food product is bread, wherein the bread comprises at least 9 grams of protein per serving. In some cases, the food product is bread, wherein the bread comprises at least 10 grams of protein per serving. In some cases, the serving is 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). In some cases, the serving is 56 g. In some cases, the method further comprises heating the food product following step (b), thereby producing a baked food product. In some cases, the baked food product comprises the same texture or organoleptic properties as a control, wherein the control is a baked food product comprising the comestible and the liquid but lacking the protein powder. In some cases, the organoleptic properties are selected from the group consisting of crust, crumb, oven spring, compression, moisture, shelf-life/staling, and rheology.

In still another aspect, provided herein is a bread comprising a protein obtained from a microbe, wherein the protein has a water holding capacity (WHC) of at least 80 g of water per 100 g of protein. In some cases, the protein has WHC of 82 g of water per 100 g of protein. In some cases, the WHC of the protein is modified prior to addition dough that produces the bread by altering the pH, temperature or salt concentration of a microbial biomass comprising the protein. In some cases, the protein is obtained from the microbe following fermentation of a plant biomass by the microbe. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae, Saccheromycopsis filbugera, and Kluyveromyces marxianus. In some cases, the plant biomass is obtained from flour, grains, seeds, tubers, roots, stalks, shoots or other agricultural byproducts. In some cases, the bread comprises 5, 6, 7, 8, 9, 10, 11, 12, 13, 14, 15, 16, 17, 18, 19, 20, 21, 22, 23, 24, 25, 26, 27, 28, 29 or 30 grams (g) of total protein per serving. In some cases, the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). In some cases, the bread comprises 9 g of total protein per serving, wherein the serving is selected from the group consisting of 48 g, 51 g and 56 g. In some cases, the bread comprises 10 g of total protein per serving, wherein the serving is selected from the group consisting of 48 g, 51 g, and 56 g. In some cases, the bread comprises 14 g of carbohydrate per serving, wherein the serving is 48 g. In some cases, the bread comprises 10 g of protein per serving. In some cases, the bread comprises 10 g of protein and 14 g of carbohydrate per serving, wherein the serving is 48 g. In some cases, the bread comprises 15 g of carbohydrate per serving, wherein the serving is 51 g. In some cases, the bread comprises 10 g of protein per serving. In some cases, the bread comprises 10 g of protein with 15 g carbohydrate per serving, wherein the serving is 51 g.

In one aspect, provided herein is a pasta comprising a protein obtained from a microbe, wherein the water holding capacity (WHC) of the protein is no greater than 144 g of water per 100 g of protein. In some cases, the pasta consists essentially of, consists of or comprises at least 10%, 11%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% w/w of the protein obtained from the microbe. In some cases, the pasta consists essentially of, consists of or comprises from 10%-15%, from 15%-20%, from 20%-25%, from 25%-30%, from 30%-35%, from 35%-40%, from 40%-45% or from 45%-50% w/w of the protein obtained from the microbe. In some cases, the pasta further comprises a fiber. In some cases, the pasta comprises 3, 3.5, 4, 4.5, 5, 5.5, 6, 6.5, 7, 7.5, 8, 8.5, 9, 9.5 or 10% w/w. In some cases, the protein content of the pasta is greater than 17%. In some cases, the PDCAAS value of the pasta is greater than 0.7. In some cases, after cooking the pasta the content of carbohydrates in the pasta is not greater than 64 grams of carbohydrates per 100 grams of cooked pasta. In some cases, the loss of weight occurring when the pasta is cooked is not greater than 6.5 percent. In some cases, firmness and al dente chewing properties of the pasta are retained when the cooking time of the pasta is extended longer than a recommended cooking time when the pasta is cooked at a desired temperature in water. In some cases, the cooking time is extended by greater than 1%, 2%, 3%, 4%, 5%, 6%, 7%, 8%, 9%, 10%, 11%, 12%, 13%, 14%, 15%, 20%, 25%, 30%, 35%, 40%, 45%, 50%, 55%, 60%, 65%, 70%, 75%, 80%, 85%, 90%, 95%, 99% or 100% of the recommended cooking time. In some cases, the cooking time is extended by between 1%-5%, between 5%-10%, between 15%-20%, between 20%-25%, between 25%-30%, between 30%-35%, between 35%-40%, between 40%-45%, between 45%-50%, between 50%-55%, between 55%-60%, between 60%-65%, between 65%-70%, between 70%-75%, between 75%-80%, between 80%-85%, between 85%-90%, between 90%-95%, or between 95%-100% of the recommended cooking time. In some cases, the recommended cooking time is the cooking time required to reach optimal or desired al dente properties. In some cases, the desired temperature is boiling. In some cases, firmness of the pasta is greater than 600 grams, 605 grams, 610 grams, 615 grams, 620 grams, 625 grams, 630 grams, 635 grams, 640 grams, 645 grams, 650 grams, 655 grams, 660 grams, 665 grams or 670 grams after cooking in boiling water for a desired period of time. In some cases, firmness of the pasta is between 600 grams-610 grams, between 610 grams-620 grams, between 620 grams-630 grams, between 630 grams-640 grams, between 640 grams-650 grams, between 650 grams-660 grams or between 660 grams-670 grams after cooking in boiling water for a desired period of time. In some cases, the shear value of the pasta is between 50-55 g/cm, between 55-60 g/cm, between 60-65 g/cm, between 65-70 g/cm, between 70-75 g/cm, between 75-80 g/cm, between 80-85 g/cm, between 85-90 g/cm, between 90-95 g/cm, between 95-100 g/cm, between 100-105 g/cm, between 105-110 g/cm, between 115-120 g/cm, between 120-125 g/cm, between 125-130 g/cm, between 130-135 g/cm, between 135-140 g/cm, between 140-145 g/cm, between 145-150 g/cm, between 150-155 g/cm, between 155-160 g/cm, between 165-170 g/cm or between 170-175 g/cm after cooking in boiling water for a desired period of time. In some cases, the shear value of the pasta is at least 50 g/cm, at least 55 g/cm, at least 60 g/cm, at least 65 g/cm, at least 70 g/cm, at least 75 g/cm, at least 80 g/cm, at least 85 g/cm, at least 90 g/cm, at least 95 g/cm, or at least 100 g/cm after cooking in boiling water for a desired period of time. In some cases, the shear value of the pasta is greater than 90 g/cm after cooking in boiling water for a desired period of time. In some cases, the desired period of time is 3, 4, 5, 6, 7, 8, 9, 10, 11, 12, 13, 14 or 15 minutes. In some cases, the desired period of time is between 3-5 minutes, between 5-7 minutes, between 7-9, between 9-11, between 11-13 minutes or between 13-15 minutes. In some cases, the pasta further comprises a PDCAAS value at least 0.7, at least 0.75, at least 0.80, at least 0.85, at least 0.9, at least 0.95 or at least 1. In some cases, the pasta further comprising a PDCAAS value between 0.7-0.80, between 0.80-0.85, between 0.85-0.9, between 0.9-0.95 or between 0.95-1. In some cases, the pasta further comprises a PDCAAS value greater than 0.7. In some cases, the pasta comprises an amino acid distribution profile of between 15% to 50% or between 25% to 50% branched chain amino acids (BCAAs). In some cases, the protein content is at least 5, 10, 15, 20, 25, 30, 35, 40, 45, 50 or 55 g/serving. In some cases, the protein content is 8 g or 25 g per/serving. In some cases, the serving is 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). In some cases, the serving is 56 g. In some cases, the pasta is resistant to excessive swelling of starch in the pasta.

In yet another aspect, provided herein is powder comprising a protein with a desired property, wherein the desired property is an amino acid distribution profile of between 15% to 50%, and wherein the protein is obtained from a non-animal source. In some cases, the protein possesses a WHC selected from the group consisting of at least 85 g of water per 100 g of the protein powder, at least 90 g of water per 100 g of the protein powder, at least 95 g of water per 100 g of the protein powder, at least 100 g of water per 100 g of the protein powder, at least 105 g of water per 100 g of the protein powder, at least 110 g of water per 100 g of the protein powder, at least 115 g of water per 100 g of the protein powder, at least 120 g of water per 100 g of the protein powder, at least 125 g of water per 100 g of the protein powder, at least 130 g of water per 100 g of the protein powder and from 80 to 150 grams (g) of water per 100 g of protein powder. In some cases, the protein is a plant protein, a microbial protein or a combination thereof. In some cases, the protein is a plant protein obtained or isolated from an angiosperm, gymnosperm or fern. In some cases, the protein is a microbial protein obtained or isolated from the fermentation of biomass by a microbe. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae. In some cases, the microbe is a bacterium selected from the group consisting of a Lactobacillus bacterium, a Bacillus bacterium, a Bifidobacterium bacterium, a Clostridium bacterium, an Enterococcus bacterium, a Corynebacterium bacterium and any combination thereof. In some cases, the bacterium is Corynebacterium glutamicum, Clostridium acetobutylicum or a combination thereof. In some cases, the biomass is spent yeast or microbial biomass from fermented products manufacturing facilities. In some cases, the biomass is a plant biomass. In some cases, the plant biomass is selected from the group consisting of a food crop, an extract of a food crop, seaweed, plankton, phytoplankton, grass crops, agricultural crop waste and residues, spent grain from ethanol production, or spent grain from breweries, trees, woody energy crops and wood waste and residue. In some cases, the food crop is selected from the group consisting of sugarcane, wheat, tubers, vegetables, lentils, kelp, legumes, soybeans, rice, potato, oats, pea, cassava and maize. In some cases, the agricultural crop waste and residue is selected from the group consisting of corn stover, wheat straw, rice straw and sugar cane bagasse. In some cases, the wood waste and residue is selected from the group consisting of softwood forest matter, barky wastes, sawdust, paper and pulp industry waste streams and wood fiber. In some cases, the powder comprises 5, 6, 7, 8, 9, 10, 11, 12, 13, 14, 15, 16, 17, 18, 19, 20, 21, 22, 23, 24, 25, 26, 27, 28, 29 or 30 grams (g) of the protein per serving. In some cases, the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). In some cases, the protein has a Solvent Retention Capacity (SRC) of at least 60%, at least 70%, at least 80%, at least 90% or at least 100%. In some cases, the protein has a Protein Digestibility-Corrected Amino Acid Score (PDCAAS) of at least 0.6, at least 0.7, at least 0.8, at least 0.9 or at least 1.0. In some cases, the protein comprises an amino acid distribution profile of between 20% to 50% or between 25% to 50% essential amino acids (EAAs).

### BRIEF DESCRIPTION OF THE FIGURES

FIG. 1 shows a bread and dough produced by the methods of the present disclosure using protein powder as provided herein to produce high protein bread. The high protein bread is indistinguishable from a normal bread and the dough is suitable for application in a bakery.

FIG. 2 shows a nutritional label for Dave's Killer Bread-White Bread Done Right.

FIG. 3 shows a nutritional label for Sara Lee Artesano Bread.

FIG. 4 shows a nutritional label for Baker's Field Flour & Bread.

FIG. 5 illustrates quantity of water in grams (g) per 100 g of protein held by a control protein as well as proteins that are components of the protein powders provided herein (i.e., Cella proteins 1 & 2).

FIGS. 6A-6C illustrates the impact of external environment variables (i.e., salt, pH and temperature) as discussed in Example 1 on protein hydration. FIG. 6A depicts non-aggregated protein that has high water hydration. FIG. 6B depicts aggregated protein that is highly effective for protein densification. FIG. 6C depicts aggregated protein with emulsifying properties.

FIGS. 7A-7C illustrate examples of dough with different hydration levels including optimal hydration (FIG. 7A), under hydration (FIG. 7B) and protein with supplemental protein (i.e., “High Protein Dough”) with optimum hydration in an industrial mixer (FIG. 7C).

FIGS. 8A-8D illustrate dough characteristics of dough with different levels of chickpea flour. FIG. 8A shows dough with 100% wheat flour, while FIG. 8B shows dough with 90% wheat flour and 10% chickpea flour, FIG. 8C shows dough with 80% wheat flour and 20% chickpea flour and FIG. 8D shows dough with 70% wheat flour and 30% chickpea flour.

FIGS. 9A-9H illustrate bread loafs volume, crust color and crumb structure with varying levels of chickpea flour. FIGS. 9A & 9E shows dough with 100% wheat flour, while FIGS. 9B & 9F shows dough with 90% wheat flour and 10% chickpea flour, FIGS. 9C & 9G shows dough with 80% wheat flour and 20% chickpea flour and FIGS. 9D & 9H shows dough with 70% wheat flour and 30% chickpea flour.

FIGS. 10A-10B illustrate doughs supplemented with a protein powder provided herein (FIG. 10A; good hydration) and a pea protein isolate (FIG. 10B; over hydration that prevents formation of gluten matrix).

FIGS. 11A-11B illustrate the crumb structure of bread supplemented with a protein powder provided herein (FIG. 11A) and a pea protein isolate (FIG. 11B).

FIGS. 12A-12C illustrate examples of adding protein powder as provided herein to breading/batter mix to create coating that adheres to various surfaces in order to boost protein profile to the food product and reduce loss of moisture. FIG. 12A shows batter mixes of control and test samples, FIG. 12B shows control or test fried onion rings and FIG. 12C shows good surface adhesion of test batter on breaded chicken tenders. (Control=Store purchased batter mix; Test=batter mix supplemented with protein powder as provided herein).

FIGS. 13A-13E illustrate examples of adding protein powder as provided herein to tortilla dough without impacting sheeting properties. FIG. 13A shows picture of dough balls, FIG. 13B shows rolled out dough balls, FIG. 13C shows pressed dough balls, FIG. 13D shows tortillas while heating and FIG. 13E shows tortillas after heating.

FIG. 14 illustrates gluten-free cake supplemented with a protein powder provided herein.

FIG. 15 illustrates bread dough supplemented with a protein powder as provided herein or a control (i.e., same dough without supplementation the protein powder as provided herein) after mixing.

FIG. 16 illustrates bread dough supplemented with a protein powder as provided herein (test) or a control (i.e., same dough without supplementation the protein powder as provided herein) after pan proofing.

FIG. 17 illustrates bread supplemented with a protein powder as provided herein (test) or a control (i.e., same dough without supplementation the protein powder as provided herein) after baking.

FIG. 18 illustrates a cross section of either bread supplemented with a protein powder (test) as provided herein or a control (i.e., same dough without supplementation the protein powder as provided herein) after baking.

FIG. 19 illustrates a cross section of either bread supplemented with a protein powder (test) as provided herein or a control (i.e., same dough without supplementation the protein powder as provided herein) after baking showing little to no difference in final finished product quality as a result of different methods used to make and bake said breads.

FIG. 20 illustrates bread rise in seeded bread made with (test) or without supplementation with a protein powder as provided herein. No difference was distinguishable.

FIG. 21 illustrates nutritional labels for either original (Sample 1) or seeded (Sample 2) bread supplemented with a protein powder as provided herein.

FIGS. 22A-22B illustrate the nutritional report including an amino acid analysis on the Sample 1 bread (FIG. 22A) or Sample 2 bread (FIG. 22B) from FIG. 21 based on Analytical testing performed by Medallion Labs (Minneapolis, MN). FIG. 22C shows the analytical tests used to analyze Samples 1 and 2.

FIGS. 23A-23B illustrate the fatty acid analysis on the Sample 1 bread (FIG. 23A) or Sample 2 bread (FIG. 23B) from FIG. 21 based on Analytical testing performed by Medallion Labs (Minneapolis, MN).

FIG. 24 illustrates the in vitro Protein Digestibility Corrected Amino Acid Score (PDCAAS) analytical results for Bread Sample 1 from FIG. 21.

FIG. 25 illustrates the in vitro PDCAAS analytical results for Bread Sample 2 from FIG. 21.

FIG. 26 illustrates firmness analysis for pasta prepared with a protein powder provided showing how firmness changes with use of increasing amounts of said protein powder (Cella protein).

FIGS. 27A-27C illustrates a color analysis for pasta prepared with a protein powder provided herein (Cella protein) compared to control pasta prepared without said protein powder provided herein showing that increasing concentrations of said protein showed increasingly lighter color (FIG. 27A), increasing redness in color (FIG. 27B) and decreased yellowness and increased blue-grey tone (FIG. 27C) as compared to said control pasta.

FIG. 28 illustrates an analysis of the firmness vs. protein content for pasta prepared with a protein powder provided herein (Cella protein) in either grams (g) (left panel) or grams/centimeter (g·cm) (right panel).

FIG. 29 illustrates the cooking weight and cooking loss for pasta prepared with a protein powder provided herein (Cella protein). As shown in the left panel, use of greater than 14% of the Cella protein in pasta (measured in samples containing up to 30% Cella protein) showed decreased cook weight. As shown in the right panel, use of greater than 14% of the Cella protein in pasta (measured in samples containing up to 30% Cella protein) showed decreased cook loss, while pasta containing up to 14% Cella protein showed increased cooking loss.

FIG. 30 illustrates the firmness & thickness analysis for pasta prepared with a protein powder provided herein (Cella protein). As shown in the top, left panel, use of up to 14% of the Cella protein in pasta showed decreased firmness in grams (g). As shown in the top, right panel, use of greater than 14% of the Cella protein in pasta showed increased shear in g/cm, while pasta containing greater than 14% Cella protein showed decreased thickness in mm (see bottom, middle panel).

FIGS. 31A-31C illustrate color vs. protein content for pasta prepared with a protein powder provided herein (Cella protein) compared to control pasta prepared without said protein powder provided herein showing that increasing concentrations of total protein showed increasingly lighter color (FIG. 31A), increasing redness in color (FIG. 31B) and decreased yellowness and increased blue-grey tone (FIG. 31C) as compared to said control pasta.

FIG. 32 illustrates an analysis of the firmness vs. total protein for pasta prepared with a protein powder provided herein (Cella protein) in either grams (g) (left panel) or grams/centimeter (g·cm) (right panel).

FIG. 33 illustrates the cook weight and cooking loss for pasta prepared with a protein powder provided herein (Cella protein). As shown in the left panel, pasta with greater than 26% of the Cella protein in pasta (measured in samples containing up to 47% total protein) showed decreased cook weight. As shown in the right panel, pasta with greater than 25% of total protein in pasta (measured in samples containing up to 47% Cella protein) showed decreased cook loss, while pasta containing up to 25% total protein showed increased cooking loss.

FIG. 34 illustrates the firmness and thickness analysis for pasta prepared with a protein powder provided herein (Cella protein). As shown in the top, left panel, pasta with greater than 25% of total protein showed increased firmness in grams (g). As shown in the top, right panel, pasta with up to 25% of total protein showed decreased firmness in g/cm, while pasta containing greater than 25% total protein showed decreased thickness in mm (see bottom, middle panel).

FIG. 35 illustrates an analysis of the components of a protein powder as provided herein (Cella protein 2).

FIG. 36 illustrates an analysis of the components of blend comprising a protein powder as provided herein.

FIG. 37 illustrates nutritional labels for either plain (Left) or multi-grain (Right) bread supplemented with a protein powder as provided herein.

FIG. 38 illustrates the firmness of pasta made with greater than 20 g Cella Proteins (e.g., Cella protein 2) and cooked at a boil for either 5 minutes, 6 minutes, 6 minutes and 30 seconds, 7 minutes, 7 minutes and 30 seconds, 8 minutes, 8 minutes and 30 seconds, 9 minutes, 9 minutes and 30 seconds or 12 minutes.

### DETAILED DESCRIPTION

### Definitions

Unless defined otherwise herein, all technical and scientific terms used herein shall have the meanings that are commonly understood by those of ordinary skill in the art to which the present disclosure belongs.

The term “microorganism” can include, but is not limited to, bacteria, viruses, fungi, algae, yeasts, protozoa, worms, spirochetes, single-celled, and multi-celled organisms that are included in classification schema as prokaryotes, eukaryotes, Archaea, and Bacteria, and those that are known to those skilled in the art.

The term “plant” can include the class of higher and lower plants including angiosperms (monocotyledonous and dicotyledonous plants), gymnosperms, ferns, and multicellular algae. It includes plants of a variety of ploidy levels, including aneuploid, polyploid, diploid, haploid and hemizygous.

The term “computer” can refer to a machine comprising a processor, a memory, and an operating system, capable of interaction with a user or other computer, and shall include without limitation desktop computers, notebook computers, laptop computers, processors, servers, personal digital assistants (PDAs), tablet computers, handheld computers, and similar devices that store data.

The term “cloud” may be used as a metaphor to refer to the internet and storing information, e.g., genomic sequences, in an off-site online system that is accessible via a computing device.

The term “in silico method” can refer to a method of using a computer or computer algorithm to model a naturally occurring (in vivo) or in vitro process, and in some aspects, to improve or predict a protein quality score.

The term “prokaryote” can refer to non-eukaryotic organisms belonging to the Eubacteria (e.g., Escherichia coli, Thermus thermophilus, etc.) and Archaea (e.g., Methanococcus jannaschii, Methanobacterium thermoautotrophicum, Halobacterium spp., Archaeoglobus fulgidus, Pyrococcus furiosus, Pyrococcus horikoshii, Aeropyrum pernix, etc.) phylogenetic domains.

The term “eukaryote” can refer to organisms belonging to the phylogenetic domain Eucarya such as animals (e.g., mammals, insects, reptiles, birds, etc.), ciliates, plants, fungi (e.g., yeasts, etc.), flagellates, microsporidia, protists, etc.

The term “unknown organism” can refer to an organism having an unknown phenotype, an unknown genomic sequence, or lacking a scientific name. An unknown organism may be used for training, and samples of the unknown organism obtained elsewhere may be identified by the method. A system trained on an unknown organism may be used either to identify the unknown organism when it occurs in a sample, or to exclude the unknown organism. In an aspect, a plurality of unknown organisms may be used to train the system and subsequent samples may be categorized so as to select an organism from the plurality of unknown organisms. Some of the phenotypes may also be associated with known genotypes. In this manner, samples of, for example, soil, may be scanned so as to identify only those organisms of a single species, or only organisms of an unknown species of a group of unknown species.

The term “PDCAAS” can refer to a Protein Digestibility-Corrected Amino Acid Score. The traditional PDCAAS method can be the one most commonly used today to estimate the protein quality of food intended for human consumption by providing a protein quality score. The PDCAAS evaluates the quality of proteins according to two criteria: the essential amino acid requirements of human beings and the digestibility of proteins.

The term “IVPDCAAS” can refer to an in vitro Protein Digestibility-Corrected Amino Acid Score. The IVPDCAAS can be based on the traditional PDCAAS method and incorporates in vitro tests as a surrogate to animal measurements. In one example, the PDCAAS-4-Enz method is shown to have a high R2 (0.9649) when correlated with in vivo measurements, (Tavano et al, “In vitro versus in vivo protein digestibility techniques for calculating PDCAAS (protein-digestibility corrected amino acid score) applied to chickpea fractions”, Food Research International, Vol 89, No v 2016). This shows that in vivo measurements can be correlated with in vitro measurements, hence allowing in vitro measurements to be used in analyzing the accuracy of in silico analyses. The k-PDCAAS method is another method for accurate determination of in vitro PDCAAS and is used by labs such as Medallion Labs, see in vitro PDCAAS Megazyme kit protocol. U.S. Pat. No. 9,700,071B2 demonstrates that the maximum PDCAAS is 3.61.

The term “DIAAS” can refer to Digestible Indispensable Amino Acid Score and can be calculated as recommended by the Food and Agriculture Organization of the United Nations using equation DIAAS (%)=100 c lowest value of the DIAA reference ratio. For example, a score of <75% is a low protein quality score, 75-99% is a good protein quality score, and ≥ 100% is an excellent protein quality score. This in vivo DIAAS is normally performed in pigs.

The term “IVDIAAS” can refer to an in vitro Digestible Indispensable Amino Acid Score. The IVDIAAS can be based on the traditional DIAAS method and incorporates in vitro tests as a surrogate to animal measurements. In vitro DIAAS can be performed via a simulated enzymatic digestion procedure and can be provided by labs such as Wageningen Food Research labs.

The term “amino acid score” (AAS) can be a measure of the nutritional quality of a protein that may be calculated with the following formula: AAS=(mg of first limiting amino acid in 1 g test protein) divided by (mg of the same amino acid in 1 g reference protein).

The term “Amino Acid Profile” can refer to the total protein, total nitrogen content, and percent of amino acids present in the sample. The measurement of total protein and nitrogen can be performed using the Dumas method preferably, or alternatively the Kjeldahl method.

The term “comestible” can refer to any article of food or an edible composition or ingredient. For example, a comestible may comprise flour or dough.

The term “pasta” can refer to a comestible comprising dough made from flour and water that is stamped into various shapes and typically cooked in boiling water. In some embodiments, a pasta comprises, but is not limited to, spaghetti, angel hair, fusilli, farfalle, pappardelle, orecchiette, rigatoni, ravioli, manicotti, tagliatelle, trofie, and/or gigli. In some embodiments, pasta refers to pizza.

The term “baked food” can refer to a comestible that has been baked in an oven. In some embodiments, a baked food comprises, but is not limited to, cakes, cookies, brownies, biscuits, and bread.

The term “tortilla” can refer to a flat comestible comprising cornmeal or flour.

The term “breading” can refer to a coating of a comestible around a food product. In some embodiments, breading is a batter at is applied to a food product and then fried in oil.

The term “shake” can refer to a liquid mixed with a comestible. In some embodiments, the comestible is a protein powder of the current disclosure.

The term “high-protein” as used in reference to any comestible, ingredient or powder as provided herein can refer to any comestible, ingredient or powder as provided herein that comprises 5, 6, 7, 8, 9, 10, 11, 12, 13, 14, 15, 16, 17, 18, 19, 20, 21, 22, 23, 24, 25, 26, 27, 28, 29 or 30 grams (g) of protein per serving. In some cases, the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). The term “high-protein” as used in reference to any comestible, ingredient or powder as provided herein can also refer to any comestible, ingredient or powder as provided herein that comprises at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100% of protein by weight per serving. The term “high-protein” as used in reference to any comestible, ingredient or powder as provided herein can also refer to any comestible, ingredient or powder as provided herein that comprises at most 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100% of protein by weight per serving. The term “high-protein” as used in reference to any comestible, ingredient or powder as provided herein can also refer to any comestible, ingredient or powder as provided herein that comprises about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% or 100% of protein by weight per serving.

The term “biomass” can refer to any renewable, organic matter. The various types of biomass can include, but are not limited to, plant biomass and microbial biomass.

The term “plant biomass” as used herein can refer to any plant-derived organic matter (woody or non-woody). Plant biomass can include, but is not limited to, agricultural or food crops (e.g., sugarcane, wheat including wheat flour, tubers, vegetables, lentils, kelp, legumes, soybeans, or corn), food waste valorization, seaweed, plankton (e.g., macroplankton, mesoplankton, microplankton, nanoplankton, picoplankton, and femptoplankton), phytoplankton, or an extract therefrom (e.g., sugar from sugarcane and corn starch from corn), agricultural crop wastes and residues such as corn stover, wheat straw, rice straw, sugar cane bagasse, and the like. Plant biomass further includes, but is not limited to, trees, woody energy crops, wood wastes and residues such as softwood forest matter, barky wastes, sawdust, paper and pulp industry waste streams, wood fiber, and the like. Additionally, grass crops, such as switchgrass and the like have potential to be produced on a large-scale as another plant biomass source.

The term “fungal biomass” as used herein can refer to organic matter derived from a mass of a fungus that has been cultured, fermented, or grown by any suitable process.

The term “microbial biomass” as used herein can refer to organic matter derived from naturally occurring or genetically modified unicellular organisms and/or multicellular organisms, e.g., organisms from the ocean, lakes, bodies of water, e.g., salt water or fresh water, or on land, and that contains a source of carbohydrate (e.g., cellulose). Microbial biomass can include, but is not limited to, for example protists (e.g., animal (e.g., protozoa such as flagellates, amoeboids, ciliates, and sporozoa) and plant (e.g., algae such alveolates, chlorarachniophytes, cryptomonads, euglenids, glaucophytes, haptophytes, red algae, stramenopiles, and viridaeplantae)), bacteria (e.g., gram positive bacteria, gram negative bacteria, and extremophiles), yeast and/or mixtures of these. In some embodiments, microbial biomass can be obtained from natural sources, e.g., the ocean, lakes, bodies of water, e.g., salt water or fresh water, or on land. Alternatively, or in addition, microbial biomass can be obtained from culture systems, e.g., large scale dry and wet culture systems.

The term “fermentation” can refer to the process of transforming organic matter into different matter using a micro-organism. For example, “fermentation” can refer to transforming sugars or other molecules from biomass to produce alcohols (e.g., ethanol, methanol, butanol); organic acids (e.g., citric acid, acetic acid, itaconic acid, lactic acid, gluconic acid); ketones (e.g., acetone), amino acids (e.g., glutamic acid); gases (e.g., H₂ and CO₂), antibiotics (e.g., penicillin and tetracycline); enzymes; and/or vitamins (e.g., riboflavin, B₁₂, beta-carotene).

The term “plant fermentation matter” as used herein can refer to plant biomass transformed into different matter using a micro-organism such as, for example, microbially produced protein. An example of microbially produced protein comprises high-protein, microbially derived protein powder produced from fermented biomass using methods described in co-pending US provisional patent application U.S. 63/428,014, filed Nov. 25, 2022, which is incorporated by reference in its entirety for all purposes.

The term “fungal fermentation matter” as used herein can refer to fungal biomass transformed into different matter using a micro-organism.

The term “microbial fermentation matter” as used herein can refer to microbial biomass transformed into different matter using a micro-organism.

The term “starch” as used herein can refer to a polymer of glucose readily hydrolyzed by digestive enzymes, e.g., amylases. Starch is usually concentrated in specialized portions of plants, such as potatoes, corn kernels, rice grains, wheat grains, and sugar cane stems.

The term “lignin” as used herein can refer to a polymer material, mainly composed of linked phenolic monomeric compounds, such as p-coumaryl alcohol, coniferyl alcohol, and sinapyl alcohol, which forms the basis of structural rigidity in plants and is frequently referred to as the woody portion of plants. Lignin is also considered to be the non-carbohydrate portion of the cell wall of plants.

The term “cellulose” as used herein can refer to a long-chain polymer polysaccharide carbohydrate of β-glucose of formula (C6H10O5)n, usually found in plant cell walls in combination with lignin and any hemicellulose.

The term “hemicellulose” as used herein can refer to a class of plant cell-wall polysaccharides that can be any of several heteropolymers. These include xylan, xyloglucan, arabinoxylan, arabinogalactan, glucuronoxylan, glucomannan and galactomannan. Monomeric components of hemicellulose include, but are not limited to: D-galactose, L-galactose, D-rnannose, L-rhamnose, L-fucose, D-xylose, L-arabinose, and D-glucuronic acid. This class of polysaccharides is found in almost all cell walls along with cellulose. Hemicellulose is lower in weight than cellulose and cannot be extracted by hot water or chelating agents but can be extracted by aqueous alkali. Polymeric chains of hemicellulose bind pectin and cellulose in a network of cross-linked fibers forming the cell walls of most plant cells.

The term “pectin” as used herein can refer to a class of plant cell-wall heterogeneous polysaccharides that can be extracted by treatment with acids and chelating agents. Typically, 70-80% of pectin is found as a linear chain of ?-(1-4)-linked D-galacturonic acid monomers. The smaller RG-I fraction of pectin is comprised of alternating (1-4)-linked galacturonic acid and (1-2)-linked L-rhamnose, with substantial arabinogalactan branching emanating from the rhamnose residue. Other monosaccharides, such as D-fucose, D-xylose, apiose, aceric acid, Kdo, Dha, 2-O-methyl-D-fucose, and 2-O-methyl-D-xylose, are found either in the RG-II pectin fraction (<2%), or as minor constituents in the RG-I fraction. Proportions of each of the monosaccharides in relation to D-galacturonic acid vary depending on the individual plant and its micro-environment, the species, and time during the growth cycle. For the same reasons, the homogalacturonan and RG-I fractions can differ widely in their content of methyl esters on GalA residues, and the content of acetyl residue esters on the C-2 and C-3 positions of GalA and neutral sugars.

The term “hydration limit” can refer to the upper limit of a liquid that a comestible, such as flour, may absorb to form a dough. For example, a comestible may have a hydration limit of 80% to form a dough.

The term “syneresis” can refer to the contraction of a composition accompanied by the separating out of liquid.

The term “organoleptic properties” can refer to the aspects of food that create an individual experience via the senses

The term “crust” can refer to the exterior layer of a comestible.

The term “crumb” can refer to structure of a comestible.

The term “oven spring” can refer to the rapid expansion a comestible, such as a dough, experiences when first exposed to the high heat of the oven. Oven spring is typically assessed by height increase in a fixed dimension pan.

The terms “compression” can refer to how well a food product resists being compressed and how much it relaxes to its original dimensions when the compressing force is released.

The term “moisture” can refer to the liquid content of the high-protein food composition.

The term “shelf life/staling” can refer to the time during which a product will remain safe, maintain desired sensory, chemical, physical and microbiological properties, and comply with nutritional labeling.

The term “food rheology” can refer to the consistency and flow of food under tightly specified conditions.

The term “glycemic index” of a food can refer to the incremental area under the blood glucose response curve of that food expressed in percent of the response to the reference food expressed as a percentage of the response to the reference food (with the same amount of available carbohydrate) which, by convention, is fresh white bread or glucose. As there exists a close association between the glycemic and insulinemic response to food, in the present application the term “glycemic index” can encompass the term “insulinemic index”. Correspondingly, the terms “low-”, “medium-” and “high-glycemic” can mean, interchangeably, “low-”, “medium-” and “high-insulinemic”.

The term “serving” or “serving size” can refer to the amount of food normally consumed at one time by an average healthy individual

### Overview

Provided herein is a powder or composition comprising a protein with a desired property as well as blends and food products comprising said powder or composition comprising the protein with the desired property. Also provided herein are methods of formulating high protein doughs, batters, aqueous and dry mixes that are used to make food products such as pasta as well as finished baked products such as bread, snacks, tortillas, flat breads, crackers, and other snack foods that comprise the protein with the desired property. Additionally, provided herein are methods for altering a protein in order to generate the protein with a desired property. The protein with the desired property can be an isolated and/or purified protein or can be a lysate comprising the protein with the desired property. In instances where the protein with the desired property is a component of a lysate, said lysate can have all non-proteinaceous material removed. The desired property can be one or a plurality of properties selected from the group consisting of water holding capacity (WHC), percentage of hydration, solvent retention capacity (SRC), percentage of essential amino acids (EAA), percentage of non-essential amino acids (NEAA), percentage of branched chain amino acids (BCAA), a Protein Digestibility-Corrected Amino Acid Score (PDCAAS), a Digestible Indispensable Amino Acid Score (DIAAS) and any combination thereof. In one embodiment, the desired property is WHC. In some cases, the desired WHC is from 80 grams (g) of water to 300 g of water per 100 g of protein powder. In some cases, the desired WHC is from 80% to 150% the WHC of a comestible such as, for example, flour. In some cases, the protein with the desired property is obtained from an animal, plant, microbe or any combination thereof. In one embodiment, the protein with the desired property is obtained from the fermentation of a biomass by a one or a plurality of microbes. The biomass can be any plant biomass known in the art or provided herein. The microbe or plurality of microbes can be any microbe known in the art or provided herein. In some cases, a food product made with said protein with a desired property has identical or substantially similar organoleptic properties as a control food product. The control food product can be the same type of food product as the food product made with said protein with the desired property except for the omission of said protein with the desired property. The organoleptic properties can be selected from the group consisting of crust, crumb, oven spring, compression/firmness and relaxation, moisture content and shelf-life/staling.

The disclosed food products of the present invention can be made using formulations and processing techniques that utilize protein powders as provided herein to deliver protein-enriched food products for humans or pets, particularly delivering at least 2, 3, 4, 5, 6, 7, 8, 9, 10, 11, 12, 13, 14, 15, 16, 17, 18, 19 or 20 times the amount of protein per serving in any particular type of food product provided herein than is commonly provided by said particular type of food product made without a protein powder provided herein. The remaining macronutrient content of the protein-enriched food product as provided herein can be a typical macronutrient content per serving known in the art for the particular type of food product. The serving can be any serving size known in the art for the particular type of food product such as, for example, a serving size in units of weight, volume or numbers of items. Further disclosed are examples of finished food products, including bread, pasta, tortillas, breading, batters, and cakes, all made with the ingredients from the present disclosure (e.g., protein powder or mix comprising a protein with a desired property such as, for example, WHC) that can deliver a high density of high-quality protein in finished food product.

Protein powders as defined in the invention can include protein blended with wheat, oat, rice, pea, cassava (Tapioca) flours, or protein rich flour fractions of these grain types, or other commonly consumed grains and grain derived flour products, or microbial protein flours derived from microbial fermentations. Protein powders as defined in the invention can include protein blended with wheat, oat, rice, pea, cassava (Tapioca) flours, or protein rich flour fractions of these grain types, or other commonly consumed grains and grain derived flour products and microbial protein flours derived from microbial fermentations.

The microbes and their proteomes present in the protein powder or mix/blend, or food products can be further processed to inactivate live microbes or refined microbial biomass by removing nucleic acid contents and non-proteinaceous materials typically cell wall material of microbial cells; optionally, the microbes can be kept live in products or blends thereof.

### Protein Powder Composition

In one aspect, provided herein is a powder or composition comprising a protein that has a desired property. The powder or composition can comprise or contain at least, at most, about or exactly 70%, 75%, 80%, 85%, 90%, 95%, 99% or 100% by weight of the protein comprising the desired property. The powder or composition can comprise or contain from 70%-80%, 75%-85%, 80%-90%, 85%-95%, 90% to 100% or 95%-100% by weight of the protein comprising the desired property. The powder or composition can comprise or contain between 70%-80%, 75%-85%, 80%-90%, 85%-95%, 90% to 100% or 95%-100% by weight of the protein comprising the desired property. As described previously herein, the desired property can be one or a plurality of properties selected from the group consisting of water holding capacity (WHC), percentage of hydration, solvent retention capacity (SRC), percentage of essential amino acids (EAA), percentage of non-essential amino acids (NEAA), percentage of branched chain amino acids (BCAA), a Protein Digestibility-Corrected Amino Acid Score (PDCAAS), a Digestible Indispensable Amino Acid Score (DIAAS) and any combination thereof. In one embodiment, the desired property is WHC.

In yet another aspect, provided herein is powder comprising a protein with a desired property, wherein the desired property is an amino acid distribution profile of between 15% to 50%, and wherein the protein is obtained from a non-animal source. In some cases, the protein is a plant protein, a microbial protein or a combination thereof. In some cases, the protein is a plant protein obtained or isolated from an angiosperm, gymnosperm or fern. In some cases, the protein is a microbial protein obtained or isolated from the fermentation of biomass by a microbe. In some cases, the microbe is selected from the group consisting of a fungus, a bacterium, an archaea, a protist and any combination thereof. In some cases, the microbe is a fungus selected from the group consisting of a yeast or filamentous fungus. In some cases, the yeast is a Pichia species or Saccharomyces species. In some cases, the yeast is Saccharomyces cerevisiae. In some cases, the microbe is a bacterium selected from the group consisting of a Lactobacillus bacterium, a Bacillus bacterium, a Bifidobacterium bacterium, a Clostridium bacterium, an Enterococcus bacterium, a Corynebacterium bacterium and any combination thereof. In some cases, the bacterium is Corynebacterium glutamicum, Clostridium acetobutylicum or a combination thereof. In some cases, the biomass is spent yeast or microbial biomass from fermented products manufacturing facilities. In some cases, the biomass is a plant biomass. In some cases, the plant biomass is selected from the group consisting of a food crop, an extract of a food crop, seaweed, plankton, phytoplankton, grass crops, agricultural crop waste and residues, spent grain from ethanol production, or spent grain from breweries, trees, woody energy crops and wood waste and residue. In some cases, the food crop is selected from the group consisting of sugarcane, wheat, tubers, vegetables, lentils, kelp, legumes, soybeans, rice, potato, oats, pea, cassava and maize. In some cases, the agricultural crop waste and residue is selected from the group consisting of corn stover, wheat straw, rice straw and sugar cane bagasse. In some cases, the wood waste and residue is selected from the group consisting of softwood forest matter, barky wastes, sawdust, paper and pulp industry waste streams and wood fiber. In some cases, the powder comprises 5, 6, 7, 8, 9, 10, 11, 12, 13, 14, 15, 16, 17, 18, 19, 20, 21, 22, 23, 24, 25, 26, 27, 28, 29 or 30 grams (g) of the protein per serving. In some cases, the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). In some cases, the protein has a Solvent Retention Capacity (SRC) of at least 60%, at least 70%, at least 80%, at least 90% or at least 100%. In some cases, the protein has a Protein Digestibility-Corrected Amino Acid Score (PDCAAS) of at least 0.6, at least 0.7, at least 0.8, at least 0.9 or at least 1.0. In some cases, the protein comprises an amino acid distribution profile of between 20% to 50% or between 25% to 50% essential amino acids (EAAs).

In some embodiments, the protein in the protein powder comprises one or a plurality of protein(s) that has/have been isolated or purified. Each protein can comprise at least 10 or at least 20 amino acids. In some embodiments, each protein comprises at least 30 amino acids, at least 40 amino acids, at least 50 amino acids, at least 60 amino acids, at least 70 amino acids, at least 80 amino acids, at least 90 amino acids, at least 100 amino acids, at least 110 amino acids, at least 120 amino acids, at least 130 amino acids, at least 140 amino acids, at least 150 amino acids, at least 160 amino acids, at least 170 amino acids, at least 180 amino acids, at least 190 amino acids, at least 200 amino acids, at least 300 amino acids, at least 400 amino acids, at least 500 amino acids, at least 600 amino acids, at least 700 amino acids, at least 800 amino acids, at least 900 amino acids, or at least 1,000 amino acids. In some embodiments, each protein comprises from 20 to 50 amino acids, from 20 to 75 amino acids, from 20 to 100 amino acids, from 30 to 100 amino acids, from 40 to 100 amino acids, from 50 to 100 amino acids, from 50 to 200 amino acids, from 100 to 200 amino acids, from 200 to 300 amino acids, from 300 to 400 amino acids, or from 400 to 500 amino acids.

In some embodiments, each protein comprises at least 50% by weight EAAs. In some embodiments, each protein comprises at least 55% by weight EAAs, at least 60% by weight EAAs, at least 65% by weight EAAs, at least 70% by weight EAAs, at least by weight 75% EAAs, at least 80% by weight EAAs, at least 85% by weight EAAs, at least 90% by weight EAAs, or at least 95% by weight EAAs, at least 96% by weight EAAs, at least 97% by weight EAAs, at least 98% by weight EAAs, at least 99% by weight EAAs, or 100% EAAs.

In some embodiments, each protein comprises from 50 to 100% by weight EAAs, from 60 to 100% by weight EAAs, from 70 to 100% by weight EAAs, from 80 to 90% by weight EAAs, from 60 to 90% by weight EAAs, from 60 to 80% by weight EAAs, from 70 to 90% by weight EAAs, from 60 to 70% by weight EAAs, from 70 to 80% by weight EAAs, from 80 to 90% by weight EAAs, and from 90 to 100% by weight EAAs. In some embodiments, each protein comprises from 90% to 100% EAAs and CEAAs. In some embodiments each protein comprises 100% EAAs and CEAAs.

### Hydration Limit

In some embodiments, a protein powder provided herein possesses a hydration limit that allows for the improvement of texture in a food composition or product comprising said protein powder.

In some embodiments, the hydration limit of a protein powder provided herein is at least 10%, at least 20%, at least 30%, at least 40%, at least 50%, at least 60%, at least 70%, at least 80%, at least 90%, at least 100%, at least 110%, at least 120%, at least 130%, at least 140%, at least 150%, at least 160%, at least 170%, at least 180%, at least 190%, or at least 200%.

In some embodiments, the hydration limit of a protein powder provided herein is at least 10%, between 10% to 20%, between 20% to 30%, between 30% to 40%, between 40% to 50%, between 50% to 60%, between 60% to 70%, between 70% to 80%, between 80% to 90%, between 90% to 100%, between 100% to 110%, between 110% to 120%, between 120% to 130%, between 130% to 140%, between 140% to 150%, between 150% to 160%, between 160% to 170%, between 170% to 180%, between 180% to 190%, or between 190% to 200%.

In one embodiment, a protein or each of a plurality of proteins for use in a protein powder provided herein comprise a desired water holding capacity (WHC). The desired WHC can be from 80 grams (g) to 300 g of water per 100 g of protein or 80 g to 150 g of water per 100 g of protein or protein powder. In some cases, a protein or each of a plurality of proteins for use in a protein powder provided herein possesses at most, at least, exactly or about 70, 75, 80, 85, 90, 95, 100, 105, 110, 115, 120, 125, 130, 135, 140, 145, 150, 155, 160, 165, 170, 175, 180, 190, 200, 210, 220, 230, 240, 250, 260, 270, 280, 290, or 300 g of water per 100 g of protein or protein powder.

In some cases, a protein or each of a plurality of proteins for use in a protein powder provided herein possesses about from 70 to about 75, 75 to about 80, about from 80 to about 85, about from 85 to about 90, about from 90 to about 95, about from 95 to about 100, about from 100 to about 105, about from 105 to about 110, about from 110 to about 115, about from 115 to about 120, about from 120 to about 125, about from 125 to about 130, about from 130 to about 135, about from 135 to about 140, about from 140 to about 145, about from 145 to about 150, about from 150 to about 155, about from 155 to about 160, about from 160 to about 165, about from 165 to about 170, about from 170 to about 175, about from 175 to about 180, about from 180 to about 190, about from 190 to about 200, about from 200 to about 210, about from 210 to about 220, about from 220 to about 230, about from 230 to about 240, about from 240 to about 250, about from 250 to about 260, about from 260 to about 270, about from 270 to about 280, about from 280 to about 290, or about from 290 to about 300 g of water per 100 g of protein or protein powder.

In some embodiments, a protein or each of a plurality of proteins for use in a protein powder provided herein possesses about 5, 10, 15, 20, 25, 30, 35, 40, 45, 50, 55, 60, or 65 g of water per 100 g of protein or protein powder.

In some embodiments, a protein or each of a plurality of proteins for use in a protein powder provided herein possesses from about 5 to about 10, about from 10 to about 15, about from 15 to about 20, about from 20 to about 25, about from 25 to about 30, about from 30 to about 35, about from 35 to about 40, about from 40 to about 45, about from 45 to about 50, about from 50 to about 55, about from 55 to about 60, or from about from 60 to about from 65 g of water per 100 g of protein or protein powder.

In some embodiments, a protein or each of a plurality of proteins for use in a protein powder provided herein possesses about 300, 400, 500, 600, 700, 800, 900, or 1,000 g of water per 100 g of protein or protein powder.

In some embodiments, a protein or each of a plurality of proteins for use in a protein powder provided herein possesses from about 300 to about 400, about from 400 to about 500, about from 500 to about 600, about from 600 to about 700, about from 700 to about 800, about from 800 to about 900, or from about from 900 to about 1,000 g of water per 100 g of protein or protein powder.

### Protein Source

In some cases, a protein or each of a plurality of proteins for use in a protein powder provided herein is selected from the group consisting of an animal protein, a plant protein, a microbial protein and any combination thereof. In one embodiment, the protein is an animal protein selected from the group consisting of a diary protein, gelatin, eggs and muscle. The protein can be an animal protein derived from a mammal, an insect, a reptile, a bird and/or a fish.

In one embodiment, a protein or each of a plurality of proteins for use in a protein powder provided herein is a plant protein derived from an angiosperm, gymnosperm, fern or multicellular algae.

In one embodiment, a protein or each of a plurality of proteins for use in a protein powder provided herein is a microbial protein derived from the fermentation of biomass by a microbe.

In one embodiment, a protein or each of a plurality of proteins for use in a protein powder or blend provided herein is produced using a starting material consisting of plant proteins, or microbial proteins (microbial biomass) or a combination thereof. In one embodiment, a protein or each of a plurality of proteins for use in a protein powder or blend provided herein is produced using an aqueous extraction method that uses a starting material consisting of plant proteins, or microbial proteins (microbial biomass) or a combination thereof;

In one embodiment, a protein or each of a plurality of proteins for use in a protein powder or blend provided herein are formed from yeast protein biomass.

Humans have used microbes for millennia in the production of fermented foods. As a result of their history as harmless, these microorganisms, or concentrated microbial biomass, e.g., yeast biomass, or probiotics microbiota such as bacillus, lactic acid bacteria and Lactobacillus, Bifidobacterium are considered as GRAS (Generally Regarded As Safe) for many applications, including human and animal consumption.

In some embodiments, the microbes or microorganisms of the disclosure include, but are not limited to, yeasts such as Saccharomyces cerevisiae, molds such as Aspergillus, Rhizopus, Mucor, and bacteria such as Lactobacillus. Additional examples of suitable probiotic microorganisms are: Aspergillus niger, A. oryzae, Bacillus coagulans, B. lentus, B. licheniformis, B. mesentericus, B. pumilus, B. subtilis, B. natto, Bifidobacterium adolescentis, B. animalis, B. breve, B. bifidum, B. infantis, B. lactis, B. longum, B. longum BB536, B. longum AH 1206 (NCIMB: 41382), B. breve AH1205 (NCIMB: 41387), B. infantis 35624 (NCIMB: 41003), B. longum AH1714 (NCIMB 41676), B. animalis subsp. lactis BB-12 (DSM No. 10140), B. pseudolongum, B. thermophilum, Candida pintolopesii, Clostridium butyricum, Enterococcus cremoris, E. diacetylactis, E faecium, E. intermedius, E lactis, E muntdi, E thermophilus, Lactobacillus acidophilus, L. alimentarius, L. amylovorus, L. crispatus, L. brevis, L. case, L. curvatus, L. cellobiosus, L. delbrueckii ss. bulgaricus, L. farciminis, L. fermentum, L. gasseri, L. helveticus, L. lactis, L. plantarum, L. johnsonii, L. reuteri, L. rhamnosus, Lactobacillus rhamnosus GG (ATCC number 53103), L. sakei, L. salivarius and any combination thereof.

Fermenting can be accomplished by any organism suitable known in the art and/or as provided herein for use in a desired fermentation step, including, but not limited to, bacteria, fungi, archaea, and protists. Suitable fermenting organisms include those that can convert mono-, di-, and trisaccharides, especially glucose and maltose, or any other biomass-derived molecule, directly or indirectly to the desired fermentation product (e.g., ethanol, butanol, etc.). Suitable fermenting organisms also include those which can convert non-sugar molecules to desired fermentation products.

In some embodiments, the fermenting is affected by a fungal organism (e.g., yeast or filamentous fungi). The yeast can include strains from a Pichia or Saccharomyces species. In some embodiments, the yeast can be Saccharomyces cerevisiae. In some embodiments, the yeast can be Saccheromycopsis filbugera, and Kluyveromyces marxianus. In some embodiments, the fermenting is affected by bacteria. For example, the bacteria can be Clostridium acetobutylicum (e.g., when butanol is the desired fermentation product) or Corynebacterium glutamicum (e.g., when monosodium glutamate (MSG) is the desired fermentation product). In some embodiments, the micro-organism (e.g., yeast or bacteria) can be a genetically modified micro-organism. In some instances, the organism can be yeast or a consortia of yeast with 1 or more of food microbes consisting of, but not limited to, Lactobacillus sp., Bacillus sp. or filamentous fungi such as Rhizopus sp., Fusarium sp., etc. In some instances, the organism can be from yeast genus with an improved tolerance to pH, salt and solute concentration of growth media. The organism can further be improved for higher productivity and protein yield with growth condition at low oxygen transfer rate or modified to be active in the presence of high concentrations of alcohol.

### Digestibility

Digestibility factors can be measured by a variety of methods and represent the true ability of an organism to process the food material as it passes through the intestines. It may often be measured in animals after passage through the small intestine or through the animal (fecal matter analysis). Digestibility may or may not be affected by processing, drying, baking, or other downstream processes. Digestibility factors known for comparable materials are used. For example, a comparable material, mycoprotein, is listed as having a digestibility of 0.86 (86%) (Edwards & Cummings, “The protein quality of mycoprotein”, Proceedings of the Nutrition Society, 2010, 69). The least represented AAS is multiplied score by the digestibility factor to arrive at the PDCAAS.

In some embodiments, a digestibility from mycoprotein or other factors derived from literature studies is used. In some embodiments, the digestibility factor may be from yeast-derived single cell protein, bacterial single cell protein, other single cell protein, plant-derived proteins, milk, whey, casein, or other protein standards known in the art. In some embodiments the digestibility factor may be derived from laboratory (in vitro) experiments or estimated using in vitro or in silico models.

### Protein Nutritional Quality

The Euclidean distance of a given amino acid distribution (p) to a target distribution (t) is calculated using the following formula Distance=\sqrt{Σ_{iεAA}(pᵢ−tᵢ)²}, where AA={H, I, L, K, SAA, AAA, T, W, V, A, R, N, D, Q, E, G, P, and S}, pᵢ is the fraction of amino acid in the given protein distribution, and t is the fraction of amino acid in the target distribution. This metric corresponds to the square root of the sum of the squared error for each amino acid (EAAs, CEAAs, and NEAAs), and measures the percent distance between a given and target amino acid distribution.

In some embodiments, the Euclidian distance of the amino acid distribution profile of a protein in a protein provided herein or fragment thereof is determined relative to a target amino acid distribution profile. In some embodiments the target amino acid distribution profile comprises a target distribution for EAAs. In some embodiments the target amino acid distribution profile comprises a target distribution for NEAAs. In some embodiments the target amino acid distribution profile comprises a target distribution for CEAAs. In some embodiments the target amino acid distribution profile comprises a target distribution for at least two of EAAs, CEAAs, and NEAAs. In some embodiments the target amino acid distribution profile comprises a target distribution for EAAs, CEAAs, and NEAAs. In some embodiments the target amino acid distribution profile of EAAs and CEAAs is a PDCAAS score. In some embodiments the target amino acid distribution profile of NEAAs is the NEAA amino acid distribution profile of NEAAs present in a benchmark dietary protein source.

In some embodiments, the target amino acid distribution profile of EAAs and CEAAs is a PDCAAS score of at least about 1.4, at least about 1.5, at least about 1.6, at least about 1.7, at least about 1.8, at least about 1.9, at least about 2.0, at least about 2.1, at least about 2.2, at least about 2.3, at least about 2.4, at least about 2.5, at least about 2.6, at least about 2.7, at least about 2.8, at least about 2.9, at least about 3.0, at least about 3.1, at least about 3.2, at least about 3.3, at least about 3.4, at least about 3.5, or about 3.6. In some embodiments the target amino acid distribution profile of EAAs and CEAAs is a PDCAAS score of at least about 1.4 to about 1.6, from about 1.4 to about 1.8, from about 1.4 to about 2.0, from about 1.4 to about 2.2, from about 1.4 to about 2.4, from about 1.4 to about 2.6, from about 1.4 to about 2.8, from about 1.4 to about 3.0, from about 1.4 to about 3.2, from about 1.4 to about 3.4, or from about 1.4 to about 3.6.

In some embodiments, the target amino acid distribution profile comprises at least 50% by weight EAAs. In some embodiments the target amino acid distribution profile comprises at least 55% by weight EAAs, at least 60% by weight EAAs, at least 65% by weight EAAs, at least 70% by weight EAAs, at least by weight 75% EAAs, at least 80% by weight EAAs, at least 85% by weight EAAs, at least 90% by weight EAAs, or at least 95% by weight EAAs, at least 96% by weight EAAs, at least 97% by weight EAAs, at least 98% by weight EAAs, at least 99% by weight EAAs, or 100% EAAs. In some embodiments the target amino acid distribution profile comprises from 50 to 100% by weight EAAs, from 60 to 100% by weight EAAs, from 70 to 100% by weight EAAs, from 80 to 90% by weight EAAs, from 60 to 90% by weight EAAs, from 60 to 80% by weight EAAs, from 70 to 90% by weight EAAs, from 60 to 70% by weight EAAs, from 70 to 80% by weight EAAs, from 80 to 90% by weight EAAs, and from 90 to 100% by weight EAAs. In some embodiments the target amino acid distribution profile comprises from 90% to 100% EAAs and CEAAs. That is, the combined fraction of essential amino acids and conditionally essential amino acids in the nutritive proteins is from 90% to 100%.

### Alteration of the Water Holding Capacity of Proteins of the Present Invention

In one embodiment, a protein or each of a plurality of proteins for use in a protein powder or protein powder/flour blend as provided herein is treated using novel aqueous extraction conditions to modify the holding capacity of said protein(s) to be a desired value or within a desired range. The method for modifying the water holding capacity (WHC) of a protein or each of a plurality of proteins for use in a protein powder provided herein can comprise performing an aqueous extraction method that comprises: (a) mixing a protein of interest obtained from a biomass in water at a defined ratio to generate a slurry comprising the protein of interest; and (b) subjecting the slurry to one or more of: (i) adding an acid or base to adjust the pH of the slurry to a desired pH; (ii) altering the temperature of the slurry to a desired temperature; (iii) adding a salt to the slurry to a desired % of salt in the slurry; (iv) milling the slurry in order to shear the protein of interest in the slurry; (v) adding one or more hydrolases to the slurry in order to hydrolyze the protein of interest as well as other biological components of the slurry that include the protein of interest and/or carbohydrates. The slurry can also be subjected to mixing the slurry with an oil in order to coat the protein with the oil.

In some cases, the desired pH ranges from pH 3 to 12. In some cases, the desired pH is selected from the group consisting of 3.5, 5.5 and 8.5. In some embodiments, the desired pH is about 2, 3, 4, 5, 6, 7, 8, 9, 10, or 11. In some embodiments, the desired pH is from about 2 to about 3, from about 3 to about 4, from about 4 to about 5, from about 5 to about 6, from about 6 to about 7, from about 7 to about 8, from about 8 to about 9, from about 9 to about 10, or from about 10 to about 11.

In some case, the desired temperature is 70, 75, 80, 85, 90 or 95 degrees Celsius. The slurry can be incubated at the desired temperature for at least 30 minutes. In some embodiments, the desired temperature of the slurry is about 50° C., 55° C., 60° C., 65° C., 70° C., 75° C., 80° C., 85° C., 90° C., 95° C. or 100° C. In some embodiments, the desired temperature of the slurry is about 50° C. to about 55° C., about from 55° C. to about 60° C., about from 60° C. to about 65° C., about from 65° C. to about 70° C., about from 70° C. to about 75° C., about from 75° C. to about 80° C., about from 80° C. to about 85° C., about from 85° C. to about 90° C., about from 90° C. to about 95° C., or from about from 95° C. to 100° C.

In some cases, the desired % of salt is 5% w/w, wherein the salt is water soluble salt known in the art. The salt can be sodium chloride or sodium sulfate.

In some cases, the one or more hydrolases can be selected from the group consisting of amylase, protease, xylanase, cellulase and any combination thereof. The slurry can be treated with the one or more hydrolases for at least 1 hour. The slurry can be treated with the mixture of enzymes for 1, 2, 3, 4, 5, 6, 7, 8, 9, 10, 20, 30, 40, 50, 60, 120, or 240 minutes. The slurry can be treated with the one or more hydrolases in a cocktail or in a sequential treatment processes consisting of “protein hydrolases” first and then by “carbohydrates & lipid” hydrolases, or vice versa for about 1 to about 2, about from 2 to about 3, about from 3 to about 4, about from 4 to about 5, about from 5 to about 6, about from 6 to about 7, about from 7 to about 8, about from 8 to about 9, about from 9 to about 10, about from 10 to about 20, about from 20 to about 30, about from 30 to about 40, about from 40 to about 50, about from 50 to about 60, about from 60 to about 120, or from about 120 to about 240 minutes.

In some cases, the method for modifying the WHC of the protein of interest further comprises testing the WHC of the modified protein and repeating steps (a) and (b) until a desired WHC of the protein is achieved. The desired WHC can be any WHC provided herein for the protein in a protein powder provided herein. In some cases, the desired WHC is from 80 g to 300 g of water per 100 g of the protein.

In some cases, the method for modifying the WHC of the protein of interest further comprises filtering the slurry to recover solids comprising the modified protein; and/or drying the modified protein recovered following the filtering in order to produce a protein powder comprising the modified protein.

In some embodiments, the defined ratio of protein to water is 1:0.05, 1:0.10, 1:0.15, 1:0.20, 1:0.25, 1:0.30, 1:0.35, 1:0.40, 1:0.45, 1:0.5, 1:0.6, 1:0.7, 1:0.8, 1:0.9, 1:1, 1.5:1, 2:1, 3:1, 4:1 or 5:1 w/w. In some embodiments, the defined ratio is 1:1, 1:2, 1:3, 1:4, 1:5, 1:6, 1:7, 1:8, 1:9, 1:10, 1:11, 1:12, 1:13, 1:14, 1:15 or 1:16, 1:17, 1:18, 1:19 or 1:20 w/w.

In some embodiments, the defined ratio of protein to water is from about 1:0.05 to about 1:0.10, from about 1:0.10 to about 1:0.15, from about 1:0.15 to about 1:0.20, from about 1:0.20 to about 1:0.25, from about 1:0.25 to about 1:0.30, from about 1:0.30 to about 1:0.35, from about 1:0.35 to about 1:0.40, from about 1:0.40 to about 1:0.45, from about 1:0.45 to about 1:0.50, from about 1:0.5 to about 1:0.55, from about 1:0.6 to about 1:0.7, from about 1:0.7 to about 1:0.8, from about 1:0.8 to about 1:0.9, from about 1:0.9 to about 1:1, from about 1:1 to about 1.5:1, from about 1.5:1 to about 2:1, from about 2:1 to about 3:1, from about 3:1 to about 4:1, or from about 4:1 to about 5:1. In one embodiment the defined ratio of protein to water is 1:2, 1: or 1:10 w/w. In one embodiment, the defined ratio of protein to water is 1:10 w/w.

In some cases, prior to step (a) the protein of interest can be extracted from a starting material. The extraction method can be an aqueous extraction method. The starting material can comprise of animal proteins, plant proteins, microbial proteins or a combination thereof. In one embodiment, the starting material can be a combination of a plant protein and a microbial protein. In some cases, the protein of interest is a microbial protein obtained from or part of a microbial biomass following fermentation of a biomass such as a plant biomass as provided herein. The microbe or microbial biomass can be from any microbe provided herein. In some embodiments, the protein of interest can be extracted from or part of yeast biomass. The yeast biomass can be obtained following fermentation of a biomass such as a plant biomass provided herein.

The extracted protein or protein biomass (e.g., fermented yeast protein biomass) can then be treated to alter the water holding capacity (WHC) of said protein or protein biomass to be a desired WHC.

In some embodiments, the slurry can be continuously mixed for 1, 2, 3, 4, 5, 6, 7, 8, 9, 10, 20, 30, 40, 50, 60, 120, or 240 minutes during one or both of steps (a) or steps (b)(i)-(vi).

In Some Embodiments, the Slurry can be Continuously Mixed for about 1 to about 2, about from 2 to about 3, about from 3 to about 4, about from 4 to about 5, about from 5 to about 6, about from 6 to about 7, about from 7 to about 8, about from 8 to about 9, about from 9 to about 10, about from 10 to about 20, about from 20 to about 30, about from 30 to about 40, about from 40 to about 50, about from 50 to about 60, about from 60 to about 120, or from about 120 to about 240 minutes during one or both of steps (a) or steps (b)(i)-(vi).

### Protein Powder Blends

In one embodiment, provided herein is a composition or blend comprising a flour and a protein powder as provided herein.

In some cases, the flour and the protein powder are present in the composition or blend at a ratio of flour to powder of 1:0.05, 1:0.10, 1:0.15, 1:0.20, 1:0.25, 1:0.30, 1:0.35, 1:0.40, 1:0.45, 1:0.5, 1:0.6, 1:0.7, 1:0.8, 1:0.9, 1:1, 1:6, 1:7, 1:8, 1:9, 1:10, 1:20, 1:30, 1:40, 1:50, 1.5:1, 2:1, 3:1, 4:1 or 5:1. In some embodiments, the comestible is mixed with a protein powder provided herein. In some embodiments, the flour and the protein powder are present in the composition or blend at a ratio of flour to powder of at least 1:0.05, at least 1:0.10, at least 1:0.15, at least 1:0.20, at least 1:0.25, at least 1:0.30, at least 1:0.35, at least 1:0.40, at least 1:0.45, at least 1:0.5, at least 1:0.6, at least 1:0.7, at least 1:0.8, at least 1:0.9, at least 1:1, at least 1:2, at least 1:3, at least 1:4, at least 1:5, at least 1:6, at least 1:7, at least 1:8, at least 1:9, at least 1:10, at least 1:20, at least 1:30, at least 1:40, or at least 1:50. In some embodiments, the flour and the protein powder are present in the composition or blend at a ratio of powder to flour of at least 1:0.05, at least 1:0.10, at least 1:0.15, at least 1:0.20, at least 1:0.25, at least 1:0.30, at least 1:0.35, at least 1:0.40, at least 1:0.45, at least 1:0.5, at least 1:0.6, at least 1:0.7, at least 1:0.8, at least 1:0.9, at least 1:1, at least 1:2, at least 1:3, at least 1:4, at least 1:5, at least 1:6, at least 1:7, at least 1:8, at least 1:9, at least 1:10, at least 1:20, at least 1:30, at least 1:40, or at least 1:50.

The flour in the blend can be any flour known in the art that can be used to prepare a food product such as, bread, pasta, tortilla, batters and breadings and other snacks. For example, the flour can be flour selected from the group consisting of wheat flour, oat flour and chickpea flour. In some cases, the flour and the protein powder are present in the composition or blend at a ratio of flour to powder that produces a WHC that is from 100% to 150% of the WHC of the flour alone. In some cases, the flour and the protein powder composition or blend comprises a water absorption that is 104-110% of control composition. The control composition can be the flour alone (i.e., without the protein powder provided herein).

### Food Products Compositions Comprising a Protein Powder Provided Herein

In one aspect, provided herein is a food product or food composition wherein in one of the ingredients in the food product or food composition is a protein powder comprising a desired property (e.g., WHC, SRC, PDCAAS, DIAAS, % EAAs, % NEAAs, % BCAAs, etc.) as provided herein. The food product of food composition can be referred to as a “high-protein food composition”. The high-protein food composition can be comprised of a protein powder as provided herein, a comestible, such as dough and/or flour, and a liquid, such as water. A high-protein food composition may be, but is not limited to, yeast leavened bread, chemically leavened bread, pasta, pizza crust, artisan bread, buns, batters (e.g., cookie batter), breading mix, croutons, ready-to-bake cake mix, rolls, rolls in a ready to bake format, uncooked filled dough product for consumers (e.g., fruit and/or jelly filling), soup, dried soup base, body-building powder, protein shakes, and/or diet shakes.

In some cases, the protein powder used to produce the high-protein food product has a desired property that is a desired water holding capacity (WHC). The desired WHC can be at least 80%, at least 85%, at least 90%, at least 95%, at least 100%, at least 110%, at least 120%, at least 130%, at least 140% or at least 150% of the WHC of the comestible. The desired WHC can be at most 80%, at most 85%, at most 90%, at most 95%, at most 100%, at most 110%, at most 120%, at most 130%, at most 140% or at most 150% of the WHC of the comestible. The desired WHC can be 80%, 85%, 90%, 95%, 100%, 110%, 120%, 130%, 140% or 150% of the WHC of the comestible.

In some embodiments, the mixture of protein powder, comestible, and liquid is heated in order to produce a cooked or baked food product. In some embodiments, the heating increases the thickness of the food product.

In some embodiments, the high-protein food composition comprising the protein powder provided herein has a firmness that is similar to a similar food composition that lacks the protein powder provided herein. In some embodiments, the high-protein food composition has a firmness of at least 1 grams, at least 10 grams, at least 50 grams, at least 100 grams, at least 200 grams, at least 300 grams, at least 350 grams, at least 400 grams, at least 450 grams, at least 500 grams, at least 550 grams, at least 600 grams, at least 650 grams, at least 700 grams, at least 750 grams, at least 800 grams, at least 900 grams, at least 1,000 grams, at least 1,500 grams, at least 2,000 grams, or at least 2,500 grams. In some embodiments, the high-protein food composition has a shear value of at least 1 centimeter, at least 4 g/m, at least 5 g/m, at least 6 g/m, at least 7 g/m, at least 8 g/m, at least 9 g/m, at least 10 g/m, at least 11 g/m, or at least 12 g/m.

In some embodiments, the high-protein food composition comprising the protein powder provided herein has a thickness that is similar to a similar food composition that lacks the protein powder provided herein. In some embodiments, the high-protein food composition has a thickness of at least 1 centimeter, at least 2 centimeters, at least 3 centimeters, at least 4 centimeters, at least 5 centimeters, at least 6 centimeters, at least 7 centimeters, at least 8 centimeters, at least 9 centimeters, or at least 10 centimeters.

In some embodiments, the high-protein food composition has a thickness of between 1 centimeter to 2 centimeters, between 2 centimeters to 3 centimeters, between 3 centimeters to 4 centimeters, between 4 centimeters to 5 centimeters, between 5 centimeters to 6 centimeters, between 6 centimeters to 7 centimeters, between 7 centimeters to 8 centimeters, between 8 centimeters to 9 centimeters, or between 9 centimeters to 10 centimeters.

In some cases, the high-protein food composition is a rectangular slice of bread that comprises a thickness of from 10-18 millimeters (mm). In some cases, the high-protein food composition is a tortilla that comprises a thickness of from 1-10 millimeters (mm). In some cases, the high-protein food composition is a flatbread that comprises a thickness of from 5-25 millimeters (mm).

In some embodiments, the comestible is mixed with a high-protein powder provided herein. In some embodiments, the comestible is mixed with the high-protein powder provided herein at a comestible:high-protein powder ratio of at least 1:1, at least 1:2, at least 1:3, at least 1:4, at least 1:5, at least 1:6, at least 1:7, at least 1:8, at least 1:9, at least 1:10, at least 1:20, at least 1:30, at least 1:40, or at least 1:50.

In some embodiments, the comestible is mixed with a high-protein powder provided herein. In some embodiments, the comestible is mixed with the high-protein powder provided herein at a high-protein powder:comestible ratio of between 1:1 to 1:2, between 1:2 to 1:3, between 1:3 to 1:4, between 1:4 to 1:5, between 1:5 to 1:6, between 1:6 to 1:7, between 1:7 to 1:8, between 1:8 to 1:9, between 1:9 to 1:10, between 1:10 to 1:20, between 1:20 to 1:30, between 1:30 to 1:40, or between 1:40 to 1:50.

In some embodiments, the liquid is mixed with an emulsifier. In some embodiments, the emulsifier comprises acacia, acetic acid esters, ammonium phosphatide, baker's yeast glycan, brominated vegetable oil, carboxymethylcellulose, carrageenan, diacetyl tartaric acid esters, dextrin, guar gum, lactic acid esters, lecithin (soy and egg), magnesium stearate, mono and diglycerides, phosphates, polyglycerol esters, polysorbate 60, polysorbate 65, polysorbate 80 (P80), propylene glycol esters of fatty acids, sodium stearolyllactylate (SSL), sorbitan monostearate, sucrose acetate isobutyrate, sucrose fatty acid ester, and/or xanthum gum. In some embodiments, the emulsifier is lecithin. In some embodiments, the emulsifier is lecithin as derived from plant, animal or microbial sources.

In one aspect, the food product is a pasta. In one embodiment, the pasta comprises a protein obtained from a non-animal source (e.g., a microbe or a microbe/plant blend) as provided herein. In one embodiment, the pasta comprises a protein obtained from a non-animal source (e.g., a microbe or a microbe/plant blend), wherein the water holding capacity (WHC) of the protein is no greater than 144 g of water per 100 g of protein. In some cases, the WHC of the protein is selected from the group consisting of at least 80 grams (g) of water per 100 g of protein, at least 85 g of water per 100 g of the protein, at least 90 g of water per 100 g of the protein, at least 95 g of water per 100 g of the protein, at least 100 g of water per 100 g of the protein, at least 105 g of water per 100 g of the protein, at least 110 g of water per 100 g of the protein, at least 115 g of water per 100 g of the protein, at least 120 g of water per 100 g of the protein, at least 125 g of water per 100 g of the protein, at least 130 g of water per 100 g of the protein and from 80 to 150 grams (g) of water per 100 g of protein. In some cases, the pasta consists essentially of, consists of or comprises at least 10%, 11%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% w/w of the protein obtained from the microbe. In some cases, the pasta consists essentially of, consists of or comprises from 10%-15%, from 15%-20%, from 20%-25%, from 25%-30%, from 30%-35%, from 35%-40%, from 40%-45% or from 45%-50% w/w of the protein obtained from the microbe. In some cases, the pasta further comprises a fiber. In some cases, the pasta comprises 3, 3.5, 4, 4.5, 5, 5.5, 6, 6.5, 7, 7.5, 8, 8.5, 9, 9.5 or 10% w/w. In some cases, the protein content of the pasta is greater than 17%. In some cases, the PDCAAS value of the pasta is greater than 0.7. In some cases, after cooking the pasta the content of carbohydrates in the pasta is not greater than 64 grams of carbohydrates per 100 grams of cooked pasta. In some cases, the loss of weight occurring when the pasta is cooked is not greater than 6.5 percent. In some cases, firmness of the cooked pasta is greater than 600 grams, 605 grams, 610 grams, 615 grams, 620 grams, 625 grams, 630 grams, 635 grams, 640 grams, 645 grams, 650 grams, 655 grams, 660 grams, 665 grams or 670 grams after cooking in boiling water for a desired period of time. In some cases, firmness of the cooked pasta is between 600 grams-610 grams, between 610 grams-620 grams, between 620 grams-630 grams, between 630 grams-640 grams, between 640 grams-650 grams, between 650 grams-660 grams or between 660 grams-670 grams after cooking in boiling water for a desired period of time. In some cases, the desired period of time is 3, 4, 5, 6, 7, 8, 9, 10, 11, 12, 13, 14 or 15 minutes. In some cases, the desired period of time is between 3-5 minutes, between 5-7 minutes, between 7-9, between 9-11, between 11-13 minutes or between 13-15 minutes. In some cases, after cooking the pasta the shear value of the cooked pasta between 50-55 g/cm, between 55-60 g/cm, between 60-65 g/cm, between 65-70 g/cm, between 70-75 g/cm, between 75-80 g/cm, between 80-85 g/cm, between 85-90 g/cm, between 90-95 g/cm, between 95-100 g/cm, between 100-105 g/cm, between 105-110 g/cm, between 115-120 g/cm, between 120-125 g/cm, between 125-130 g/cm, between 130-135 g/cm, between 135-140 g/cm, between 140-145 g/cm, between 145-150 g/cm, between 150-155 g/cm, between 155-160 g/cm, between 165-170 g/cm or between 170-175 g/cm. In some cases, after cooking the pasta the shear value of the cooked pasta is at least 50 g/cm, at least 55 g/cm, at least 60 g/cm, at least 65 g/cm, at least 70 g/cm, at least 75 g/cm, at least 80 g/cm, at least 85 g/cm, at least 90 g/cm, at least 95 g/cm, or at least 100 g/cm. In some cases, after cooking the pasta the shear value of the cooked pasta is greater than 90 g/cm. In some cases, the pasta further comprises a PDCAAS value at least 0.7, at least 0.75, at least 0.80, at least 0.85, at least 0.9, at least 0.95 or at least 1. In some cases, the pasta further comprises a PDCAAS value between 0.7-0.80, between 0.80-0.85, between 0.85-0.9, between 0.9-0.95 or between 0.95-1. In some cases, the pasta further comprises a PDCAAS value greater than 0.7. In some cases, the pasta comprises an amino acid distribution profile of between 15% to 50% or between 25% to 50% branched chain amino acids (BCAAs). In some cases, the protein content is at least 5, 10, 15, 20, 25, 30, 35, 40, 45, 50 or 55 g/serving. In some cases, the protein content is 8 or 25 g/serving. In some cases, the serving is 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g). In some cases, the serving is 56 g. In some cases, the pasta is resistant to excessive swelling of starch in the pasta.

In some cases, the pasta was boiled for different times and the firmness was measured subjectively by chewing. In some cases, the firmness and al dente chewing properties of a pasta as provided herein when cooked at a desired temperature in water are retained when the cooking time of the pasta is extended longer than the recommended cooking time. In some cases, the desired temperature is boiling. In one embodiment, the cooking time is extended by at most 1%, 2%, 3%, 4%, 5%, 6%, 7%, 8%, 9%, 10%, 11%, 12%, 13%, 14%, 15%, 20%, 25%, 30%, 35%, 40%, 45%, 50%, 55%, 60%, 65%, 70%, 75%, 80%, 85%, 90%, 95%, 99% or 100% of the recommended cooking time. In one embodiment, the cooking time is extended by at least 1%, 2%, 3%, 4%, 5%, 6%, 7%, 8%, 9%, 10%, 11%, 12%, 13%, 14%, 15%, 20%, 25%, 30%, 35%, 40%, 45%, 50%, 55%, 60%, 65%, 70%, 75%, 80%, 85%, 90%, 95%, 99% or 100% of the recommended cooking time. In one embodiment, the cooking time is extended by about 1%, 2%, 3%, 4%, 5%, 6%, 7%, 8%, 9%, 10%, 11%, 12%, 13%, 14%, 15%, 20%, 25%, 30%, 35%, 40%, 45%, 50%, 55%, 60%, 65%, 70%, 75%, 80%, 85%, 90%, 95%, 99% or 100% of the recommended cooking time. In one embodiment, the cooking time is extended by greater than 1%, 2%, 3%, 4%, 5%, 6%, 7%, 8%, 9%, 10%, 11%, 12%, 13%, 14%, 15%, 20%, 25%, 30%, 35%, 40%, 45%, 50%, 55%, 60%, 65%, 70%, 75%, 80%, 85%, 90%, 95%, 99% or 100% of the recommended cooking time. In one embodiment, the cooking time is extended by between 1%-5%, between 5%-10%, between 15%-20%, between 20%-25%, between 25%-30%, between 30%-35%, between 35%-40%, between 40%-45%, between 45%-50%, between 50%-55%, between 55%-60%, between 60%-65%, between 65%-70%, between 70%-75%, between 75%-80%, between 80%-85%, between 85%-90%, between 90%-95%, or between 95%-100% of the recommended cooking time. The recommended cooking time can be the time required to reach optimal or desired al dente properties as known in the art and/or as provided by the manufacturer. In one embodiment, the food product was pasta and the pasta was made according to formulation 26 as disclosed in Table 6D. Further to this embodiment, the pasta was boiled for different times and the firmness was measured subjectively by chewing. While the optimal al dente texture was reached after cooking pasta for 8 minutes for said pasta made according to formulation 26 of Table 6D, the firmness and chewing properties of pasta cooked for longer time (12 minutes) were retained, demonstrating that the pasta could be cooked longer and retain optimal al dente texture.

### Fermentable Oligo-, Di-, and Monosaccharides and Polyols (FODMAPS)

The term “FODMAPS” refers to fermentable oligo-, di-, and monosaccharides and polyols, or FODMAPS. FODMAPs represent a group of short-chain carbohydrates and sugar alcohols comprising fructose, lactose, fructo- and galacto-oligosaccharides (fructans and galactans) and polyols. Decreasing the amount of FODMAPs in a person's diet can help with weight loss. In addition, patients suffering from IBS, Inflammatory Bowel Disease (IBD), or nonceliac gluten sensitivity (NCGS) are advised to follow a diet that is limited in FODMAPs. Traditional bread products, for example, contain relatively high fructan levels and is therefore a major source of FODMAPs. Fructans are linear or branched polymers consisting mainly or exclusively of fructose units and maximally one glucose unit per molecule.

The high-protein food compositions of the present disclosure have decreased FODMAPS compared to a comestible that does not contain the high-protein powder.

In some embodiments, the high-protein food compositions of the present disclosure comprise at least 1%, at least 10%, at least 20%, at least 30%, at least 40%, at least 50%, at least 60%, at least 70%, at least 80%, at least 90%, or 100% less FODMAPS compared to a comestible that does not contain the high-protein powder.

In some embodiments, the high-protein food compositions of the present disclosure comprise between 1% to 10%, between 10% to 20%, between 20% to 30%, between 30% to 40%, between 40% to 50%, between 50% to 60%, between 60% to 70%, between 70% to 80%, between 80% to 90%, or between 90% to 100% less FODMAPS compared to a comestible that does not contain the high-protein powder.

### Syneresis

A food composition that comprises or is made with a protein powder of the present disclosure has lower syneresis compared to a comestible that does not contain the high-protein powder.

In some embodiments, the syneresis of the food composition is less than 1% wt/wt, less than 2% wt/wt, less than 3% wt/wt, less than 4% wt/wt, less than 5% wt/wt, less than 6% wt/wt, less than 7% wt/wt, less than 8% wt/wt, less than 9% wt/wt, less than 10% wt/wt, less than 11% wt/wt, less than 12% wt/wt, less than 13% wt/wt, less than 14% wt/wt, or less than 15% wt/wt of the composition stored under 0° C.

In some embodiments, the syneresis of the food composition is between 0.001% wt/wt to 1% wt/wt, between 1% wt/wt to 2% wt/wt, between 2% wt/wt to 3% wt/wt, between 3% wt/wt to 4% wt/wt, between 4% wt/wt to 5% wt/wt, between 5% wt/wt to 6% wt/wt, between 6% wt/wt to 7% wt/wt, between 7% wt/wt to 8% wt/wt, between 8% wt/wt to 9% wt/wt, between 9% wt/wt to 10% wt/wt, between 10% wt/wt to 11% wt/wt, between 11% wt/wt to 12% wt/wt, between 12% wt/wt to 13% wt/wt, between 13% wt/wt to 14% wt/wt, or between 14% wt/wt to 15% wt/wt of the composition stored under 0° C.

### Organoleptic Properties

The term “organoleptic properties” refer to the aspects of food that create an individual experience via the senses. In one embodiment, a food composition or product made with a protein powder as provided herein comprise organoleptic properties that are the same or substantially similar to an identical food composition or product made without a protein powder as provided herein. The organoleptic properties can include, but not be limited to crust, crumb, oven spring, compression, moisture, shelf-life/staling and rheology. One aspect of the individual experience comprises “mouth feel.” Several different characteristics that affect mouth feel include, but are not limited to, crust, crumb, oven spring, compression, moisture, shelf-life/staling, and rheology.

### Crust

The crispiness/firmness of the crust can be assessed by using a penetration test using a cylindrical penetration probe. In some embodiments, a crispier crust will show a series of high force peaks followed by a drop once the probe reaches the interior. In some embodiments, a stale comestible will show uniformly high force.

In some embodiments, the high protein food composition has a crust. In some embodiments, a cylindrical penetration probe is used to measure the crispiness/firmness of the crust of the high protein food composition.

In some embodiments, the crispiness/firmness of the crust of the high protein food composition is at least 1 g, at least 10 g, at least 50 g, at least 100 g, at least 200 g, at least 300 g, at least 400 g, at least 500 g, at least 600 g, at least 700 g, at least 800 g, at least 900 g, at least 1,000 g, at least 1,500 g, at least 2,000 g, or at least 2,500 g.

In some embodiments, the crispiness/firmness of the crust of the high protein food composition is between 1 g to 10 g, between 10 g to 50 g, between 50 g to 100 g, between 100 g to 200 g, between 200 g to 300 g, between 300 g to 400 g, between 400 g to 500 g, between 500 g to 600 g, between 600 g to 700 g, between 700 g to 800 g, between 800 g to 900 g, between 900 g to 1,000 g, between 1,000 g to 1,500 g, between 1,500 g to 2,000 g, or between 2,000 g to 2,500 g.

### Crumb

Comestibles with large air pockets, like ciabatta bread, are said to have an open crumb. Comestibles with tiny air pockets, such as pain de mie, have a “tight” or closed crumb. Crumb is commonly assessed by putting a slice of a comestible on a scanner, converting to a binary image, and calculating air pockets dimensions versus comestible material space occupied. Image processing can be performed on scanner images, software such as ImageJ can be used. Crumb structure, air pocket size, and other aspects of bread quality can also be measured by a C-Cell Baking Quality Analyzer Calibre Control International, 5-6 Asher Court, Lyncastle Way, Warrington, WA4 4ST, UK.

In some embodiments, image processing may measure the size of the air pockets of a food composition or product made with a protein powder as provided herein.

In some embodiments, the food composition does not have any air pockets.

In some embodiments, the food composition has at least 1 air pocket/mm³, at least 10 air pockets/mm³, at least 100 air pockets/mm³, at least 1,000 air pockets/mm³, at least 10,000 air pockets/mm³, or at least 100,000 air pockets/mm³.

In some embodiments, the food composition has between 1 air pocket/mm³ to 10 air pockets/mm³, between 10 air pockets/mm³ to 100 air pockets/mm³, between 100 air pockets/mm³ to 1,000 air pockets/mm³, between 1,000 air pockets/mm³, between 10,000 air pockets/mm³, or at least at least 100,000 air pockets/mm³.

In some embodiments, air pockets have an average radius of at least 0.01 mm, at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm.

In some embodiments, air pockets have an average radius of between 0.01 mm to 0.1 mm, between 0.1 mm to 0.2 mm, between 0.2 mm to 0.3 mm, between 0.3 mm to 0.4 mm, between 0.4 mm to 0.5 mm, between 0.5 mm to 0.6 mm, between 0.6 mm to 0.7 mm, between 0.7 mm to 0.8 mm, between 0.8 mm to 0.9 mm, or between 0.9 mm to 1 mm.

The number and size of air pockets may impact the density of the food composition or product made with a protein powder as provided herein. For example, a food composition or product made with a protein powder as provided herein with more air pockets and/or large air pockets may be less dense than a food composition with fewer air pockets and/or smaller air pockets.

In some embodiments, the density of the food composition or product made with a protein powder as provided herein is at least 0.01 g/cm³, at least 0.1 g/cm³, at least 0.2 g/cm³, at least 0.3 g/cm³, at least 0.4 g/cm³, at least 0.5 g/cm³, at least 0.6 g/cm³, at least 0.7 g/cm³, at least 0.8 g/cm³, at least 0.9 g/cm³, at least 1.0 g/cm³, at least 1.1 g/cm³, at least 1.2 g/cm³, at least 1.3 g/cm³, at least 1.4 g/cm³, or at least 1.5 g/cm³.

In some embodiments, the density of the food composition or product made with a protein powder as provided herein is between 0.01 g/cm³ to 0.1 g/cm³, between 0.1 g/cm³ to 0.2 g/cm³, between 0.2 g/cm³ to 0.3 g/cm³, between 0.3 g/cm³ to 0.4 g/cm³, between 0.4 g/cm³ to 0.5 g/cm³, between 0.5 g/cm³ to 0.6 g/cm³, between 0.6 g/cm³ to 0.7 g/cm³, between 0.7 g/cm³ to 0.8 g/cm³, between 0.8 g/cm³ to 0.9 g/cm³, between 0.9 g/cm³ to 1.0 g/cm³, between 1.0 g/cm³ to 1.1 g/cm³, between 1.1 g/cm³ to 1.2 g/cm³, between 1.2 g/cm³ to 1.3 g/cm³, between 1.3 g/cm³ to 1.4 g/cm³, or between 1.4 g/cm³ to 1.5 g/cm³.

### Oven Spring

In some embodiments, the height of the food composition or product made with a protein powder as provided herein increases in a fixed dimension pan at least 1%, at least 10%, at least 20%, at least 30%, at least 40%, at least 50%, at least 60%, at least 70%, at least 80%, at least 90%, at least 100%, at least 150%, at least 200%, at least 300%, at least 400%, at least 500%, at least 600%, at least 700%, at least 800%, at least 900%, or at least 1,000%.

In some embodiments, the height of the food composition or product made with a protein powder as provided herein increases in a fixed dimension pan between 1% to 10%, between 10% to 20%, between 20% to 30%, between 30% to 40%, between 40% to 50%, between 50% to 60%, between 60% to 70%, between 70% to 80%, between 80% to 90%, between 90% to 100%, between 100% to 110%, between 150% to 200%, between 200% to 300%, between 300% to 400%, between 400% to 500%, between 500% to 600%, between 600% to 700%, between 700% to 800%, between 800% to 900%, or between 900% to 1,000%.

### Compression

The instrument to measure compression, firmness and relaxation is a specialty instrument and the data produced is a sinusoidal pressure graph. Exemplary equipment includes, but is not limited to, the Stable Micro Systems TA.XT plus texture analyzer, the Instron Universal Testing Machine, the Baker Compressimeter, the Bloom Gelometer, the Voland Stevens Texture Analyzer, and similar equipment.

In some embodiments, the firmness of the bread crumb of the food composition or product made with a protein powder as provided herein is at least 1 g, at least 10 g, at least 50 g, at least 100 g, at least 200 g, at least 300 g, at least 400 g, at least 500 g, at least 600 g, at least 700 g, at least 800 g, at least 900 g, at least 1,000 g, at least 1,500 g, at least 2,000 g, or at least 2,500 g.

In some embodiments, the firmness of the bread crumb of the food composition or product made with a protein powder as provided herein is between 1 g to 10 g, between 10 g to 50 g, between 50 g to 100 g, between 100 g to 200 g, between 200 g to 300 g, between 300 g to 400 g, between 400 g to 500 g, between 500 g to 600 g, between 600 g to 700 g, between 700 g to 800 g, between 800 g to 900 g, between 900 g to 1,000 g, between 1,000 g to 1,500 g, between 1,500 g to 2,000 g, or between 2,000 g to 2,500 g.

In some embodiments, the food composition or product made with a protein powder as provided herein has a compression of at least 1%, at least 10%, at least 20%, at least 30%, at least 40%, at least 50%, at least 60%, at least 70%, at least 80%, at least 90%, or 100% of the original height at a speed of 1.7 mm/s.

In some embodiments, the food composition or product made with a protein powder as provided herein has a compression of between 1% to 10%, between 10% to 20%, between 20% to 30%, between 30% to 40%, between 40% to 50%, between 50% to 60%, between 60% to 70%, between 70% to 80%, between 80% to 90%, or between 90% to 100% of the original height at a speed of 1.7 mm/s.

### Moisture

Moisture is commonly assessed in a moisture analyzer. A moisture analyzer; weighs a comestible, slowly bakes dry the comestible, and weighs the comestible repeatedly. The weight drops over time before stabilizing when the comestible is completely dry.

The moisture content of a composition impacts several factors related to the state and texture of the food composition or product made with a protein powder as provided herein, such as a broth, flour, dough, or high-protein powder. For example, the moisture content of a broth food composition or product made with a protein powder as provided herein is above 50%. The moisture content of a dough composition is about 15-50% and the moisture content of a flour composition and high-protein powder may be less than 15%.

In some embodiments, the moisture content of the food composition or product made with a protein powder as provided herein of the disclosure is less than about 80%, about 75%, about 70%, about 65%, about 60%, about 55%, about 50%, about 45%, about 40%, about 35%, about 30%, about 25%, about 20%, about 15%, about 14%, about 13%, about 12%, about 11%, about 10%, about 9%, about 8%, about 7%, about 6%, about 5%, about 4%, about 3%, about 2% or about 1%.

In some embodiments, the moisture content of the food composition or product made with a protein powder as provided herein of the disclosure is between 1% to 2%, between 2% to 3%, between 3% to 4%, between 4% to 5%, between 5% to 6%, between 6% to 7%, between 7% to 8%, between 8% to 9%, between 9% to 10%, between 10% to 11%, between 11% to 12%, between 12% to 13%, between 13% to 14%, between 14% to 15%, between 15% to 20%, between 20% to 25%, between 25% to 30%, between 30% to 35%, between 35% to 40%, between 40% to 45%, between 45% to 50%, between 50% to 55%, between 55% to 60%, between 60% to 65%, between 65% to 70%, between 70% to 75%, or between 75% to 80%.

In some embodiments, the food composition or product made with a protein powder as provided herein is any combination of a dough composition, a broth composition, a flour composition, and/or high-protein powder. For example, the combination may comprise 40% of a flour composition, 25% of a dough composition, 25% of a broth composition, and 10% of a high-protein powder.

In some embodiments, the composition may comprise at least 0.0001% of a dough composition, at least 1% of a dough composition, at least 1% of a dough composition, at least 5% of a dough composition, at least 10% of a dough composition, at least 15% of a dough composition, at least 20% of a dough composition, at least 25% of a dough composition, at least 30% of a dough composition, at least 35% of a dough composition, at least 40% of a dough composition, at least 45% of a dough composition, at least 50% of a dough composition, at least 55% of a dough composition, at least 60% of a dough composition, at least 65% of a dough composition, at least 70% of a dough composition, at least 75% of a dough composition, at least 80% of a dough composition, at least 85% of a dough composition, at least 90% of a dough composition, at least 95% of a dough composition, or at least 99% of a dough composition.

In some embodiments, the food composition or product made with a protein powder as provided herein may comprise between 0.0001% to 1% of a dough composition, between 1% to 5% of a dough composition, between 5% to 10% of a dough composition, between 10% to 15% of a dough composition, between 15% to 20% of a dough composition, between 20% to 25% of a dough composition, between 25% to 30% of a dough composition, between 30% to 35% of a dough composition, between 35% to 40% of a dough composition, between 40% to 45% of a dough composition, between 45% to 50% of a dough composition, between 50% to 55% of a dough composition, between 55% to 60% of a dough composition, between 60% to 65% of a dough composition, between 65% to 70% of a dough composition, between 70% to 75% of a dough composition, between 75% to 80% of a dough composition, between 80% to 85% of a dough composition, between 85% to 90% of a dough composition, between 90% to 95% of a dough composition, or between 95% to 99.9999% of a dough composition.

In some embodiments, a food composition or product made with a protein powder as provided herein may comprise at least 0.0001% of a flour composition, at least 1% of a flour composition, at least 1% of a flour composition, at least 5% of a flour composition, at least 10% of a flour composition, at least 15% of a flour composition, at least 20% of a flour composition, at least 25% of a flour composition, at least 30% of a flour composition, at least 35% of a flour composition, at least 40% of a flour composition, at least 45% of a flour composition, at least 50% of a flour composition, at least 55% of a flour composition, at least 60% of a flour composition, at least 65% of a flour composition, at least 70% of a flour composition, at least 75% of a flour composition, at least 80% of a flour composition, at least 85% of a flour composition, at least 90% of a flour composition, at least 95% of a flour composition, or at least 99% of a flour composition.

In some embodiments, a food composition or product made with a protein powder as provided herein may comprise between 0.0001% to 1% of a flour composition, between 1% to 5% of a flour composition, between 5% to 10% of a flour composition, between 10% to 15% of a flour composition, between 15% to 20% of a flour composition, between 20% to 25% of a flour composition, between 25% to 30% of a flour composition, between 30% to 35% of a flour composition, between 35% to 40% of a flour composition, between 40% to 45% of a flour composition, between 45% to 50% of a flour composition, between 50% to 55% of a flour composition, between 55% to 60% of a flour composition, between 60% to 65% of a flour composition, between 65% to 70% of a flour composition, between 70% to 75% of a flour composition, between 75% to 80% of a flour composition, between 80% to 85% of a flour composition, between 85% to 90% of a flour composition, between 90% to 95% of a flour composition, or between 95% to 99.9999% of a flour composition.

In some embodiments, a food composition or product made with a protein powder as provided herein may comprise at least 0.0001% of a broth composition, at least 1% of a broth composition, at least 1% of a broth composition, at least 5% of a broth composition, at least 10% of a broth composition, at least 15% of a broth composition, at least 20% of a broth composition, at least 25% of a broth composition, at least 30% of a broth composition, at least 35% of a broth composition, at least 40% of a broth composition, at least 45% of a broth composition, at least 50% of a broth composition, at least 55% of a broth composition, at least 60% of a broth composition, at least 65% of a broth composition, at least 70% of a broth composition, at least 75% of a broth composition, at least 80% of a broth composition, at least 85% of a broth composition, at least 90% of a broth composition, at least 95% of a broth composition, or at least 99% of a broth composition.

In some embodiments, a food composition or product made with a protein powder as provided herein may comprise between 0.0001% to 1% of a broth composition, between 1% to 5% of a broth composition, between 5% to 10% of a broth composition, between 10% to 15% of a broth composition, between 15% to 20% of a broth composition, between 20% to 25% of a broth composition, between 25% to 30% of a broth composition, between 30% to 35% of a broth composition, between 35% to 40% of a broth composition, between 40% to 45% of a broth composition, between 45% to 50% of a broth composition, between 50% to 55% of a broth composition, between 55% to 60% of a broth composition, between 60% to 65% of a broth composition, between 65% to 70% of a broth composition, between 70% to 75% of a broth composition, between 75% to 80% of a broth composition, between 80% to 85% of a broth composition, between 85% to 90% of a broth composition, between 90% to 95% of a broth composition, or between 95% to 99.9999% of a broth composition.

In some embodiments, a food composition or product made with a protein powder as provided herein may comprise at least 0.0001% of a protein powder provided herein, at least 1% of a protein powder provided herein, at least 1% of a protein powder provided herein, at least 5% of a protein powder provided herein, at least 10% of a protein powder provided herein, at least 15% of a protein powder provided herein, at least 20% of a protein powder provided herein, at least 25% of a protein powder provided herein, at least 30% of a protein powder provided herein, at least 35% of a protein powder provided herein, at least 40% of a protein powder provided herein, at least 45% of a protein powder provided herein, at least 50% of a protein powder provided herein, at least 55% of a protein powder provided herein, at least 60% of a protein powder provided herein, at least 65% of a protein powder provided herein, at least 70% of a protein powder provided herein, at least 75% of a protein powder provided herein, at least 80% of a protein powder provided herein, at least 85% of a protein powder provided herein, at least 90% of a protein powder provided herein, at least 95% of a protein powder provided herein, or at least 99% of a protein powder provided herein.

In some embodiments, a food composition or product made with a protein powder as provided herein may comprise between 0.0001% to 1% of a protein powder provided herein, between 1% to 5% of a protein powder provided herein, between 5% to 10% of a protein powder provided herein, between 10% to 15% of a protein powder provided herein, between 15% to 20% of a protein powder provided herein, between 20% to 25% of a protein powder provided herein, between 25% to 30% of a protein powder provided herein, between 30% to 35% of a protein powder provided herein, between 35% to 40% of a protein powder provided herein, between 40% to 45% of a protein powder provided herein, between 45% to 50% of a protein powder provided herein, between 50% to 55% of a protein powder provided herein, between 55% to 60% of a protein powder provided herein, between 60% to 65% of a protein powder provided herein, between 65% to 70% of a protein powder provided herein, between 70% to 75% of a protein powder provided herein, between 75% to 80% of a protein powder provided herein, between 80% to 85% of a protein powder provided herein, between 85% to 90% of a protein powder provided herein, between 90% to 95% of a protein powder provided herein, or between 95% to 99.9999% of a protein powder provided herein.

### Shelf-Life/Staling

The term “shelf life/staling” refers to the time during which a product will remain safe, maintain desired sensory, chemical, physical and microbiological properties, and comply with nutritional labeling. Shelf-life/staling is typically assessed by compressibility, but occasionally assessed by sensory panel, crumbliness, or water absorption. Yellow color development has additionally been studied as an indicator of staling.

In some embodiments, the shelf-life of a food compositions or products made with a protein powder of the disclosure have an increased shelf-life.

In some embodiments, the shelf-life is increased by at least 1 day, at least 2 days, at least 3 days, at least 4 days, at least 5 days, at least 6 days, at least 1 week, at least 2 weeks, at least 3 weeks, at least 4 weeks, at least 1 month, at least 2 months, at least 3 months, at least 4 months, at least, 5 months, at least 6 months, or at least 1 year.

In some embodiments, the shelf-life is increased between 1 day to 2 days, between 2 days to 3 days, between 3 days to 4 days, between 4 days to 5 days, between 5 days to 6 days, between 6 days to 7 days, between 1 week to 2 weeks, between 2 weeks to 3 weeks, between 3 weeks to 4 weeks, between 1 month to 2 months, between 2 months to 3 months, between 3 months to 4 months, between 4 months to 5 months, between 5 months to 6 months, or between 6 months to 1 year.

Water activity is an important means of predicting and controlling the shelf life of food products. Water activity is expressed by the equation:

aw=ERH/100

where ERH is the equilibrium relative humidity of a bread sample. Water activity is a critical factor in the determination of the shelf life of the product, and especially for a baked product. For example, a conventional bread product is known to have a water activity of from about 0.90 to about 0.95. In general, a lower water activity value for a bread product will retard the growth of molds and can indicate that the product will have a longer shelf life before the onset of molding on the bread product under shelf storage conditions.

Methods to measure the water activity of a comestible are well known. For the present disclosure, the water activity may be measured on a bread slice sample that has cooled after baking and equilibrated at room temperature for at least two hours.

In some embodiments, the water of a food composition or product made with a protein powder as provided herein is less than 0.9, less than 0.85, less than 0.8, less than 0.75, less than 0.7, less than 0.65, less than 0.6, less than 0.55, less than 0.5, less than 0.45, less than 0.4, less than 0.35, less than 0.3, less than 0.25, or less than 0.2.

### Rheology

Dynamic rheological measuring devices, such as the Tinius Olsen Rheometer, Weitzy Dynamic Rheometer, and Paar-Physica Rheometer, can be applied to measure the viscoelastic properties of a food material. The units of measure for 1/s=1 s−1, also called reciprocal seconds.

In some embodiments, the food rheology of a food compositions or products made with a protein powder as provided herein retains a similar food rheology after storage under 0° C. In some embodiments, the change in food rheology of the high-protein food composition is less than 1%, less than 2%, less than 3%, less than 4%, less than 5%, less than 6%, less than 7%, less than 8%, less than 9%, less than 10%, less than 11%, less than 12%, less than 13%, less than 14%, or less than 15% compared to a comestible without a protein powder as provided herein after storage under 0° C.

In some embodiments, the change in food rheology of a food composition or product made with a protein powder as provided herein is between 0.001% to 1%, between 1% to 2%, between 2% to 3%, between 3% to 4%, between 4% to 5%, between 5% to 6%, between 6% to 7%, between 7% to 8%, between 8% to 9%, between 9% to 10%, between 10% to 11%, between 11% to 12%, between 12% to 13%, between 13% to 14%, or between 14% to 15% compared to a comestible without a protein powder as provided herein after storage under 0° C.

### Adhesion and Cohesion Properties

Breaded and batter-coated cooked products are widely popular among consumers. The acceptability of breaded and batter-coated cooked products depends greatly on the breading or batter's adhesion to food products. Studies have shown that the higher the amount of dough batter adhered to the food product, greater the yield due to reduced cooking loss (Corey, et al., 1987; Mukprasirt et al., 2000).

Coating adhesion is an important characteristic that has been studied in battered products and can be described as the chemical and physical binding of a coating, both with itself and with the food product (Suderman, 1983; Maskat & Kerr, 2004). The batter coating for frying contains a variety of ingredients, including starches and proteins, that affect the adhesion. During batter formations, proteins retain an extensive range of dynamic properties, such as gelation, adhesion and cohesion properties, hydrophilic/Lipophilic balance (HLB) modifiable to the substrate type (meat, vegetables, etc.), protein structure/folding, texture and network formations, thickening, emulsification, and foaming (Dogan, et. al, 2005).

Consequently, proteins represent the most important class of functional ingredients in a batter. Various proteins such as soy protein isolate and whey protein have been extensively studied in batter applications and have been shown to have effects ranging from reduced oil uptake in deep-fried products (Rayner et al., 2000) to increased crispness and adhesion (Labropoulos et al., 2013).

### Crispiness

In some embodiments, the protein powders of the current disclosure increases the crispiness of a comestible compared to a food product that does not comprise a protein powder of the current disclosure.

In some embodiments, the protein powders of the current disclosure increases the crispiness of a comestible by at least 1%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 100%, at least 1,000%, or at least 10,000% compared to a food product that does not comprise a protein powder of the current disclosure.

In some embodiments, the protein powders of the current disclosure increases the crispiness of a comestible from about 1% to about 5%, from about 5% to about 10%, from about 10% to about 15%, from about 15% to about 20%, from about 20% to about 25%, from about 25% to about 30%, from about 30% to about 35%, from about 35% to about 40%, from about 40% to about 45%, from about 45% to about 50%, from about 50% to about 55%, from about 55% to about 60%, from about 60% to about 65%, from about 65% to about 70%, from about 70% to about 75%, from about 75% to about 80%, from about 80% to about 85%, from about 85% to about 90%, from about 90% to about 95%, from about 95% to about 100%, from about 100% to about 1,000%, or from about 1,000% to about 10,000% compared to a food product that does not comprise a protein powder of the current disclosure.

### Oil Uptake

In some embodiments, the protein powders of the current disclosure increases the oil uptake of a comestible compared to a food product that does not comprise a protein powder of the current disclosure.

In some embodiments, the protein powders of the current disclosure increases the oil uptake of a comestible by at least 1%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 100%, at least 1,000%, or at least 10,000% compared to a food product that does not comprise a protein powder of the current disclosure.

In some embodiments, the protein powders of the current disclosure increases the oil uptake of a comestible from about 1% to about 5%, from about 5% to about 10%, from about 10% to about 15%, from about 15% to about 20%, from about 20% to about 25%, from about 25% to about 30%, from about 30% to about 35%, from about 35% to about 40%, from about 40% to about 45%, from about 45% to about 50%, from about 50% to about 55%, from about 55% to about 60%, from about 60% to about 65%, from about 65% to about 70%, from about 70% to about 75%, from about 75% to about 80%, from about 80% to about 85%, from about 85% to about 90%, from about 90% to about 95%, from about 95% to about 100%, from about 100% to about 1,000%, or from about 1,000% to about 10,000% compared to a food product that does not comprise a protein powder of the current disclosure.

### Batter Adhesion and Cohesion

In some embodiments, the protein powders of the current disclosure increases the batter adhesion and cohesion of a comestible compared to a food product that does not comprise a protein powder of the current disclosure.

In some embodiments, the protein powders of the current disclosure increases the batter adhesion and cohesion of a comestible by at least 1%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 100%, at least 1,000%, or at least 10,000% compared to a food product that does not comprise a protein powder of the current disclosure.

In some embodiments, the protein powders of the current disclosure increases the batter adhesion and cohesion of a comestible from about 1% to about 5%, from about 5% to about 10%, from about 10% to about 15%, from about 15% to about 20%, from about 20% to about 25%, from about 25% to about 30%, from about 30% to about 35%, from about 35% to about 40%, from about 40% to about 45%, from about 45% to about 50%, from about 50% to about 55%, from about 55% to about 60%, from about 60% to about 65%, from about 65% to about 70%, from about 70% to about 75%, from about 75% to about 80%, from about 80% to about 85%, from about 85% to about 90%, from about 90% to about 95%, from about 95% to about 100%, from about 100% to about 1,000%, or from about 1,000% to about 10,000% compared to a food product that does not comprise a protein powder of the current disclosure.

### Thickening

In some embodiments, the protein powders of the current disclosure increases the batter thickening of a comestible compared to a food product that does not comprise a protein powder of the current disclosure.

In some embodiments, the protein powders of the current disclosure increases the batter thickening of a comestible by at least 1%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 100%, at least 1,000%, or at least 10,000% compared to a food product that does not comprise a protein powder of the current disclosure.

In some embodiments, the protein powders of the current disclosure increases the batter thickening of a comestible from about 1% to about 5%, from about 5% to about 10%, from about 10% to about 15%, from about 15% to about 20%, from about 20% to about 25%, from about 25% to about 30%, from about 30% to about 35%, from about 35% to about 40%, from about 40% to about 45%, from about 45% to about 50%, from about 50% to about 55%, from about 55% to about 60%, from about 60% to about 65%, from about 65% to about 70%, from about 70% to about 75%, from about 75% to about 80%, from about 80% to about 85%, from about 85% to about 90%, from about 90% to about 95%, from about 95% to about 100%, from about 100% to about 1,000%, or from about 1,000% to about 10,000% compared to a food product that does not comprise a protein powder of the current disclosure.

### Glycemic Index

The glycemic index (GI) is a measure of the blood glucose rising property of food. It is determined by analyzing the blood glucose levels in regular intervals for a 2-3 hour period after intake of the test food and a reference food which, by convention, is either white bread or glucose.

Foods with a high-glycemic index increase blood glucose levels at higher level than foods with a low-glycemic index. Increased consumption of foods with a high-glycemic index lead to health conditions like diabetes. Consequently, decreasing the glycemic index of foods may decrease the development of health conditions like diabetes.

In some embodiments, a food composition or product made with a protein powder as provided herein produced by the methods disclosed herein have a lower glycemic index compared to the compositions before the method.

In some embodiments, a food composition or product made with a protein powder as provided herein produced by the methods disclosed herein have a lower glycemic index at least 0.0001% lower, at least 1% lower, at least 1% lower, at least 5% lower, at least 10% lower, at least 15% lower, at least 20% lower, at least 25% lower, at least 30% lower, at least 35% lower, at least 40% lower, at least 45% lower, at least 50% lower, at least 55% lower, at least 60% lower, at least 65% lower, at least 70% lower, at least 75% lower, at least 80% lower, at least 85% lower, at least 90% lower, at least 95% lower, or 100% lower compared to the compositions before the method.

In some embodiments, a food composition or product made with a protein powder as provided herein produced by the methods disclosed herein have a glycemic index between 0.0001% to 1% lower, between 1% to 5% lower, between 5% to 10% lower, between 10% to 15% lower, between 15% to 20% lower, between 20% to 25% lower, between 25% to 30% lower, between 30% to 35% lower, between 35% to 40% lower, between 40% to 45% lower, between 45% to 50% lower, between 50% to 55% lower, between 55% to 60% lower, between 60% to 65% lower, between 65% to 70% lower, between 70% to 75% lower, between 75% to 80% lower, between 80% to 85% lower, between 85% to 90% lower, between 90% to 95% lower, or between 95% to 100% lower compared to the compositions before the method.

### Characteristics of the Protein Powder and Food Products of the Invention Solvent Retention Capacity (SRC)

The term “solvent retention capacity (SRC)” refers to a physical test performed on hard and soft wheat flours to determine their end use, baking quality and hydration performance during mixing. The degree of starch gelatinization and low amount of starch damage due to abrasion during grinding may be measured by the sodium carbonate-water solvent retention capacity (SRC sodium carbonate). Solvent retention capacity (SRC) may be measured by mixing a sample of the ingredient or component, such as the stabilized ground coarse fraction or bran component, or a stabilized whole-grain wheat flour, having a weight (A), e.g., about 5 g, with a large excess of water or other solvent, such as an aqueous solution of sodium carbonate (e.g., 5% by weight sodium carbonate) and centrifuging the solvent-flour mixture. The supernatant liquid may then be decanted, and the sample may be weighed to obtain the weight of the centrifuged wet sample (B), wherein the SRC value is calculated by the following equation: SRC value=((B−A)/A)×100.

In embodiments, SRC of the protein powder provided herein, flour/protein powder blend provided herein, or a food composition or product made with a protein powder as provided herein is at least 100%, at least 105%, at least 110%, at least 115%, at least 120%, at least 125%, at least 130%, at least 140%, at least 150%, at least 160%, at least 170%, at least 180%, at least 190%, or at least 200%.

In embodiments, SRC of the protein powder provided herein, flour/protein powder blend provided herein, or a food composition or product made with a protein powder as provided herein is between 100% to 105%, between 105% to 110%, between 110% to 115%, between 115% to 120%, between 120% to 125%, between 125% to 130%, between 130% to 140%, between 140% to 150%, between 150% to 160%, between 160% to 170%, between 170% to 180%, between 180% to 190%, or at between 190% to 200%.

In embodiments, SRC of the protein powder provided herein, flour/protein powder blend provided herein, or a food composition or product made with a protein powder as provided herein is at least 100%, at least 105%, at least 110%, at least 115%, at least 120%, at least 125%, at least 130%, at least 140%, at least 150%, at least 160%, at least 170%, at least 180%, at least 190%, or at least 200%.

In embodiments, SRC of the protein powder provided herein, flour/protein powder blend provided herein, or a food composition or product made with a protein powder as provided herein is between 100% to 105%, between 105% to 110%, between 110% to 115%, between 115% to 120%, between 120% to 125%, between 125% to 130%, between 130% to 140%, between 140% to 150%, between 150% to 160%, between 160% to 170%, between 170% to 180%, between 180% to 190%, or at between 190% to 200%.

In some embodiments, the protein powder provided herein, flour/protein powder blend provided herein comprises a water absorption of at least 100%, at least 105%, at least 110%, at least 115%, at least 120%, at least 125%, at least 130%, at least 140%, at least 150%, at least 160%, at least 170%, at least 180%, at least 190%, or at least 200% compared to a comestible without the high-protein powder.

In some embodiments, the protein powder provided herein, flour/protein powder blend provided herein comprises a water absorption of between 100% to 105%, between 105% to 110%, between 110% to 115%, between 115% to 120%, between 120% to 125%, between 125% to 130%, between 130% to 140%, between 140% to 150%, between 150% to 160%, between 160% to 170%, between 170% to 180%, between 180% to 190%, or at between 190% to 200% compared to a comestible without the high-protein powder.

In some embodiments, the protein or protein powder provided herein, or a protein food product made with a protein powder as provided herein comprises a nutritional quality score that is a PDCAAS of at least 0.75, or at least 0.80, or at least 0.85, or at least 0.86, or at least 0.87, or at least 0.88, or at least 0.89, or at least 0, 90, or at least 0.91, or at least 0.92, or at least 0.93, or at least 0.94, or at least 0.95, or at least 0.96, or at least 0.97, or at least 0.98, or at least 0.99 or at least 1.

In some embodiments, the protein or protein powder provided herein, or a protein food product made with a protein powder as provided herein comprises a nutritional quality score that is a PDCAAS of at least 1, or at least 1.25, or at least 1.5, or at least 1.75, or at least 2 or at least 2.25, or at least 2.5, or at least 2.75, or at least 3, or at least 3.25, or at least 3.5, or at least 3.6.

In some embodiments, the protein or protein powder provided herein, or a protein food product made with a protein powder as provided herein comprises a nutritional quality score that is a PDCAAS between 0.75 and 0.80, or between 0.80 and 0.85, or between 0.85 and 0.9, or between 0.90 and 0.92, or between 0.92 and 0.94, or between 0.94 and 0.96, or between 0.96 and 0.98, or between 0.98 and 1.

In some embodiments, the protein or protein powder provided herein, or a protein food product made with a protein powder as provided herein comprises a nutritional quality score that is a PDCAAS between 1 and 1.25, or between 1.25 and 1.50, or between 1.50 and 1.75, or between 1.75 and 2, or between 2 and 2.25, or between 2.25 and 2.50, or between 2.50 and 2.75, or between 2.75 and 3, or between 3 and 3.25, or between 3.25 and 3.50, or between 3.50 and 3.6.

In some embodiments, the protein or protein powder provided herein, or a protein food product made with a protein powder as provided herein comprises a nutritional quality score that is a IVPDCAAS of at least 0.75, or at least 0.80, or at least 0.85, or at least 0.86, or at least 0.87, or at least 0.88, or at least 0.89, or at least 0.90, or at least 0.91, or at least 0.92, or at least 0.93, or at least 0.94, or at least 0.95, or at least 0.96, or at least 0.97, or at least 0.98, or at least 0.99 or at least 1.

In some embodiments, the protein or protein powder provided herein, or a protein food product made with a protein powder as provided herein comprises a nutritional quality score that is a an IVPDCAAS of at least 1, or at least 1.25, or at least 1.5, or at least 1.75, or at least 2 or at least 2.25, or at least 2.5, or at least 2.75, or at least 3, or at least 3.25, or at least 3.5, or at least 3.6.

In some embodiments, the protein or protein powder provided herein, or a protein food product made with a protein powder as provided herein comprises a nutritional quality score that is a an IVPDCAAS between 0.75 and 0.80, or between 0.80 and 0.85, or between 0.85 and 0.9, or between 0.90 and 0.92, or between 0.92 and 0.94, or between 0.94 and 0.96, or between 0.96 and 0.98, or between 0.98 and 1.

In some embodiments, the protein or protein powder provided herein, or a protein food product made with a protein powder as provided herein comprises a nutritional quality score that is a IVPDCAAS between 1 and 1.25, or between 1.25 and 1.50, or between 1.50 and 1.75, or between 1.75 and 2, or between 2 and 2.25, or between 2.25 and 2.50, or between 2.50 and 2.75, or between 2.75 and 3, or between 3 and 3.25, or between 3.25 and 3.50, or between 3.50 and 3.6.

In some embodiments, the protein or protein powder provided herein, or a protein food product made with a protein powder as provided herein comprises a nutritional quality score that is a DIAAS of at least 75, or at least 80, or at least 85, or at least 86, or at least 87, or at least 88, or at least 89, or at least 90, or at least 91, or at least 92, or at least 93, or at least 94, or at least 95, or at least 96, or at least 97, or at least 98, or at least 99 or at least 100.

In some embodiments, the protein or protein powder provided herein, or a protein food product made with a protein powder as provided herein comprises a nutritional quality score that is a DIAAS of at least 100, at least 110, at least 120, at least 130, at least 140, at least 150, at least 160, at least 170, at least 180, at least 190, or at least 200.

In some embodiments, the protein or protein powder provided herein, or a protein food product made with a protein powder as provided herein comprises a nutritional quality score that is a DIAAS of between 100 and 110, or between 110 and 120, or between 120 and 130, or between 130 and 140, or between 140 and 150, or between 150 and 160, or between 160 and 170, or between 170 and 180, or between 180 and 190, or between 190 and 200.

In some embodiments, the protein or protein powder provided herein, or a protein food product made with a protein powder as provided herein comprises a nutritional quality score that is a DIAAS between 75 and 80, or between 80 and 85, or between 85 and 90, or between 90 and 92, or between 92 and 94, or between 94 and 96, or between 96 and 98, or between 98 and 100.

In some embodiments, the protein or protein powder provided herein, or a protein food product made with a protein powder as provided herein comprises a nutritional quality score that is a an IVDIAAS of at least 75, or at least 80, or at least 85, or at least 86, or at least 87, or at least 88, or at least 89, or at least 90, or at least 91, or at least 92, or at least 93, or at least 94, or at least 95, or at least 96, or at least 97, or at least 98, or at least 99 or at least 100.

In some embodiments, the protein or protein powder provided herein, or a protein food product made with a protein powder as provided herein comprises a nutritional quality score that is a an IVDIAAS between 75 and 80, or between 80 and 85, or between 85 and 90, or between 90 and 92, or between 92 and 94, or between 94 and 96, or between 96 and 98, or between 98 and 100.

In some embodiments, the protein or protein powder provided herein, or a protein food product made with a protein powder as provided herein comprises a nutritional quality score that is a IVDIAAS of at least 100, at least 110, at least 120, at least 130, at least 140, at least 150, at least 160, at least 170, at least 180, at least 190, or at least 200.

In some embodiments, the protein or protein powder provided herein, or a protein food product made with a protein powder as provided herein comprises a nutritional quality score that is a IVDIAAS of between 100 and 110, or between 110 and 120, or between 120 and 130, or between 130 and 140, or between 140 and 150, or between 150 and 160, or between 160 and 170, or between 170 and 180, or between 180 and 190, or between 190 and 200.

In some embodiments, the average protein nutritional quality score of the protein powder provided herein or the high-protein food composition provided herein may have a PDCAAS of at least 0.75, or at least 0.80, or at least 0.85, or at least 0.86, or at least 0.87, or at least 0.88, or at least 0.89, or at least 0, 90, or at least 0.91, or at least 0.92, or at least 0.93, or at least 0.94, or at least 0.95, or at least 0.96, or at least 0.97, or at least 0.98, or at least 0.99 or at least 1.

In some embodiments, the average protein nutritional quality score of the protein or protein powder provided herein, or a protein food product made with a protein powder as provided herein herein may have a PDCAAS between 0.75 and 0.80, or between 0.80 and 0.85, or between 0.85 and 0.9, or between 0.90 and 0.92, or between 0.92 and 0.94, or between 0.94 and 0.96, or between 0.96 and 0.98, or between 0.98 and 1.

In some embodiments, the average protein nutritional quality score of the protein or protein powder provided herein, or a protein food product made with a protein powder as provided herein may have an IVPDCAAS of at least 0.75, or at least 0.80, or at least 0.85, or at least 0.86, or at least 0.87, or at least 0.88, or at least 0.89, or at least 0, 90, or at least 0.91, or at least 0.92, or at least 0.93, or at least 0.94, or at least 0.95, or at least 0.96, or at least 0.97, or at least 0.98, or at least 0.99 or at least 1.

In some embodiments, the average protein nutritional quality score of the protein or protein powder provided herein, or a protein food product made with a protein powder as provided herein may have an IVPDCAAS between 0.75 and 0.80, or between 0.80 and 0.85, or between 0.85 and 0.9, or between 0.90 and 0.92, or between 0.92 and 0.94, or between 0.94 and 0.96, or between 0.96 and 0.98, or between 0.98 and 1.

In some embodiments, the average protein nutritional quality score of the protein or protein powder provided herein, or a protein food product made with a protein powder as provided herein may have a PDCAAS of at least 1, or at least 1.25, or at least 1.5, or at least 1.75, or at least 2 or at least 2.25, or at least 2.5, or at least 2.75, or at least 3, or at least 3.25, or at least 3.6.

In some embodiments, the average protein nutritional quality score of the protein or protein powder provided herein, or a protein food product made with a protein powder as provided herein may have a PDCAAS between 1 and 1.25, or between 1.25 and 1.50, or between 1.50 and 1.75, or between 1.75 and 2, or between 2 and 2.25, or between 2.25 and 2.50, or between 2.50 and 2.75, or between 2.75 and 3, or between 3 and 3.25, or between 3.25 and 3.50, or between 3.50 and 3.6.

In some embodiments, the average protein nutritional quality score of the protein or protein powder provided herein, or a protein food product made with a protein powder as provided herein may have an IVPDCAAS of at least 1, or at least 1.25, or at least 1.5, or at least 1.75, or at least 2 or at least 2.25, or at least 2.5, or at least 2.75, or at least 3, or at least 3.25, or at least 3.5, or at least 3.75, or at least 4.

In some embodiments, the average protein nutritional quality score of the protein or protein powder provided herein, or a protein food product made with a protein powder as provided herein may have an IVPDCAAS between 1 and 1.25, or between 1.25 and 1.50, or between 1.50 and 1.75, or between 1.75 and 2, or between 2 and 2.25, or between 2.25 and 2.50, or between 2.50 and 2.75, or between 2.75 and 3, or between 3 and 3.25, or between 3.25 and 3.50, or between 3.50 and 3.75, or between 3.75 and 4. In some embodiments, the average protein nutritional quality score of the protein or protein powder provided herein, or a protein food product made with a protein powder as provided herein may have a DIAAS of at least 100, at least 110, at least 120, at least 130, at least 140, at least 150, at least 160, at least 170, at least 180, at least 190, or at least 200.

In some embodiments, the average protein nutritional quality score of the protein or protein powder provided herein, or a protein food product made with a protein powder as provided herein may have a DIAAS of between 100 and 110, or between 110 and 120, or between 120 and 130, or between 130 and 140, or between 140 and 150, or between 150 and 160, or between 160 and 170, or between 170 and 180, or between 180 and 190, or between 190 and 200.

In some embodiments, the average protein nutritional quality score of the protein or protein powder provided herein, or a protein food product made with a protein powder as provided herein may have a DIAAS between 75 and 80, or between 80 and 85, or between 85 and 90, or between 90 and 92, or between 92 and 94, or between 94 and 96, or between 96 and 98, or between 98 and 100.

In some embodiments, the average protein nutritional quality score of the protein or protein powder provided herein, or a protein food product made with a protein powder as provided herein may have an IVDIAAS of at least 75, or at least 80, or at least 85, or at least 86, or at least 87, or at least 88, or at least 89, or at least 90, or at least 91, or at least 92, or at least 93, or at least 94, or at least 95, or at least 96, or at least 97, or at least 98, or at least 99 or at least 100.

In some embodiments, the average protein nutritional quality score of the protein or protein powder provided herein, or a protein food product made with a protein powder as provided herein may have an IVDIAAS between 75 and 80, or between 80 and 85, or between 85 and 90, or between 90 and 92, or between 92 and 94, or between 94 and 96, or between 96 and 98, or between 98 and 100.

In some embodiments, the average protein nutritional quality score of the protein or protein powder provided herein, or a protein food product made with a protein powder as provided herein may have a IVDIAAS of at least 100, at least 110, at least 120, at least 130, at least 140, at least 150, at least 160, at least 170, at least 180, at least 190, or at least 200.

In some embodiments, the average protein nutritional quality score of the protein or protein powder provided herein, or a protein food product made with a protein powder as provided herein may have a IVDIAAS of between 100 and 110, or between 110 and 120, or between 120 and 130, or between 130 and 140, or between 140 and 150, or between 150 and 160, or between 160 and 170, or between 170 and 180, or between 180 and 190, or between 190 and 200.

In some embodiments, the protein or protein powder provided herein, or a protein food product made with a protein powder as provided herein comprises at least 50% by weight EAAs. In some embodiments, the protein or protein powder provided herein, or a protein food product made with a protein powder as provided herein comprises at least 55% by weight EAAs, at least 60% by weight EAAs, at least 65% by weight EAAs, at least 70% by weight EAAs, at least by weight 75% EAAs, at least 80% by weight EAAs, at least 85% by weight EAAs, at least 90% by weight EAAs, or at least 95% by weight EAAs, at least 96% by weight EAAs, at least 97% by weight EAAs, at least 98% by weight EAAs, at least 99% by weight EAAs, or 100% EAAs. In some embodiments, the protein or protein powder provided herein, or a protein food product made with a protein powder as provided herein comprises from 50 to 100% by weight EAAs, from 60 to 100% by weight EAAs, from 70 to 100% by weight EAAs, from 80 to 90% by weight EAAs, from 60 to 90% by weight EAAs, from 60 to 80% by weight EAAs, from 70 to 90% by weight EAAs, from 60 to 70% by weight EAAs, from 70 to 80% by weight EAAs, from 80 to 90% by weight EAAs, and from 90 to 100% by weight EAAs. In some embodiments, the protein or protein powder provided herein, or a protein food product made with a protein powder as provided herein comprises from 90% to 100% EAAs and CEAAs. In some embodiments, the protein or protein powder provided herein, or a protein food product made with a protein powder as provided herein comprises 100% EAAs and CEAAs.

### Amino Acid Content

Maize, rice, and wheat are staple foods in many regions of the world; however, proteins from these grains are limited in certain amino acids, making their protein of poor dietary quality. For example, maize protein is limited in the amino acids lysine and tryptophan. Rice and wheat are additionally limiting in lysine. Consequently, populations that rely heavily on these foods are lacking in at least one essential amino acids and require supplementation from other foods. The food products of the present disclosure comprise a high-protein content containing all 20 amino acids, Histidine (H), Isoleucine (I), Leucine (L), Lysine (K), Methionine (M), Phenylalanine (F), Threonine (T), Tryptophan (W), Valine (V), Alanine (A), Arginine (R), Asparagine (N), Aspartic Acid (D), Glutamine (Q), Glutamic Acid (E), Glycine (G), Proline (P), Serine (S), Cysteine (C) and Tyrosine (Y).

In some embodiments, the amino acid (protein) content of the protein or protein powder provided herein, or a protein food product made with a protein powder as provided herein comprises all 20 amino acids.

In some embodiments, the amino acid (protein) content comprising all 20 amino acids of a food composition or product made with a protein powder of the disclosure is between 20% to 25%, between 25% to 30%, between 30% to 35%, between 35% to 40%, between 40% to 45%, between 45% to 50%, between 50% to 55%, between 55% to 60%, between 60% to 65%, between 65% to 70%, between 70% to 75%, between 75% to 80%, between 80% to 85%, between 85% to 90%, between 90% to 95%, or between 95% to 100%.

In some embodiments, the amino acid (protein) content comprising all 20 amino acids of a food composition or product made with a protein powder of the disclosure is at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%, or 100%.

Among the amino acids are non-essential amino acids (NEAAs), conditionally-essential amino acids (CEAA), and essential amino acids (EAA). Among the EAA are branched-chain amino acids (BCAAs). A BCAA is an amino acid having an aliphatic side-chain with a branch (a central carbon atom bound to three or more carbon atoms). BCAAs include leucine, isoleucine, and valine.

In some embodiments, the BCAA content of a protein powder provided herein or a food product comprising a protein powder provided herein is between 20% to 25%, between 25% to 30%, between 30% to 35%, between 35% to 40%, between 40% to 45%, between 45% to 50%, between 50% to 55%, between 55% to 60%, between 60% to 65%, between 65% to 70%, between 70% to 75%, between 75% to 80%, between 80% to 85%, between 85% to 90%, between 90% to 95%, or between 95% to 100%.

In some embodiments, the BCAA content of a protein powder provided herein or a food product comprising a protein powder provided herein is at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%, or 100%.

### L-Amino Acids and D-Amino Acids

Amino acids are made from amine (—NH₂) and carboxylic acid (—COOH) functional groups, along with a side-chain specific to each type of amino acid. All amino acids (except glycine) can occur in two isomeric forms, because of the possibility of forming two different enantiomers (stereoisomers) around the central carbon atom. By convention, these stereoisomers are referred to as “L-” and “D-” forms, analogous to left-handed and right-handed configurations. Only L-amino acids are manufactured in cells and incorporated into proteins, whereas D-amino acids are more plentifully produced by microorganisms. The L-enantiomers of amino acids are widely assumed to account for most of their biological effects, including signaling, transporter-mediated protein interactions, and as a metabolic substrate. In mammals D-amino acids are believed to play a role in neuronal signaling. For example, D-serine is a potent ligand for the glycine binding site on the N-methyl-D-aspartate (NMDA) receptor. Other D-amino acids are present in the brain.

In some embodiments, a protein powder provided herein or a food product comprising a protein powder provided herein may comprise at least 0.0001% L-amino acids, at least 1% L-amino acids, at least 1% L-amino acids, at least 5% L-amino acids, at least 10% L-amino acids, at least 15% L-amino acids, at least 20% L-amino acids, at least 25% L-amino acids, at least 30% L-amino acids, at least 35% L-amino acids, at least 40% L-amino acids, at least 45% L-amino acids, at least 50% L-amino acids, at least 55% L-amino acids, at least 60% L-amino acids, at least 65% L-amino acids, at least 70% L-amino acids, at least 75% L-amino acids, at least 80% L-amino acids, at least 85% L-amino acids, at least 90% L-amino acids, at least 95% L-amino acids, or at least 99% L-amino acids.

In some embodiments, a protein powder provided herein or a food product comprising a protein powder provided herein may comprise between 0.0001% to 1% L-amino acids, between 1% to 5% L-amino acids, between 5% to 10% L-amino acids, between 10% to 15% L-amino acids, between 15% to 20% L-amino acids, between 20% to 25% L-amino acids, between 25% to 30% L-amino acids, between 30% to 35% L-amino acids, between 35% to 40% L-amino acids, between 40% to 45% L-amino acids, between 45% to 50% L-amino acids, between 50% to 55% L-amino acids, between 55% to 60% L-amino acids, between 60% to 65% L-amino acids, between 65% to 70% L-amino acids, between 70% to 75% L-amino acids, between 75% to 80% L-amino acids, between 80% to 85% L-amino acids, between 85% to 90% L-amino acids, between 90% to 95% L-amino acids, or between 95% to 99.9999% L-amino acids.

In some embodiments, a protein powder provided herein or a food product comprising a protein powder provided herein may comprise at least 0.0001% D-amino acids, at least 1% D-amino acids, at least 1% D-amino acids, at least 5% D-amino acids, at least 10% D-amino acids, at least 15% D-amino acids, at least 20% D-amino acids, at least 25% D-amino acids, at least 30% D-amino acids, at least 35% D-amino acids, at least 40% D-amino acids, at least 45% D-amino acids, at least 50% D-amino acids, at least 55% D-amino acids, at least 60% D-amino acids, at least 65% D-amino acids, at least 70% D-amino acids, at least 75% D-amino acids, at least 80% D-amino acids, at least 85% D-amino acids, at least 90% D-amino acids, at least 95% D-amino acids, or at least 99% D-amino acids.

In some embodiments, a protein powder provided herein or a food product comprising a protein powder provided herein may comprise between 0.0001% to 1% D-amino acids, between 1% to 5% D-amino acids, between 5% to 10% D-amino acids, between 10% to 15% D-amino acids, between 15% to 20% D-amino acids, between 20% to 25% D-amino acids, between 25% to 30% D-amino acids, between 30% to 35% D-amino acids, between 35% to 40% D-amino acids, between 40% to 45% D-amino acids, between 45% to 50% D-amino acids, between 50% to 55% D-amino acids, between 55% to 60% D-amino acids, between 60% to 65% D-amino acids, between 65% to 70% D-amino acids, between 70% to 75% D-amino acids, between 75% to 80% D-amino acids, between 80% to 85% D-amino acids, between 85% to 90% D-amino acids, between 90% to 95% D-amino acids, or between 95% to 99.9999% D-amino acids.

### Serving Size

Food manufacturers usually indicate the serving size on a label describing the nutritional value of a food product, and under national food labeling laws, certain laws oblige you to provide specific instructions for determining the serving size of a food product. See, for example, US federal code under heading 21—Food and Drug Administration, § 101.12. The serving or serving size can be any serving size known in the art for the particular food product such as, for example, a serving size in units of weight, volume or numbers of items. In one embodiment, a food composition or product made with a protein powder as provided herein comprises at least 2, 3, 4, 5, 6, 7, 8, 9, 10, 11, 12, 13, 14, 15, 16, 17, 18, 19 or 20 times the amount of protein per serving in the food product than is commonly provided by said product. The remaining macronutrient content of the protein-enriched food product as provided herein can be a typical macronutrient content per serving known in the art for the particular type of food product. The serving can be any serving size known in the art for the particular food product such as, for example, a serving size in units of weight, volume or numbers of items.

In one embodiment, a food composition or product made with a protein powder as provided herein comprises at least, at most, exactly or about 5, 6, 7, 8, 9, 10, 11, 12, 13, 14, 15, 16, 17, 18, 19, 20, 21, 22, 23, 24, 25, 26, 27, 28, 29 or 30 grams (g) of protein(s) per serving. In one embodiment, a food composition or product made with a protein powder as provided herein comprises from 5-10, 10-15, 15-20, 20-25 or 25-30 grams (g) of protein(s) per serving. In one embodiment, a food composition or product made with a protein powder as provided herein comprises between 5-10, 10-15, 15-20, 20-25 or 25-30 grams (g) of protein(s) per serving. The serving size can be any standard serving size known in the art for a particular type of food product. The serving size can be any unit of measure known in the art such as, for example, weight, volume or number of food items. In one embodiment, the serving or serving size is at least, at most, exactly or about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g) of the finished product.

In some embodiments, the serving size is 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 grams (g) of the finished product.

In some embodiments, the serving size is about 100, about 200, about 300, about 400, about 500, about 600, about 700, about 800, about 900, or about 1,000 grams (g) of the finished product.

In some embodiments, the serving size is about from 1 to about 10, about from 10 to about 20, about from 20 to about 30, about from 30 to about 40, about from 40 to about 50, about from 50 to about 60, about from 60 to about 70, about from 70 to about 80, about from 80 to about 90, about from 90 to about 100, about from 100 to about 200, from about 200 to about 300, from about 300 to about 400, from about 400 to about 500, from about 500 to about 600, from about 600 to about 700, from about 700 to about 800, from about 800 to about 900, or about 900 to about 1,000 grams (g) of the finished product.

Typical macronutrients content (not accounting for sodium, other micronutrients and food additives <2 g), in said food products of the present invention can be carbohydrates that can range from 0-15 g, dietary fiber that can range from 0 to 15, fats that can range from 0 to 5 g, and moisture as the remaining component per serving, such as for example a serving size of 50 g.

In some embodiments, a serving size is at least 1 calorie, at least 50 calories, at least 100 calories, at least 150 calories, at least 200 calories, at least 250 calories, at least 300 calories, at least 350 calories, at least 400 calories, at least 450 calories, at least 500 calories, at least 550 calories, at least 600 calories, at least 650 calories, at least 700 calories, at least 750 calories, at least 800 calories, at least 850 calories, at least 900 calories, at least 950 calories, or at least 1,000 calories.

In some embodiments, a serving size is between 1 calorie to 50 calories, between 50 calories to 100 calories, between 100 calories to 150 calories, between 150 calories to 200 calories, between 200 calories to 250 calories, between 250 calories to 300 calories, between 300 calories to 350 calories, between 350 calories to 400 calories, between 400 calories to 450 calories, between 450 calories to 500 calories, between 500 calories to 550 calories, between 550 calories to 600 calories, between 600 calories to 650 calories, between 650 calories to 700 calories, between 700 calories to 750 calories, between 750 calories to 800 calories, between 800 calories to 850 calories, between 850 calories to 900 calories, between 900 calories to 950 calories, or between 950 calories to 1,000 calories.

In some embodiments, a serving size is less than 1 gram of fat.

In some embodiments, a serving size is at least 1 gram of fat, at least 2 grams of fat, at least 3 grams of fat, at least 4 grams of fat, at least 5 grams of fat, at least 6 grams of fat, at least 7 grams of fat, at least 8 grams of fat, at least 9 grams of fat, at least 10 grams of fat, at least 11 grams of fat, at least 12 grams of fat, at least 13 grams of fat, at least 14 grams of fat, at least 15 grams of fat, at least 16 grams of fat, at least 17 grams of fat, at least 18 grams of fat, at least 19 grams of fat, or at least 20 grams of fat.

In some embodiments, a serving size is between 1 to 2 grams of fat, between 2 grams of fat to 3 grams of fat, between 3 grams of fat to 4 grams of fat, between 4 grams of fat to 5 grams of fat, between 5 grams of fat to 6 grams of fat, between 6 grams of fat to 7 grams of fat, between 7 grams of fat to 8 grams of fat, between 8 grams of fat to 9 grams of fat, between 9 grams of fat to 10 grams of fat, between 10 grams of fat to 11 grams of fat, between 11 grams of fat to 12 grams of fat, between 12 grams of fat to 13 grams of fat, between 13 grams of fat to 14 grams of fat, between 14 grams of fat to 15 grams of fat, between 15 grams of fat to 16 grams of fat, between 16 grams of fat to 17 grams of fat, between 17 grams of fat to 18 grams of fat, between 18 grams of fat to 19 grams of fat, or between 19 grams of fat to 20 grams of fat.

In some embodiments, a serving size is at least 1 gram of protein, at least 2 grams of protein, at least 3 grams of protein, at least 4 grams of protein, at least 5 grams of protein, at least 6 grams of protein, at least 7 grams of protein, at least 8 grams of protein, at least 9 grams of protein, at least 10 grams of protein, at least 11 grams of protein, at least 12 grams of protein, at least 13 grams of protein, at least 14 grams of protein, at least 15 grams of protein, at least 16 grams of protein, at least 17 grams of protein, at least 18 grams of protein, at least 19 grams of protein, at least 20 grams of protein, at least 25 grams of protein, at least 30 grams of protein, at least 35 grams of protein, at least 40 grams of protein, at least 45 grams of protein, or at least 50 grams of protein.

In some embodiments, a serving size is between 1 to 2 grams of protein, between 2 grams of protein to 3 grams of protein, between 3 grams of protein to 4 grams of protein, between 4 grams of protein to 5 grams of protein, between 5 grams of protein to 6 grams of protein, between 6 grams of protein to 7 grams of protein, between 7 grams of protein to 8 grams of protein, between 8 grams of protein to 9 grams of protein, between 9 grams of protein to 10 grams of protein, between 10 grams of protein to 11 grams of protein, between 11 grams of protein to 12 grams of protein, between 12 grams of protein to 13 grams of protein, between 13 grams of protein to 14 grams of protein, between 14 grams of protein to 15 grams of protein, between 15 grams of protein to 16 grams of protein, between 16 grams of protein to 17 grams of protein, between 17 grams of protein to 18 grams of protein, between 18 grams of protein to 19 grams of protein, between 19 grams of protein to 20 grams of protein, between 20 grams of protein to 25 grams of protein, between 25 grams of protein to 30 grams of protein, between 30 grams of protein to 35 grams of protein, between 35 grams of protein to 40 grams of protein, between 40 grams of protein to 45 grams of protein, or between 45 grams of protein to 50 grams of protein.

In some embodiments, a serving size is less than 1 gram of carbohydrate.

In some embodiments, a serving size is at least 1 gram of carbohydrate, at least 2 grams of carbohydrate, at least 3 grams of carbohydrate, at least 4 grams of carbohydrate, at least 5 grams of carbohydrate, at least 6 grams of carbohydrate, at least 7 grams of carbohydrate, at least 8 grams of carbohydrate, at least 9 grams of carbohydrate, at least 10 grams of carbohydrate, at least 11 grams of carbohydrate, at least 12 grams of carbohydrate, at least 13 grams of carbohydrate, at least 14 grams of carbohydrate, at least 15 grams of carbohydrate, at least 16 grams of carbohydrate, at least 17 grams of carbohydrate, at least 18 grams of carbohydrate, at least 19 grams of carbohydrate, or at least 20 grams of carbohydrate.

In some embodiments, a serving size is between 1 to 2 grams of carbohydrate, between 2 grams of carbohydrate to 3 grams of carbohydrate, between 3 grams of carbohydrate to 4 grams of carbohydrate, between 4 grams of carbohydrate to 5 grams of carbohydrate, between 5 grams of carbohydrate to 6 grams of carbohydrate, between 6 grams of carbohydrate to 7 grams of carbohydrate, between 7 grams of carbohydrate to 8 grams of carbohydrate, between 8 grams of carbohydrate to 9 grams of carbohydrate, between 9 grams of carbohydrate to 10 grams of carbohydrate, between 10 grams of carbohydrate to 11 grams of carbohydrate, between 11 grams of carbohydrate to 12 grams of carbohydrate, between 12 grams of carbohydrate to 13 grams of carbohydrate, between 13 grams of carbohydrate to 14 grams of carbohydrate, between 14 grams of carbohydrate to 15 grams of carbohydrate, between 15 grams of carbohydrate to 16 grams of carbohydrate, between 16 grams of carbohydrate to 17 grams of carbohydrate, between 17 grams of carbohydrate to 18 grams of carbohydrate, between 18 grams of carbohydrate to 19 grams of carbohydrate, or between 19 grams of carbohydrate to 20 grams of carbohydrate.

### EXAMPLES

The present invention is further illustrated by reference to the following Examples. However, it should be noted that these Examples, like the embodiments described above, are illustrative and are not to be construed as restricting the scope of the invention in any way.

### Example 1 Modification of Water Holding of Various Protein Powders

### Background

Developing high protein products is critical for Human nutrition and health. However, achieving high levels of protein without compromising texture, taste, or other properties is difficult. Herein methods are demonstrated for preparing high protein powders such that they can be mixed into doughs and baked products in a way that provides for superior baking or cooking properties as well as maintaining or even improving the taste, texture, and other properties critical to consumers are demonstrated. Application of this method is then implemented to provide several examples of high-protein baked products.

### Experiments on Water Hydration of Protein

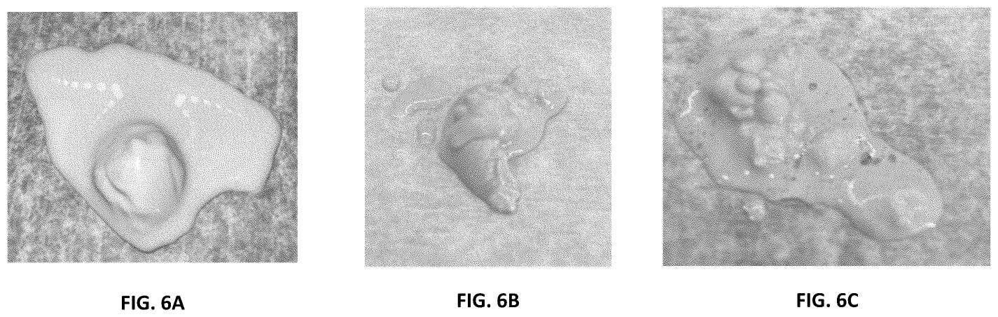

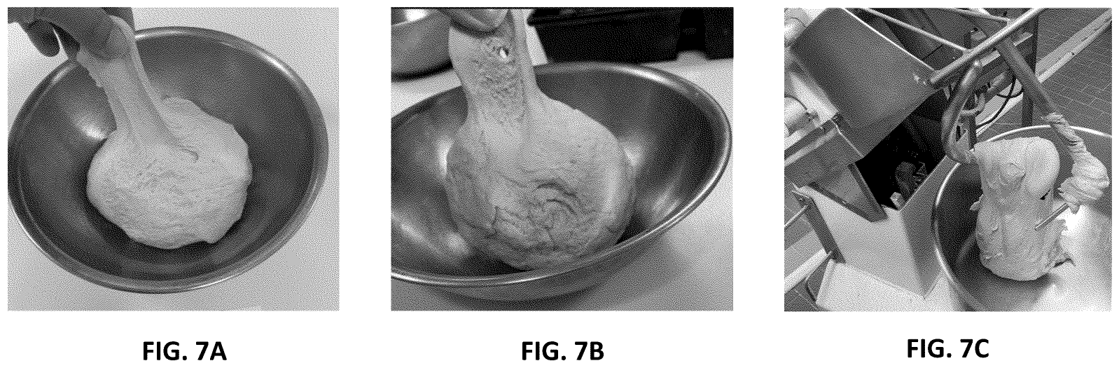

Water hydration of the protein was modified by a combination of one or more processes that include a) environmental adjustment (such as pH, salt concentration, other ingredients etc.), b) temperature, c) shearing protein, d) particle size; or a combination of these processes to impact hydration of protein. These changes can be made in either a low moisture high fat environment or a high moisture low fat environment. Combination of one or more of these processes leads to (1) exposure of hydrophobic protein, or (2) lipophilic protein structure that interacts less with water, or (3) aggregates of protein that are stabilized by intermolecular interactions of amino acids chains to adjacent amino acids chains. These intermolecular interactions trigger formation of aggregates that squeezes water out this interacting less with water. These phenomenon as described above in (1) to (3) were key technology enablers (see FIG. 6) in generating a tailored protein for use in a protein powder provided herein with controllable water interaction properties that influence the amount of water needed for hydration.

### Materials and Methods

High protein powders were produced using an aqueous extraction method that used a starting material consisting of plant proteins, or microbial proteins (microbial biomass) or a combination thereof. Collectively, these input proteins which are listed in Table 1 below can be referred to as “protein biomass”. The protein biomass used as an input raw material showed a minimum protein purity of 20 to 30% protein on dry weight basis and possessed the water holding capacities shown in Table 1 prior to treatment described in (a)-(d) above.

TABLE 1
Example of water holding capacity of various protein powders

| | WHC (g/100 g material) |
|---|---|
| Wheat Flour | 78 |
| Oat Flour | 96 |
| Soy Protein Isolate | 629 |
| Soy Protein concentrate | 353 |
| Pea Protein isolate | 367 |
| Pea Protein flour | 280 |
| Chickpea flour | 144 |
| Yeast protein | 225 |

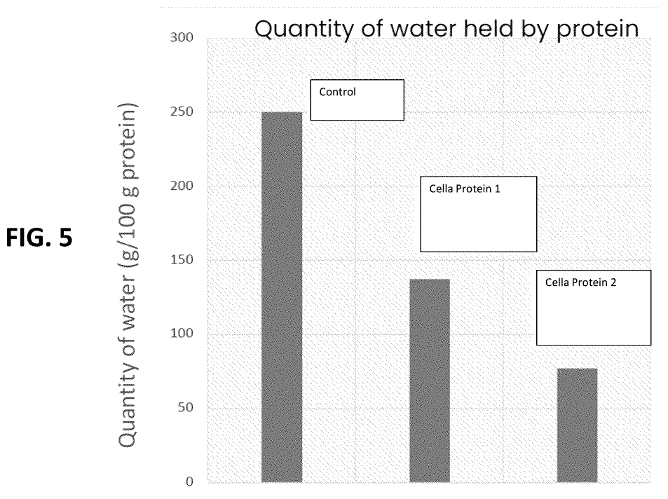

FIG. 5 shows results from testing of Quantity of Water held by various proteins.

In one specific line of experiment, yeast protein biomass (referred to as Cella Protein) was subjected to one or more of the treatments described in (a)-(d) as follows. The high protein powders (collectively referred here as Cella Protein samples) are formed from yeast protein biomass. Yeast protein biomass was obtained following fermentation of plant biomass (malt extract (Malt Corporation)) in YPD media with S. cerevisiae. Following fermentation, solids were recovered by filtration and/or centrifugal force formed into a slurry by mixing 1:10 parts of solids from the yeast protein biomass to water, on a w/w basis. The slurry was mixed continuously and adjusted for pH using 5% v/v hydrochloric acid or 5% w/v sodium hydroxide to generate one Cella Protein group with a pH of 3.5 (Cella Protein 3), one group with a pH of 5.5 (Cella Protein 2) or one Cella Protein group with a pH of 8.5 (Cella Protein 4). The non-pH adjusted yeast protein biomass having a pH value of 6.6 served as the Cella Protein Control. The temperature of the slurry for each Cella Protein group was adjusted to and held at 75° C. or 95° C. for two additional different treatment conditions and NaCl was either omitted or added at 5% v/v to each Cella Protein group to generate a further two different treatment conditions (see Table 3). The slurries in each Cella Protein group was then continuously mixed for 30 minutes and then filtered to separate solids (protein-rich material) from solubles. The protein rich solids from each Cella Protein group were then re-slurried in water and pH adjusted to their respective pH values of 3.5, 5.5 and 8.5 to yield the three different treatment conditions (i.e., Cella Protein-2 and Cella protein-3, and Cella Protein 4 as noted previously herein). Each slurry was then mixed for 30 minutes and subsequently treated with a cocktail of enzymes consisting of equal parts by percentage of dry cell weight of amylase, protease, xylanase and cellulase with a final concentration of each enzyme ranging from 0.1% to 0.5% for 1 hour. Enzymes were provided by Novozymes™ (Franklinton, NC, USA 27525). Next, the enzymes were inactivated by heat treatment (85° C. for 10 minutes) and each slurry was wet milled, using simple mechanical milling that broke particle sizes and induced shear while milling. The wet milled slurries were then filtered to recover solids that were further dried to forma high protein powder (i.e., Cella Protein 2, Cella Protein 3 and Cella Protein 4). In all examples of protein production, the protein content of the “protein powders” ranged from 30-80% dry wt basis.

In parallel, pea protein flour (ProFam® Pea 580, Archer Daniels Midland) was subjected to the same treatments as the Cella Protein groups.

The water holding capacity of the resultant powders for the Cella Protein groups and Pea Protein groups were then ascertained using standard methods in the art. Table 2 shows the differential WHC of either pea protein or Cella Protein Control at various pH values. Table 3 shows the alterations in WHC as a result of changes in pH, salt %, temperature.

TABLE 2
Effect of the pH value of water added to proteins
powders on the water holding capacity of protein

| Protein source | pH of added water | WHC (g/100 g material) |
|---|---|---|
| Pea protein flour | 3 | 411 |
| | 4 | 276 |
| | 5 | 229 |
| | 7 | 260 |
| Cella protein control | 3 | 146 |
| | 4 | 127 |
| | 5 | 96 |
| | 7 | 117 |

TABLE 3
Change in water holding capacity of protein ingredients
by changing pH, salt and temperature.

| | | Temperature | Salt | WHC (g/100 g |
|---|---|---|---|---|
| | pH | ° C. | (NaCl %) | material) |
| Pea Protein | 6.5 | | 0 | 280 |
| Flour-Control | | | | |
| Pea Protein | 3.5 | 75 | 0 | 440 |
| Pea Protein | 3.5 | 90 | 0 | 480 |
| Pea Protein | 3.5 | 75 | 5 | 380 |
| Pea Protein | 3.5 | 90 | 5 | 340 |
| Pea Protein | 5.5 | 75 | 0 | 320 |
| Pea Protein | 5.5 | 90 | 0 | 360 |
| Pea Protein | 5.5 | 75 | 5 | 260 |
| Pea Protein | 5.5 | 90 | 5 | 220 |
| Pea Protein | 8.5 | 75 | 0 | 240 |
| Pea Protein | 8.5 | 90 | 0 | 260 |
| Pea Protein | 8.5 | 75 | 5 | 180 |
| Pea Protein | 8.5 | 90 | 5 | 150 |
| Cella Protein- | 5.65 | | | 94 |
| Control | | | | |
| Cella Protein 3 | 3.5 | 75 | 0 | 134 |
| Cella Protein 3 | 3.5 | 90 | 0 | 144 |
| Cella Protein 3 | 3.5 | 75 | 5 | 120 |
| Cella Protein 3 | 3.5 | 90 | 5 | 110 |
| Cella Protein 2 | 5.5 | 75 | 0 | 102 |
| Cella Protein 2 | 5.5 | 90 | 0 | 107 |
| Cella Protein 2 | 5.5 | 75 | 5 | 88 |
| Cella Protein 2 | 5.5 | 90 | 5 | 82 |
| Cella Protein 4 | 8.5 | 75 | 0 | 120 |
| Cella Protein 4 | 8.5 | 90 | 0 | 130 |
| Cella Protein 4 | 8.5 | 75 | 5 | 110 |
| Cella Protein 4 | 8.5 | 90 | 5 | 115 |

### Conclusions

This Example demonstrates ways to modify proteins such that water of hydration is close to the water hydration of wheat flour (such as 78 g water/100 g wheat flour as shown in Table 1) used in various doughs. Accordingly, it is predicted that finished food products comprising a protein modified to possess a desired WHC as detailed above should have similar texture and taste to conventional doughs, batters, aqueous and dry mixes. The following Examples disclose testing of this hypothesis.

### Examples 2-6

The following Examples disclose methods for formulating food products with high protein content using the protein powder provided herein (e.g., the microbial protein or the protein comprising of microbial protein and plant protein). It is often challenging to add a high amount of protein without changing the look and sensorial feel or satisfaction of a product when consumed. For example, bread may come out very dense and spongy and lead to a very different eating experience for consumers or a bread crumb may come out very dense and spongy which leads to an undesirable texture and taste. One of the reasons it is challenging to add protein to dough or breading is the difference in water holding properties of flour and the fortifying protein. When adding protein powder to fortify a dough or batter with increased protein, the protein in the powder competes for water in the dough/batter mixture. For example, flour used in bread making has water holding capacity of 65 to 90 (g of water/100 g flour), while most proteins (plant-based) as used commercially in food applications have water holding capacity in range of 110 to 700 (g of water/100 g protein powder). That means that in breadmaking the formulation with high protein will require extra water to complete hydration of wheat gluten. Hydration of wheat gluten is critical to develop the dough properties with optimum elasticity and stretch (Mohammed et al, 2014). Addition of this extra water leads to poor dough development and baking performance that results in soggy, dense bread or limiting this extra water leads to chalky/gritty texture in finished baked goods. This issue had been highlighted by Traynham et al. 2007 where they could just blend 2% soybean flour to wheat flour without impacting hydration (water holding capacity (WHC)). Mohammed et al., 2014 found it challenging to incorporate chickpea flour (containing 25% protein) at 10, 20 and 30% replacement of wheat flour to make bread. They observed sticky dough, reduction in baking loss, loaf height, loaf volume and specific volume compared to regular wheat flour bread.

While nutrient rich pizza doughs have been provided (Gupta et al. 2014) using soy protein isolate, plant proteins were also used to fortify a variety of foods (Sharif et al. 2022). Brewer's spent grains have been used to enrich pasta (Cuomo et al. 2022) and high protein soups have been prepared from dried milk powder (Srilekha et al. 2022). Previous methods for single cell protein (SCP) (e.g., proteins from microbial biomass such as the proteins in the protein powders provided herein) integration into foods have been hampered by lower levels of protein or impact on organoleptic properties. In the following Examples, a variety of formulation methods were performed that produced the food product in the respective Example, which maintained taste and sensory qualities while also containing a high level of nutritious protein (e.g., essential amino acids). Here, methods are provided for formulation that overcome these limitations.

### Example 2—High Protein Bread Comprising Protein Powder Provided Herein

### Background

High protein breads have been made using for example poppy seed flour (Wojcik et al., 2022)) or microalgae. SCP (Single Cell Protein) has been mixed into bread at various levels. Khan et al 2022 found that levels of up to 4% could be added before affecting organoleptic properties.

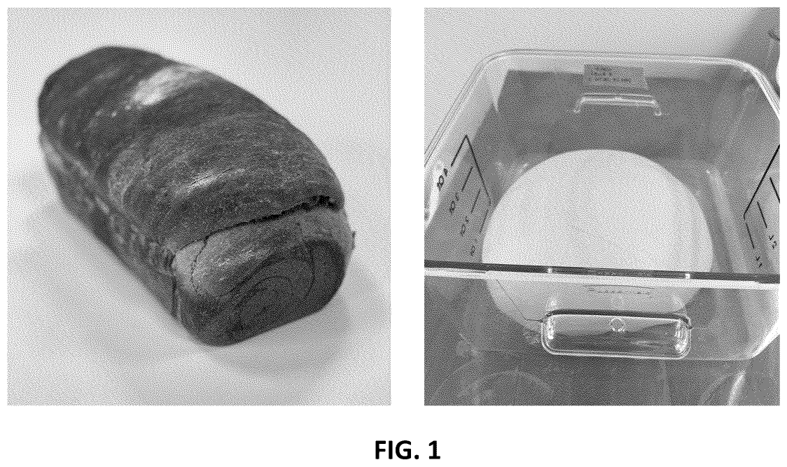

Based on the studies in Example 1, protein powder with a desired water holding capacity (WHC) of 82 (e.g., Cella Protein 2) was used to construct a variety of high protein doughs & baked products, starting with a high protein bread with excellent organoleptic properties (see FIG. 1).

### Objective

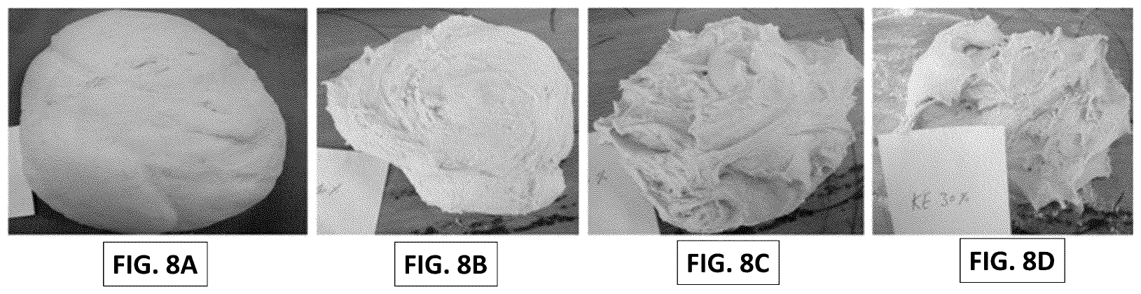

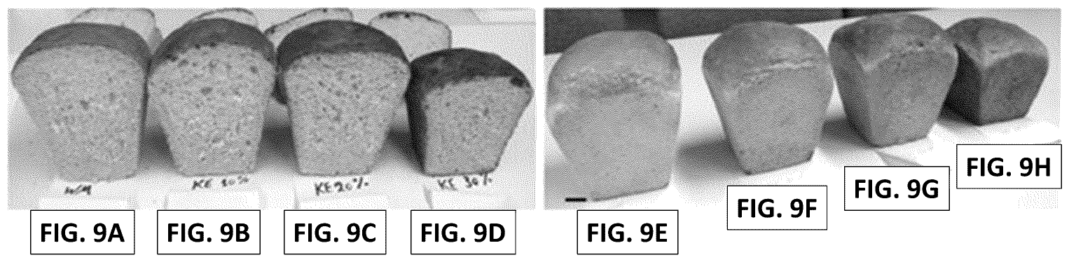

The purpose of this Example was to produce a classic white bread using a high protein powder as provided herein (e.g., Cella protein 2) and compare to a variety of dough formulations with different levels of wheat flour or chickpea flour (see FIGS. 8A-D, and 9A-H).

### Method of Mixing Dry Ingredients and Baking Technique for Classic Plain Bread:

In a mixing bowl, high gluten wheat flour, protein powder (i.e., Cella Protein-2 from Example 1), yeast, oil, fresh or dry yeast and water were mixed using the formulation set forth in Table 4.

TABLE 4
Ingredients for preparing classic white bread
using a high protein powder provided herein.

| Ingredient | %, wt basis |
|---|---|
| High gluten wheat Flour | 33 |
| Cella Protein-2 (from | 13 |
| Example 1; i.e., microbial | |
| protein obtained from | |
| fermentation of plant | |
| biomass by microbe and | |
| WHC altered to 82 g/100 g | |
| material as discussed in | |
| Example 1) | |
| Water | 50.5 |
| Fresh Yeast | 2 |
| Sugar or sweeteners | — |
| (optional) | |
| Salt | 1.5 |
| Bakery Enzymes and | — |
| Lecithin (optional) | |
| Grape seed oil (optional) | — |

The ingredients were scaled precisely and were added and mixed at low speed for 5 minutes. Thereafter, the contents in the bowl were mixed at a high speed for another 5 minutes. Optional ingredients, as known to the someone skilled in the art, included: sugar (e.g., dextrose, maltose, sucrose) or sweeteners (e.g., erythritol, stevia), vegetable oils (canola, grape seed oil), bakery enzymes (blend of amylase, xylanase, lipase), and emulsifiers (e.g., sunflower lecithin) can be added in the ingredient mix. The dough was mixed until a smooth and cohesive texture of dough is formed (see FIG. 1 right panel). The dough was then portioned, proofed at 82° F. and 80% humidity for about 60-70 minutes. The proofing time was based on the type of yeast, optional ingredients, and amount of portioned dough. The dough was then left to rest for 10 minutes before molding into its final shape in the pan. A second round of proofing of the dough was done at 82° F. and 80% humidity for about 60-70 minutes. The dough was then baked in a conventional oven at 340° F. for 35 to 40 minutes.

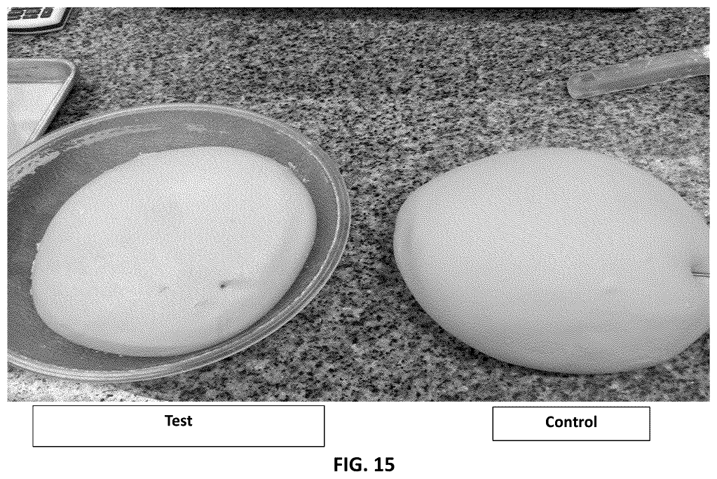

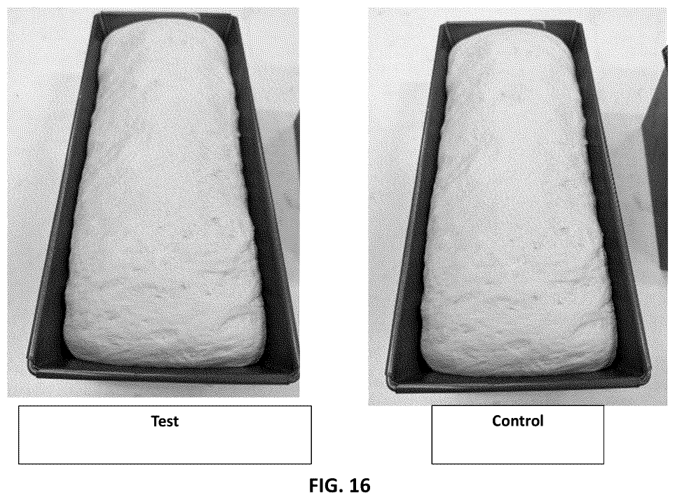

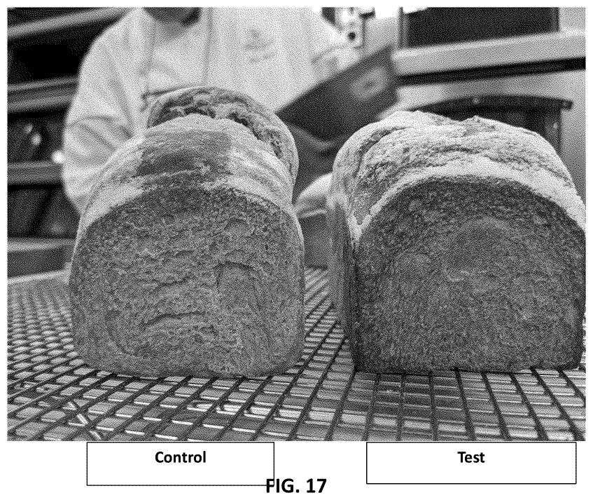

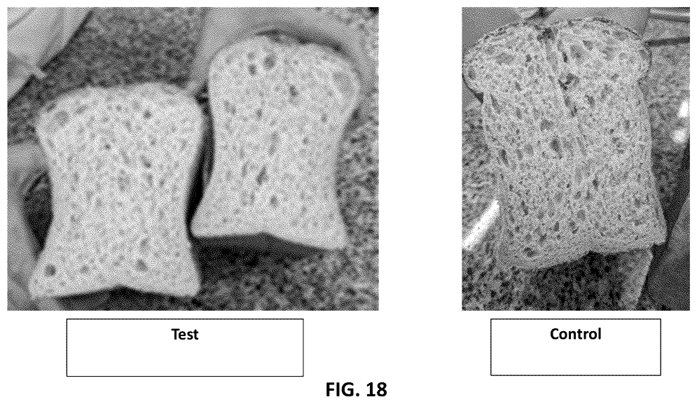

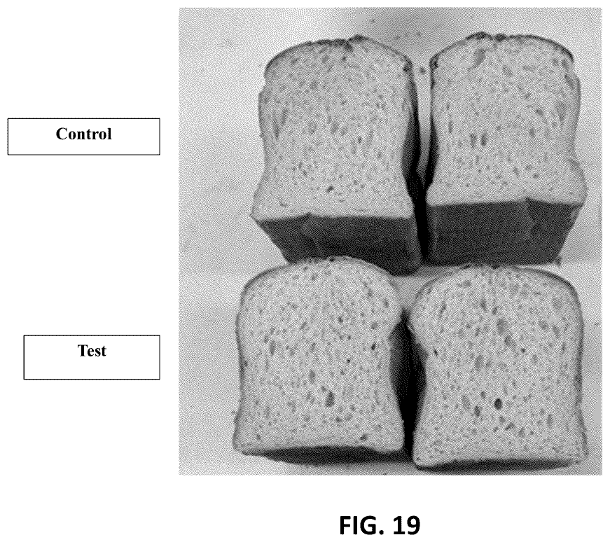

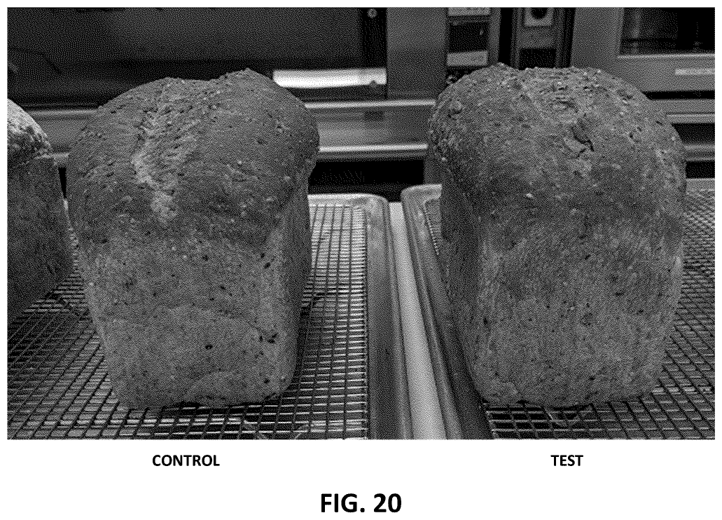

FIGS. 15-20 show the entire baking process for the bread with side-by-side comparison to the control samples. Overall, the dough and bread texture showed superior properties in baking, rise of dough, height of the loaf, uniform air cells, and crumb texture.

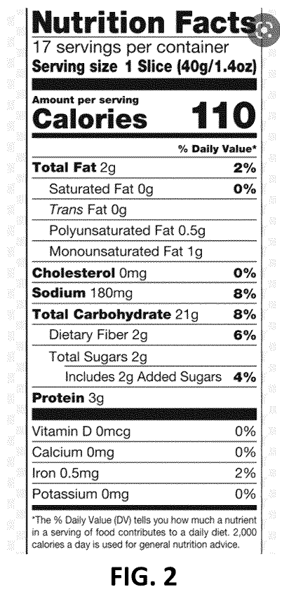

The high protein bread showed texture and taste properties similar to control samples comprising Dave's Killer Bread-White Bread Done Right, which had protein levels typical of commercially available bread (FIG. 2).

### Method of Measuring Texture and Sensory Properties of Bread

The texture profile analysis on the bread slices was performed according to modified AACC method 74-09 Measurement of Bread Firmness (1995). TAXTPlus (Stable Micro Systems, Inc.) equipped with TA-3 1″ compression rig was used to perform compression of bread slices.

The bread was also given a quantitative sensory score based on the flavor, texture and appearance attributes as determined by a panel of analysts. Chewiness is an important sensorial and organoleptic attribute that is attributed to the textural deformation of bread during mastication in mouth. It represents energy needed to disintegrate the structure of bread in the first chew and then the subsequent chews which forms a semi-solid bola during chewing and swallowing of food. The bread firmness measurement indicated how hardness of structure can results when bread structure if airy or very dense (less airy). The airy and less airy structures are often result from improper dough formation due to under-hydration or over hydration of dough when additional proteins are added in the formulation.

### Bread Test Results

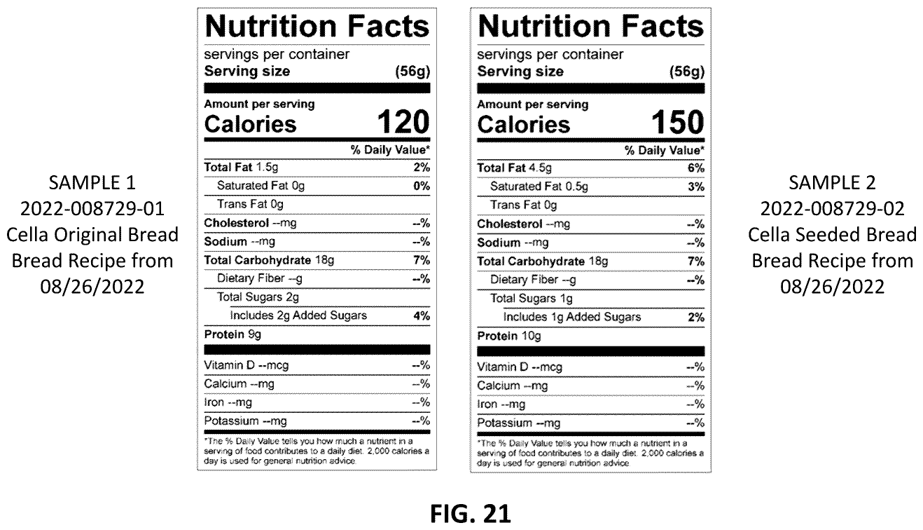

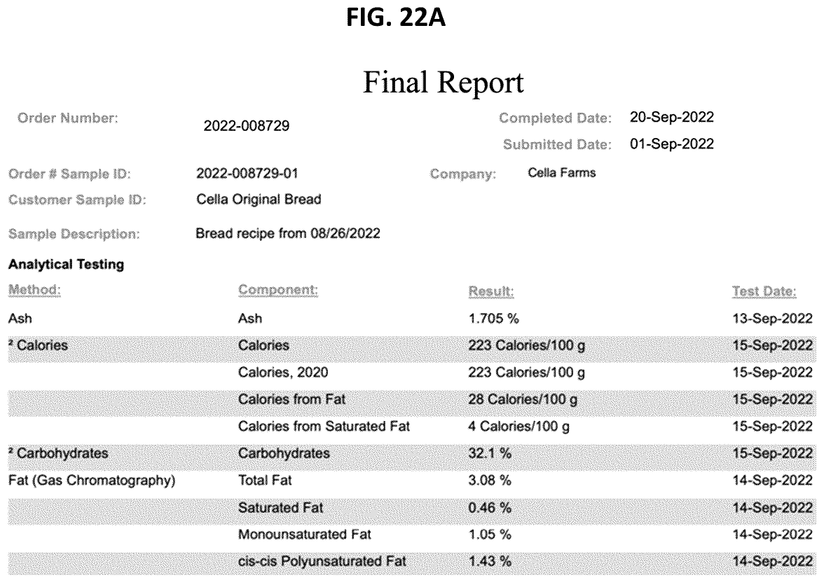

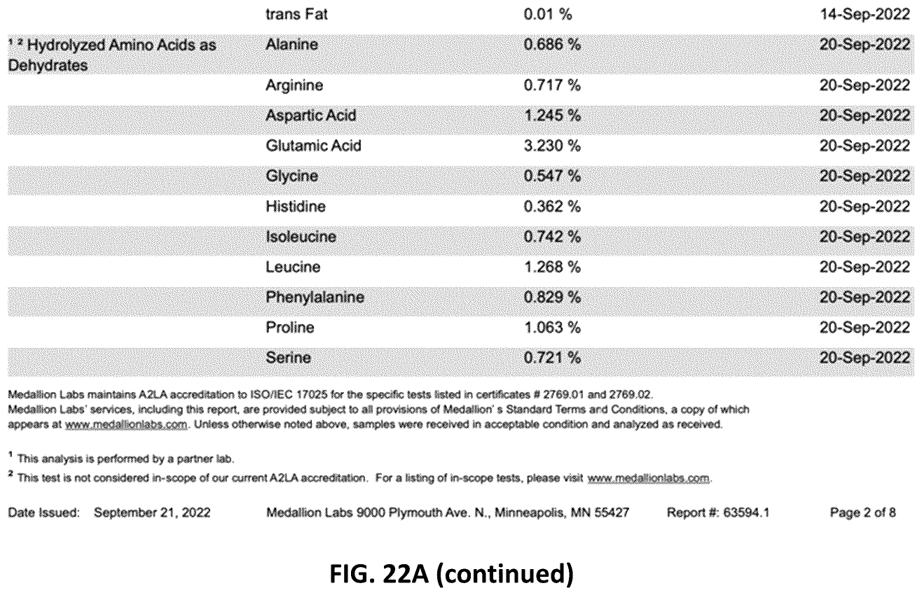

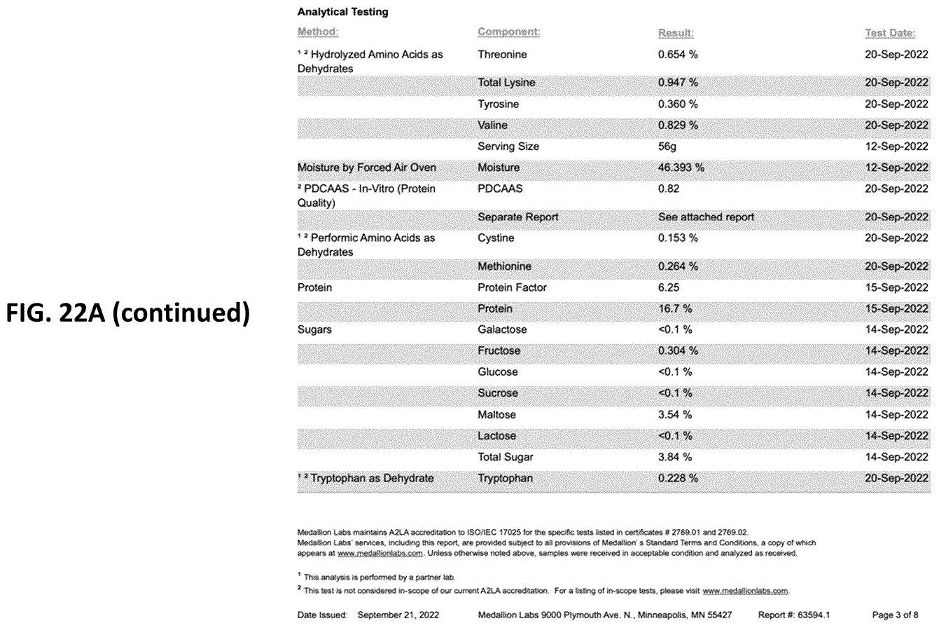

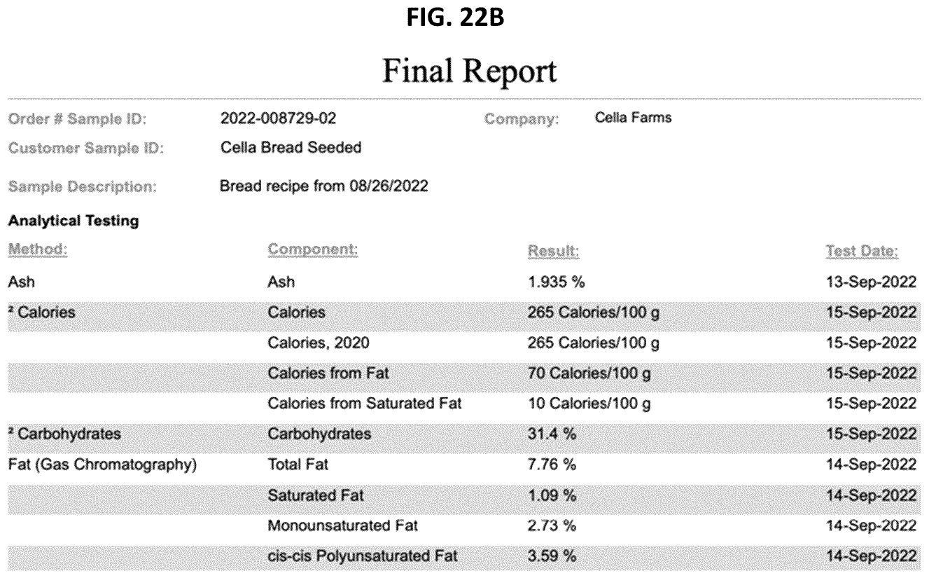

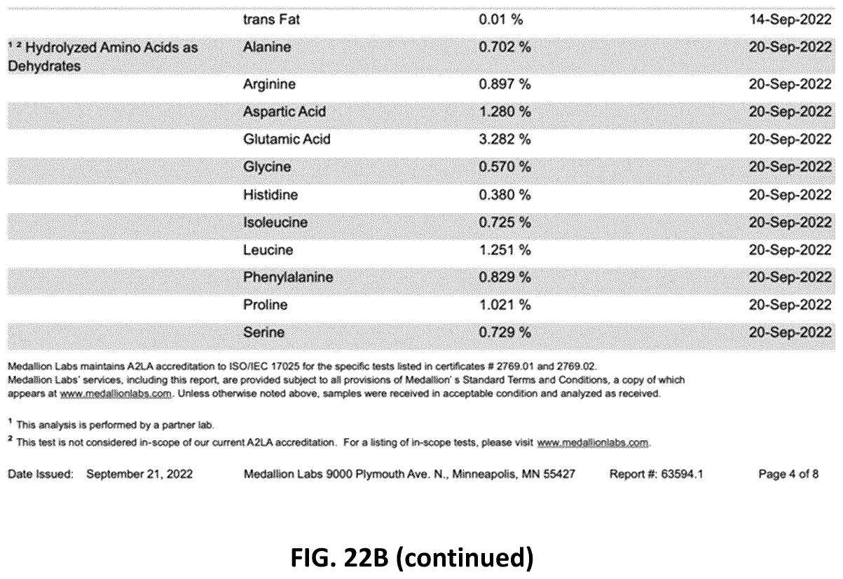

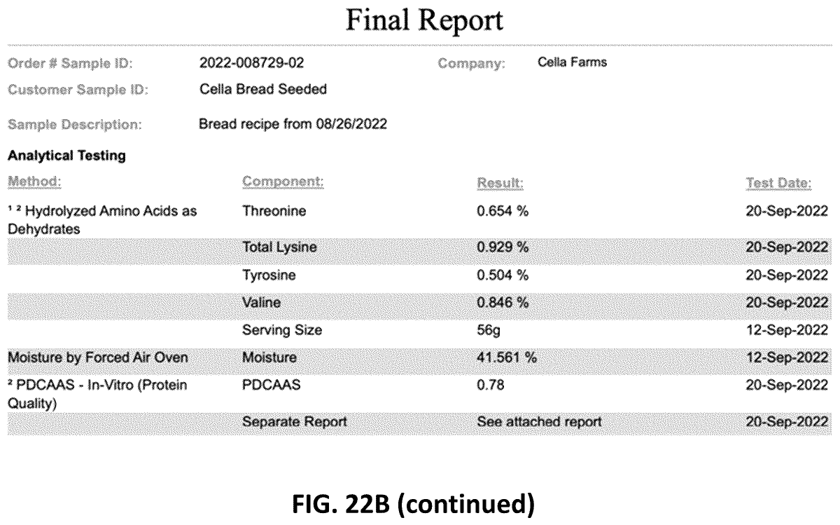

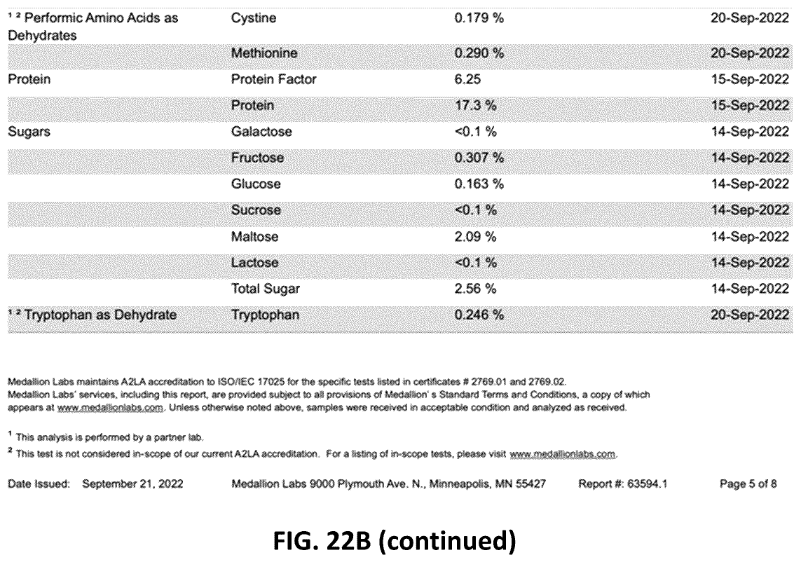

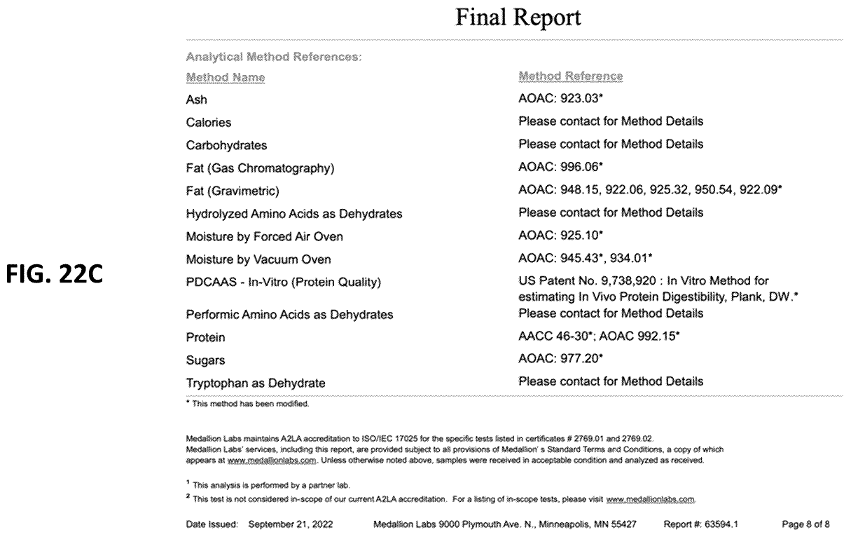

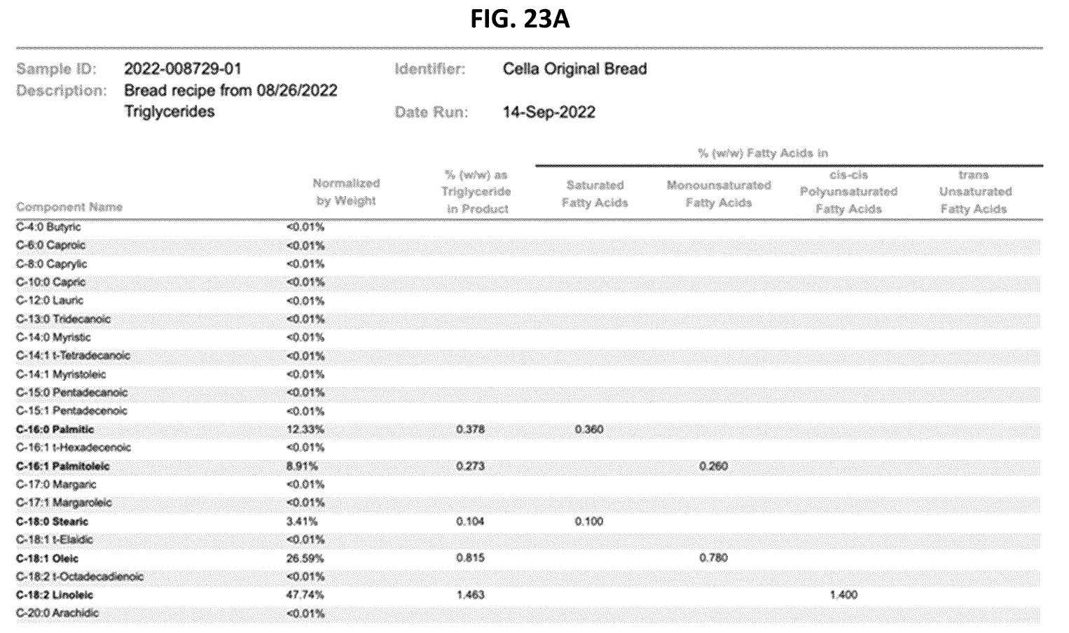

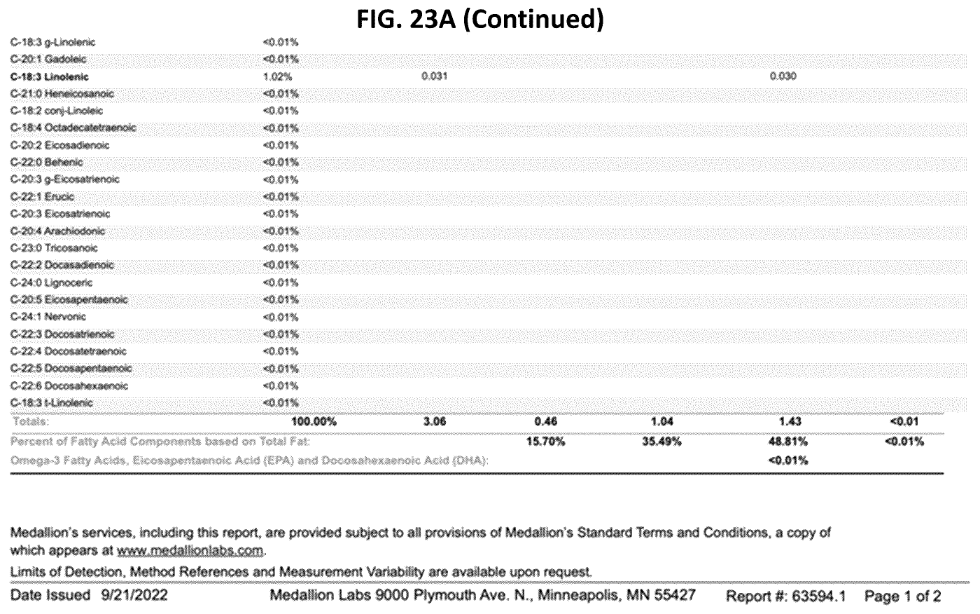

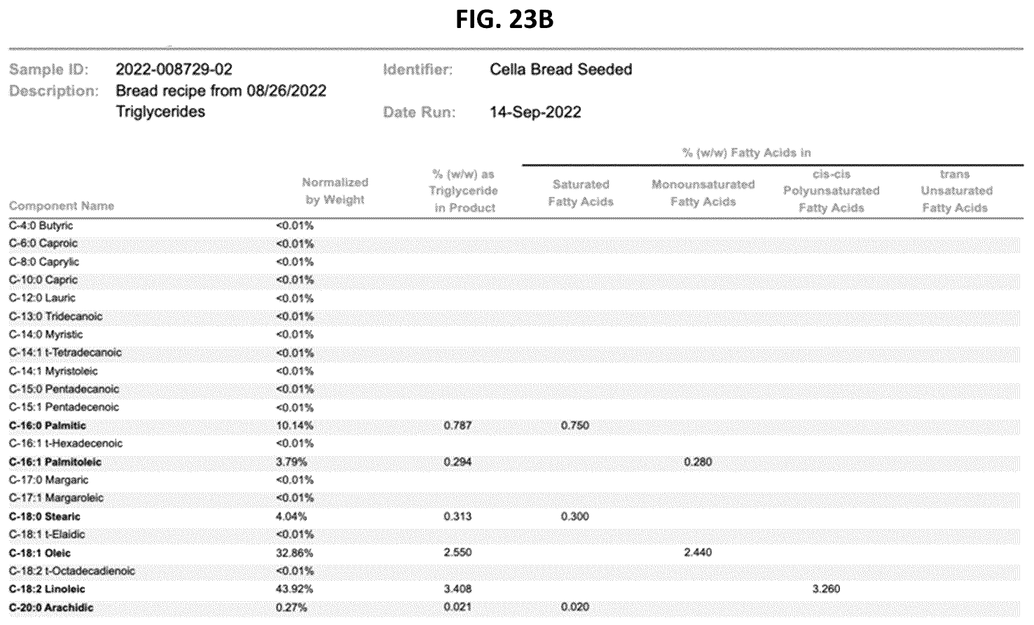

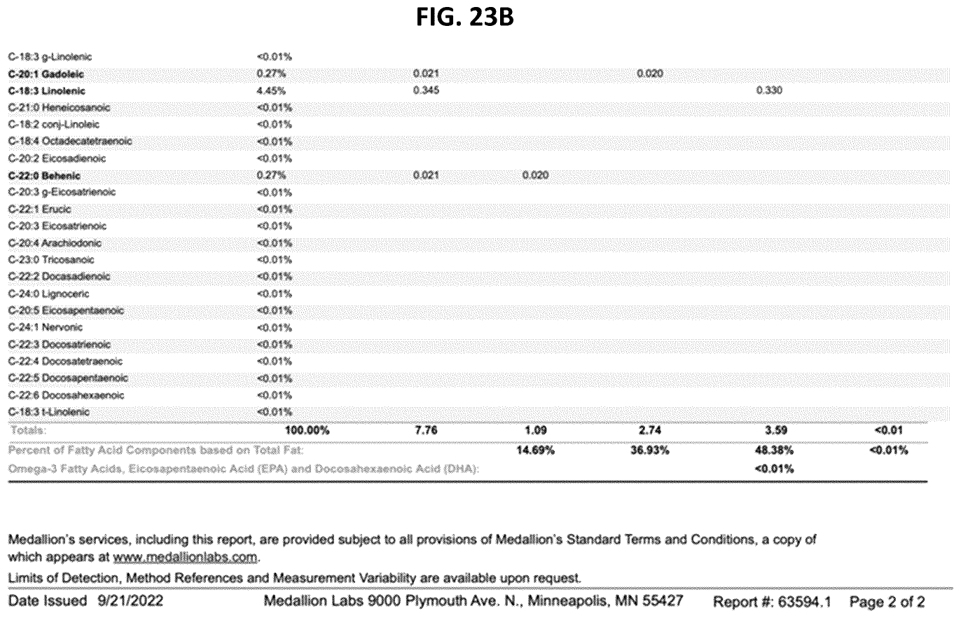

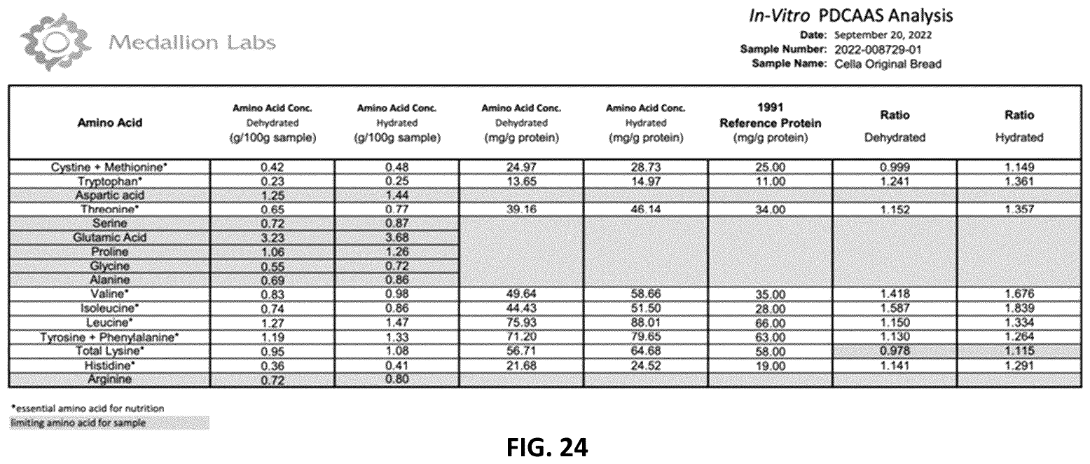

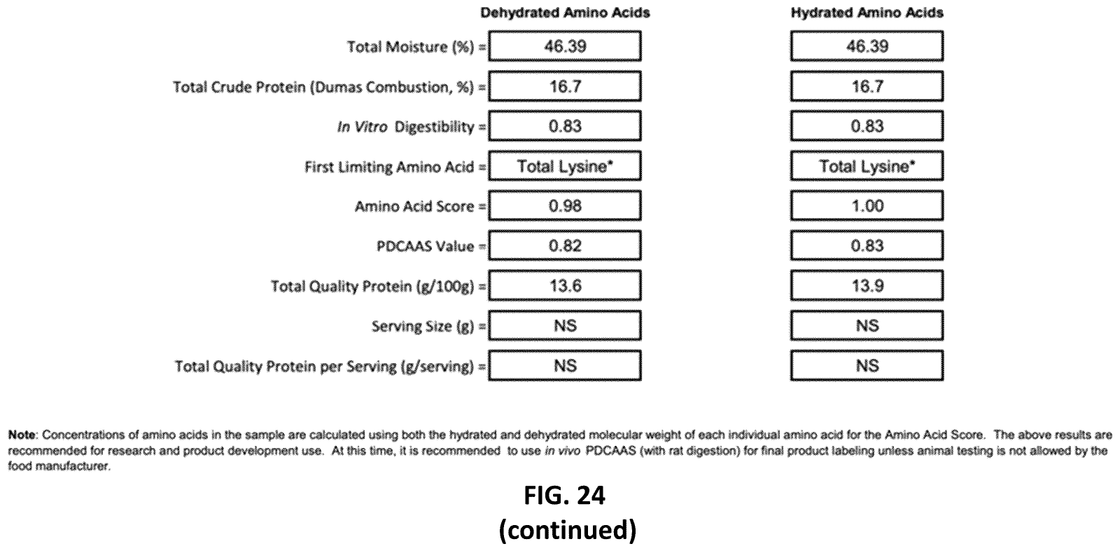

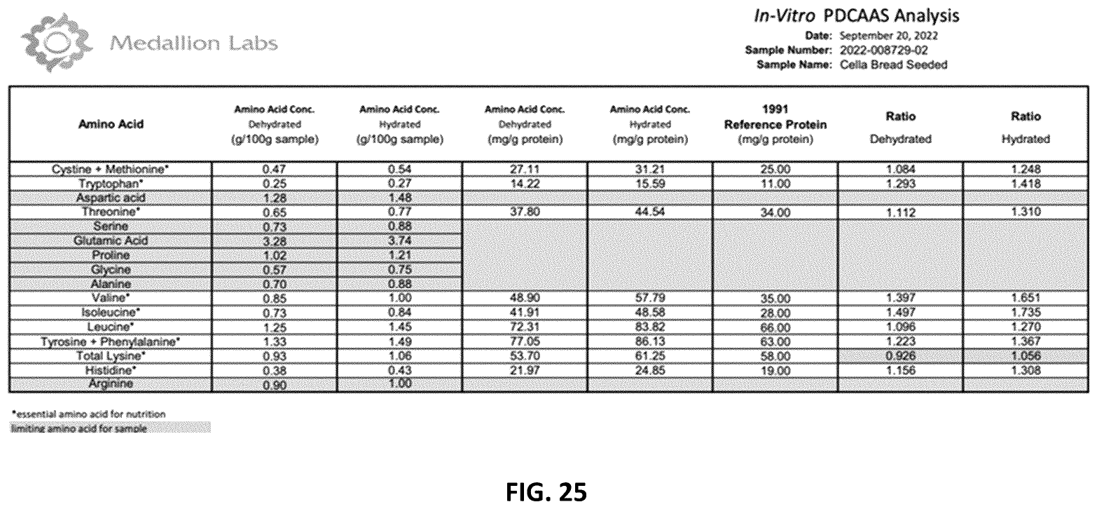

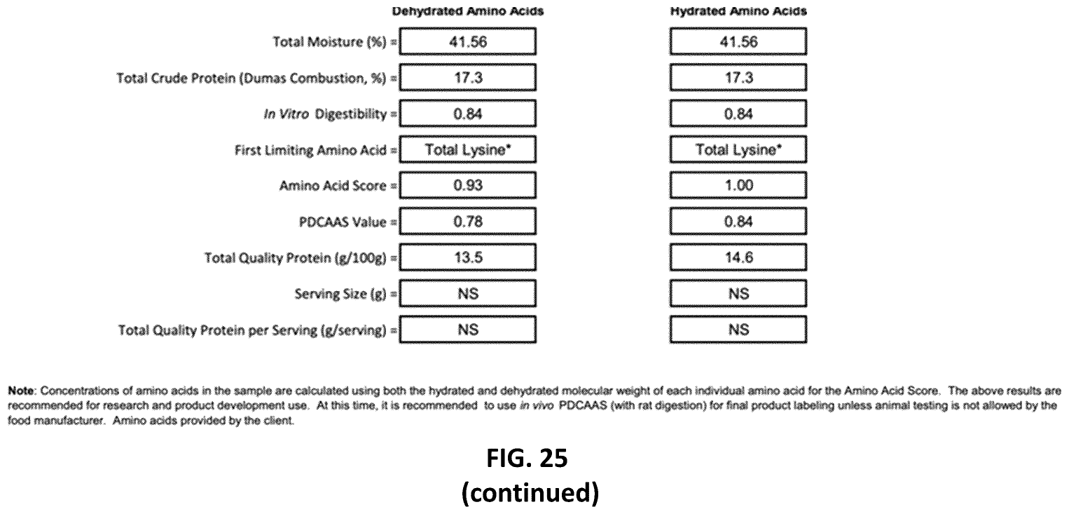

The bread produced in this Example was subjected to a variety of in vitro analyses. The nutritional label for the bread generated using the high protein powder from Example 1 is summarized in FIG. 21. Overall, an excellent nutritional profile was provided including superior amino acid profile (see FIGS. 22A-22C). A full report including Fatty Acid analysis is presented in FIGS. 23A-23B. The PDCAAS is summarized in FIGS. 24 and 25. The PDCAAS analysis shows Lysine as the first limiting amino acid score, with an amino acid score near 1, and a digestibility of ˜84%, leading to an excellent PDCAAS score of 0.84

By way of comparison, leading bread brands contain ˜3 g of protein, with ˜21 g of carbohydrate. The bread obtained using the composition (i.e., protein powder) as shown in the current example of the present disclosure instead contains 9 g or higher quantity of protein with ˜18 g of carbohydrate per serving (FIG. 21). This provides a much higher ratio of protein to carbohydrates than what is reported in the leading brands of commercially sold bread as shown in FIGS. 2-4.

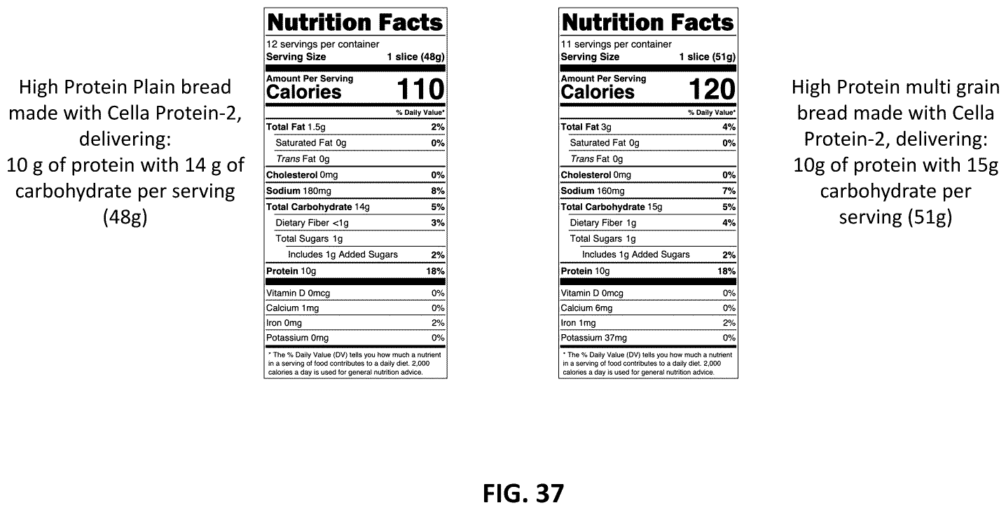

In another high protein bread example where Cella protein-2 was adjusted higher in a formula resulted in 10 g of protein with 15 g of carbohydrates in a serving (FIG. 37, plain bread (left) and multi-grain bread (right)).

The amino acid profiles of Cella protein powder and bread made with Cella protein powder as also determined.

TABLE 5
Amino acid content of Cella protein powder and bread made with Cella protein powder.

| | | | Bread with Cella | | | |
|---|---|---|---|---|---|---|
| | Cella protein powder | | protein powder | | Wheat* | |
| | % amount | % relative | % amount | % relative | % amount in | % relative |
| | in sample | abundance | in sample | abundance | sample | abundance |
| Ile | 5.01 | 6.27 | 0.86 | 4.93 | 0.443 | 2.77 |
| Leu | 7.92 | 9.92 | 1.47 | 8.43 | 0.898 | 5.62 |
| Val | 5.74 | | 1 | 5.6 | 0.564 | 3.53 |
| BCAA % | | 23.98 | | 18.96 | | 11.92 |
| His | 2.18 | 2.73 | 0.4 | 2.4 | 0.357 | 2.23 |
| Ile | 5.01 | 6.27 | 0.86 | 4.93 | 0.443 | 2.77 |
| Leu | 7.92 | 9.92 | 1.47 | 8.43 | 0.898 | 5.62 |
| Lys | 8 | 10 | 1.08 | 6.2 | 0.359 | 2.25 |
| Met | 0.57 | 0.72 | 0.29 | 1.65 | 0.228 | 1.43 |
| Phe | 1.64 | 2.06 | 0.94 | 5.37 | 0.682 | 4.27 |
| Thr | 4.5 | 5.64 | 0.77 | 4.42 | 0.367 | 2.3 |
| Val | 5.74 | 7.19 | 0.98 | 5.62 | 0.564 | 3.53 |
| Trp | 1.35 | 1.69 | 0.25 | 1.43 | 0.174 | 1.09 |
| EAA % | | 46.22 | | 40.45 | | 25.49 |
| Ala | 5.24 | 6.56 | 0.86 | 4.93 | 0.489 | 3.06 |
| Arg | 5.29 | 6.62 | 0.8 | 4.59 | 0.648 | 4.05 |
| Asp | 9.32 | 11.7 | 1.44 | 8.26 | 0.722 | 4.52 |
| Glu | 9.32 | 12.5 | 3.68 | 21.1 | 4.33 | 27.1 |
| Gly | 3.79 | 4.75 | 0.72 | 4.13 | 0.569 | 3.56 |
| Pro | 3.36 | 4.21 | 1.26 | 7.23 | 2.08 | 13 |
| Ser | 4.44 | 5.56 | 0.87 | 4.99 | 0.62 | 3.88 |
| Tyr | 1.08 | 1.36 | 0.55 | 3.13 | 0.275 | 1.72 |
| Cys | 0.41 | 0.51 | 0.21 | 1.2 | 0.275 | 1.72 |

*Wheat data source: fdc.nal.usda.gov/fdc-app.html#/food-details/168893/nutrients

### Conclusions

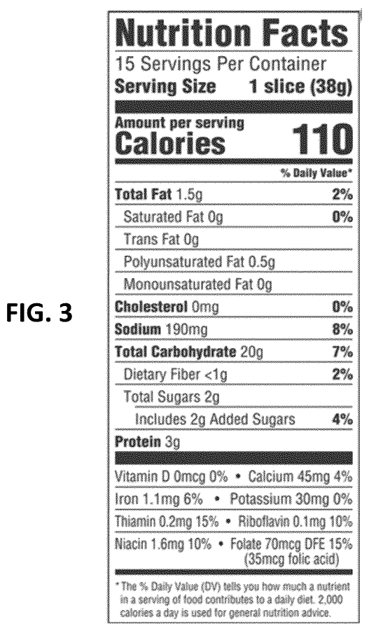

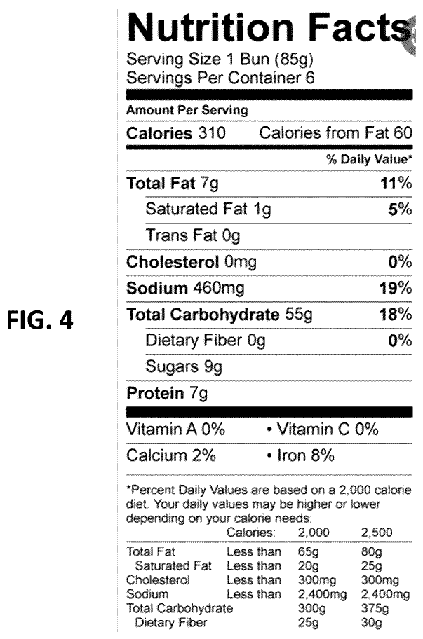

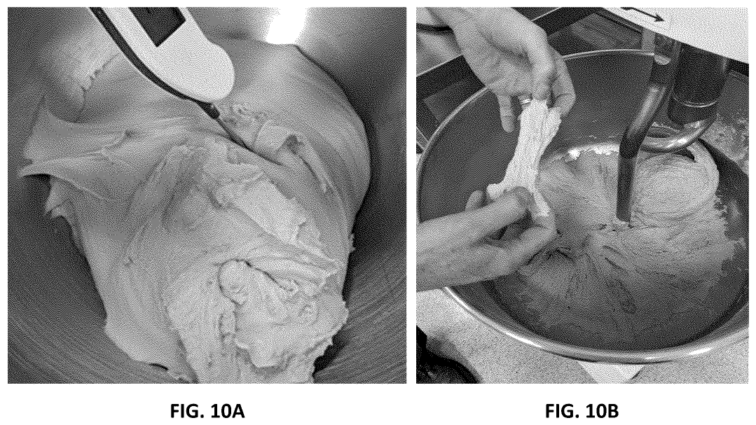

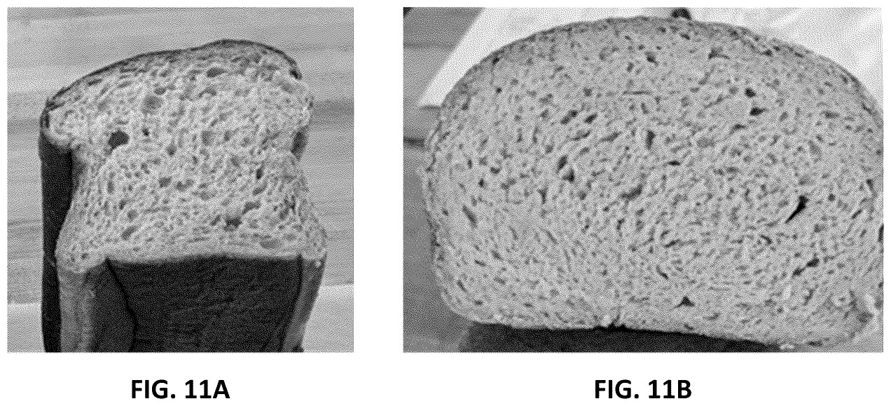

As shown in FIG. 1, a dough and bread were produced using a protein powder comprising a protein formulated using the hydration methods disclosed herein (see FIGS. 10A-B). This dough and bread showed superior properties to previous formulations (see Bread Test results) and excellent crumb structure (see FIGS. 11A-B). The dough and subsequent bread produced using the protein powders provided herein showed a high level of protein (see FIG. 21). In contrast, existing products on the market do not have the same level of protein as shown in FIG. 2 (Dave's Killer Bread), FIG. 3 (Sara Lee Artesano bread), and FIG. 4 (Baker's Field bread).

### Example 3—Pasta & Pasta Dough Comprising Protein Powder Provided Herein

A high protein pasta and pasta dough were developed using the optimized protein powder discussed in the above Examples in order to test the resultant organoleptic properties.

### Method of Making Pasta:

Control noodles were prepared from a blend of 70% hard red spring wheat and 30% hard red winter wheat. Dough was transferred to a vacuum mixer and mixed for a minute before extruding through a single screw extruder with an internal temperature maintained at 104° F., 28 in Hg pressure and 10 rpm.

Semolina and high protein powder (Cella protein 1, 2, 3 or 4) were mixed with the other dry ingredients as shown in Tables 6A-6H in a Hobart mixer for 1 minute at speed 1. Water was added at a temperature of 120° F. and the mixer speed was increased to 2 for 2 minutes. The mixture was then transferred to a vacuum mixer and mixed for an additional minute before being extruded through a single screw extruder with an internal temperature maintained at 104° F., 28 inches Hg pressure and 10 rpm. The extruded pasta was then dried until it contained 11% moisture.

Tables 6A-6D. Pasta trial recipes.

TABLE 6A
Control and pastas made with Cella protein 1 having a WHC of 94 grams of
water/100 g of Cella protein 1 (Cella Protein Control from Table 3).

| | Control | | | | | | |
|---|---|---|---|---|---|---|---|
| | (1) | 2 | 3 | 4 | 5 | 6 | 7 |
| Semolina | 100.0% | 81.8% | 69.3% | 60.2% | 42.9% | 60.1% | 60.8% |
| Cella Protein 1 | | 16.4% | 27.7% | 36.1% | 51.5% | 36.1% | 36.5% |
| Wheat Protein | | 1.6% | 2.8% | 3.6% | 5.2% | 3.6% | 2.4% |
| Xanthan Gum | | 0.2% | 0.2% | 0.2% | 0.4% | 0.2% | 0.3% |
| Total | 100.0% | 100.0% | 100.0% | 100.0% | 100.0% | 100.0% | 100.0% |

TABLE 6B
Pastas made with Cella protein 2 having a WHC of 82 grams of water/100
g of Cella protein 2 (Cella Protein 2 from Table 3).

| | 8 | 9 | 10 | 11 | 12 |
|---|---|---|---|---|---|
| Semolina | 81.80% | 81.60% | 81.65% | 81.59% | 73.14% |
| Cella Protein 2 | 16.35% | 16.35% | 16.29% | 16.33% | 25.00% |
| Wheat Protein | 1.63% | 1.63% | 1.63% | 1.62% | 1.45% |
| Xanthan Gum | 0.19% | 0.39% | 0.20% | 0.20% | 0.18% |
| Guar Gum | | | 0.20% | 0.21% | 0.18% |
| Enzyme | | | | 0.02% | 0.02% |
| (Noopazyme ®) | | | | | |
| Enzyme | 0.03% | 0.03% | 0.03% | 0.03% | 0.03% |
| (Veron NDL) | | | | | |
| Total | 100.0% | 100.0% | 100.0% | 100.0% | 100.0% |

TABLE 6C
Pastas made with Cella protein 2 or 3 having a WHC of 110 grams of water/100 g
of Cella protein 3 (Cella Protein 3 from Table 3).

| | 13 | 14 | 15 | 16 | 17 | 18 | 19 | 20 |
|---|---|---|---|---|---|---|---|---|
| Semolina | 76.39% | 59.96% | 77.95% | 61.18% | 85.03% | 77.31% | 75.65% | 68.80% |
| Cella Protein 2 | | | | | 11.37% | 19.23% | 19.16% | 27.81% |
| Cella Protein 3 | 18.95% | 34.96% | 19.34% | 35.67% | | | | |
| Wheat Protein | 2.66% | 3.08% | 2.71% | 3.15% | 1.60% | 1.45% | 1.45% | 1.37% |
| Xanthan Gum | 0.57% | 0.57% | 0.00% | | 0.57% | 0.57% | 0.57% | 0.58% |
| Guar Gum | 0.57% | 0.57% | | | 0.57% | 0.57% | 0.57% | 0.58% |
| Enzyme | 0.86% | 0.86% | | | 0.86% | 0.87% | 0.87% | 0.86% |
| (Noopazyme ® | | | | | | | | |
| Enzyme | | | | | | | 1.73% | |
| (Veron NDL) | | | | | | | | |
| Total | 100.00% | 100.00% | 100.00% | 100.00% | 100.00% | 100.00% | 100.00% | 100.00% |

TABLE 6D
Pastas made with Cella protein 2 or 4 having a WHC of 115 grams of water/100 g
of Cella protein 4 (Cella Protein 4 from Table 3).

| | 21 | 22 | 23 | 24 | 25 | 26 | 27 |
|---|---|---|---|---|---|---|---|
| Semolina | 66.80% | 67.51% | 66.34% | 67.35% | 59.58% | 67.51% | 59.58% |
| Cella Protein 2 | 17.75% | 17.94% | | | | 17.94% | |
| Cella Protein 4 | | | 25.00% | 25.00% | 31.00% | | 31.00% |
| Wheat Protein | 4.98% | 4.87% | 4.80% | 4.65% | 5.56% | 4.87% | 5.56% |
| Fiber | 9.61% | 9.68% | 3.00% | 3.00% | 3.00% | 9.68% | 3.00% |
| Enzyme | 0.86% | | 0.86% | | 0.86% | | 0.86% |
| (Noopazyme ®) | | | | | | | |
| Total | 100.0% | 100.0% | 100.0% | 100.0% | 100.0% | 100.0% | 100.0% |

### Results of Pasta Trials

Pastas 2-27 listed in Tables 6A-6D were tested to compare their properties to the control pasta. The data is shown in Tables 6E-6H.

Notably, the protein content of all of the trial pastas was much higher than the protein content of the control pasta (11%), ranging from 19.8% to 50.30. The PDCAAS value of the control pasta was very low (0.3); in contrast, the PDCAAS values of the trial pastas ranged from 0.74 to 1, indicating that the Cella proteins raised the PDCAAS values significantly. The proper levels of firmness and shear properties are vital to the eating properties of pasta; excellent levels of these properties were found in some of the pastas listed in Table 6D. Pasta firmness values greater than 600 g with PDCAAS values of 0.83-0.97 were obtained when formulating with Cella proteins. These are listed in Table 6H.

Many consumers have a goal to reduce the amount of carbohydrates they consume. The trial pastas achieved carbohydrate reduction relative to the control ranging from 11.9% to 50.7%. The data is shown in Tables 6E-6H. A further benefit was the lower loss of weight on cooking (cook loss) of several trial pastas, notably formulations 21-27. The cook loss of trial pasta 22 was 40% lower than the cook loss of the control pasta.

TABLE 6E
Properties of trial pastas made with the formulations listed in Table 6A.

| | Control | | | | | | |
|---|---|---|---|---|---|---|---|
| | (1) | 2 | 3 | 4 | 5 | 6 | 7 |
| Firmness (g) | 665.8 | 511.8 | 531.8 | 562.9 | 575.7 | 564.4 | 589.4 |
| Shear (g/cm) | 72.3 | 51.9 | 52.7 | 58.8 | 60.4 | 60 | 64.4 |
| Cook Loss (%) | 7.8 | 9.7 | 8.1 | 7.7 | 7.6 | 8 | 7.2 |
| Protein content | 11.00 | 23.50 | 32.00 | 38.50 | 50.30 | 38.50 | 38.00 |
| (g/100 g) | | | | | | | |
| PDCAAS | 0.3 | 0.84 | 0.98 | 0.99 | 1 | 0.99 | 1 |
| Carbohydrate | 72 | 60 | 52.5 | 46.6 | 35.5 | 46.5 | 47 |
| (g/100 g) | | | | | | | |
| Reduction of | | 16.7% | 27.1% | 35.3% | 50.7% | 35.4% | 34.7% |
| carbohydrates | | | | | | | |
| relative to control | | | | | | | |

TABLE 6F
Properties of trial pastas made with
the formulations listed in Table 6B.

| | 8 | 9 | 10 | 11 | 12 |
|---|---|---|---|---|---|
| Firmness (g) | 583.8 | 621.5 | 608.5 | 576.2 | 648 |
| Shear (g/cm) | 59.9 | 64.5 | 62.3 | 60 | 64.3 |
| Cook Loss (%) | 25.8 | 26 | 25.6 | 26.2 | 25.2 |
| Protein content | 23.30 | 23.30 | 23.40 | 23.40 | 29.30 |
| (g/100 g) | | | | | |
| PDCAAS | 0.85 | 0.85 | 0.84 | 0.84 | 0.97 |
| Carbohydrate | 60 | 60 | 60.2 | 60.2 | 55 |
| (g/100 g) | | | | | |
| Reduction of | 16.7% | 16.7% | 16.4% | 16.4% | 23.6% |
| carbohydrates | | | | | |
| relative to control | | | | | |

TABLE 6G
Properties of trial pastas made with formulations listed in Table 6C.

| | 13 | 14 | 15 | 16 | 17 | 18 | 19 | 20 |
|---|---|---|---|---|---|---|---|---|
| Firmness (g) | 353 | 309.4 | 303.6 | 301.2 | 432.5 | 443.5 | 400.6 | 426.1 |
| Shear (g/cm) | | | | | | | | |
| Cook Loss (%) | 5.9 | 6.5 | 6.5 | 6.5 | 6.5 | 6.2 | 7.4 | 7.2 |
| Protein content | 21.90 | 27.64 | 22.36 | 28.20 | 19.80 | 25.10 | 24.90 | 31.00 |
| (g/100 g) | | | | | | | | |
| PDCAAS | 0.91 | 0.92 | 0.91 | 0.92 | 0.74 | 0.9 | 0.9 | 0.99 |
| Carbohydrate | 62.00 | 57.50 | 63.40 | 58.70 | 62.30 | 57.40 | 56.2 | 52.00 |
| (g/100 g) | | | | | | | | |
| Reduction of | 13.9% | 20.1% | 11.9% | 18.5% | 13.5% | 20.3% | 21.9% | 27.8% |
| carbohydrates | | | | | | | | |
| relative to control | | | | | | | | |

TABLE 6H
Properties of trial pastas made with the formulations listed in Table 6D.

| | 21 | 22 | 23 | 24 | 25 | 26 | 27 |
|---|---|---|---|---|---|---|---|
| Firmness (g) | 645.38 | 757.25 | 517.29 | 505.84 | 553.28 | 750.12 | 506.87 |
| Shear (g/cm) | 163.14 | 173.55 | 107.78 | 100.18 | 92.42 | 165.24 | 101.18 |
| Cook Loss (%) | 4.44 | 4.04 | 4.52 | 4.52 | 5.24 | 4.14 | 5.32 |
| Protein content | 25.60 | 25.70 | 26.10 | 26.10 | 29.60 | 25.70 | 29.60 |
| (g/100 g) | | | | | | | |
| PDCAAS | 0.86 | 0.86 | 0.8 | 0.8 | 0.83 | 0.86 | 0.83 |
| Carbohydrate | 50.00 | 50.40 | 48.50 | 49.00 | 44.00 | 50.40 | 44.00 |
| (g/100 g) | | | | | | | |
| Reduction of | 30.6% | 30.0% | 32.6% | 31.9% | 38.9% | 30.0% | 38.9% |
| carbohydrates | | | | | | | |
| relative to control | | | | | | | |
| Firmness (g) | 645.38 | 757.25 | 517.29 | 505.84 | 553.28 | 750.12 | 506.87 |

### Method of Measure Texture and Sensory Properties of Pasta:

The texture profile analysis of pasta was performed using a TAXTPlus (Stable Micro Systems, Inc.) with a TA-47 blade rig attachment for measuring firmness and TA-96 double clamp rig attachment for measuring tensile strength of the spaghetti noodles according to Azhar et al. (2011). The fixture TA-47, used for measuring firmness was pasta firmness/stickiness rig was attached to a 25 kg load cell.

The noodles were cooked according to the method described by Sozer and Kaya (2003). In summary, the cooking process entailed adding predefined amount (25 g) of pasta/noodles to 500 ml of vigorously boiling water. The pasta/noodles was stirred once to prevent sticking, and the boiling was consistently maintained throughout the entire cooking period. Measurements of the cooking properties were taken at predefined intervals, starting at the 5th minute. After cooking, the pasta/noodles underwent drainage in a sieve and was/were rinsed with cold water. To eliminate excess moisture from the surface, the strands were gently patted between paper towels. Subsequently, the samples were promptly utilized for sensory, analytical and instrumental measurements. After cooking, the cooked noodles were cut into 50 mm length and five noodle strands were placed flat and straight adjacently to one another under the compression platen of the TA-47 rig in the center of a heavy-duty platform. The settings used after performing calibration were: Mode: Measure force in compression; Option: Return to start; Pre-test Speed: 1.0 mm/s, Test Speed: 0.1 mm/s; Post-test Speed: 10 mm/s, Distance: 4.98 mm; Data Acquisition Rate: 200 pps. From the TPA curve, hardness (maximum peak force during the first compression), chewiness (product of hardness, cohesiveness and springiness) were reported. Ten replicates were taken, and results reported as average for each noodle type.

For measurement of extensibility of noodles, the TAXTPlus fitted with a 5 kg load cell and TA-96 rig was used. Rig calibration was performed, and the following settings were used for measurement of extensibility of samples: Mode: Mode: Measure force in tension; Option: Return to start; Pre-test Speed: 3.0 mm/s, Test Speed: 3.0 mm/s; Post-test Speed: 5.0 mm/s, Distance: 100 mm; Trigger Force: 0.05 N; Data Acquisition Rate: 200 pps. The cooked noodles were cut into 200 mm long pieces. The tensile strength was calculated as: α=F/A

Where a is the tensile strength (Pa), F is the peak force (N) and A is the cross-sectional area of the noodle strand (m²). The elasticity was then calculated as: Elasticity=(Flₒ/tAₒ)×1/v

Where F/t is the initial slope (N/s) of the force-time curve, lₒ is the original length of the boodles between the limit arms (0.015 m), Aₒ is the original cross-sectional area of the noodle (m²) and v is the rate of movement of the upper arm (0.003 m/s) (Gan et al., 2009).

### Experiments to Optimize Pasta Rheology and Organoleptic Properties Using Microbial Protein

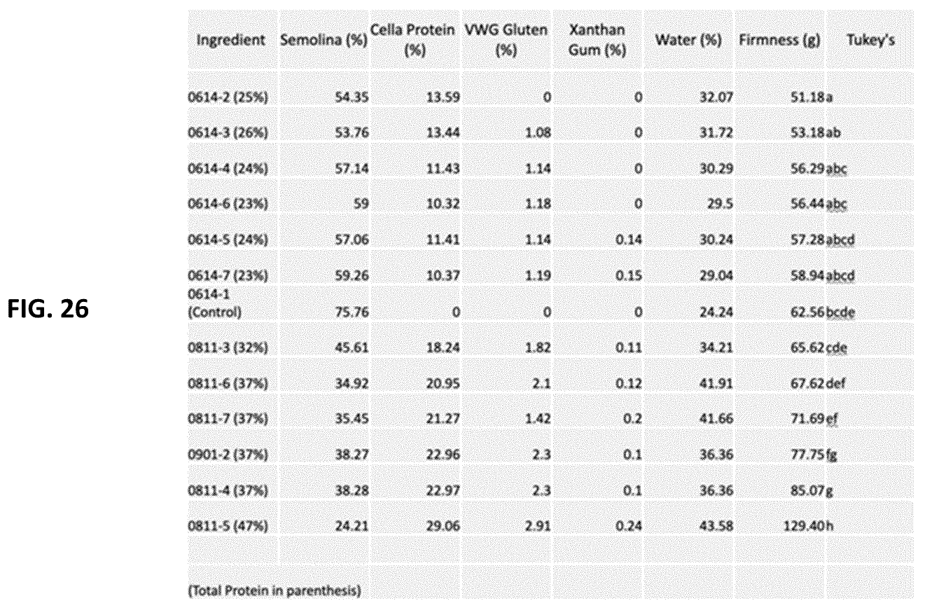

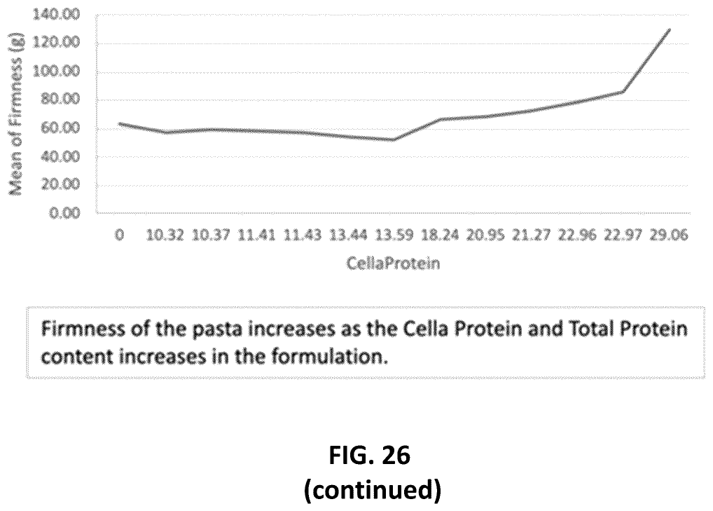

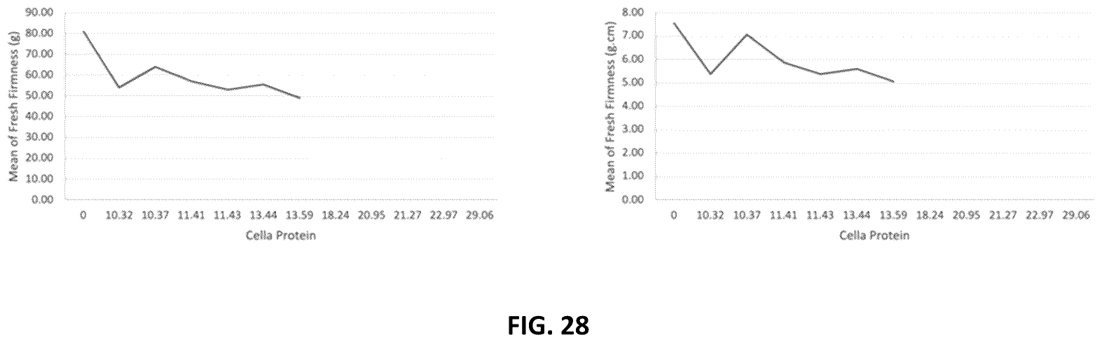

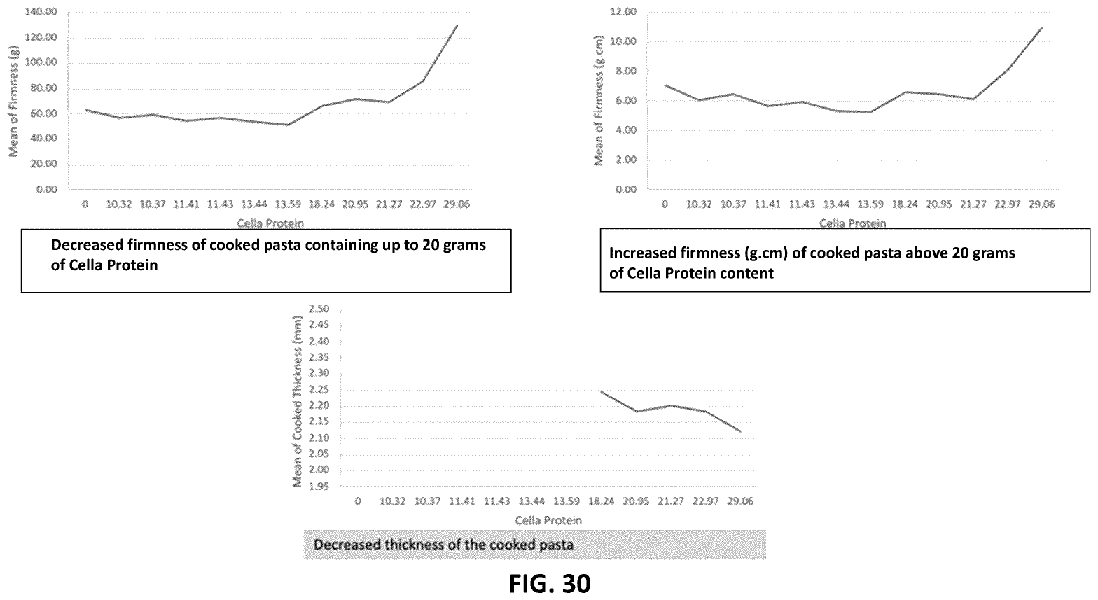

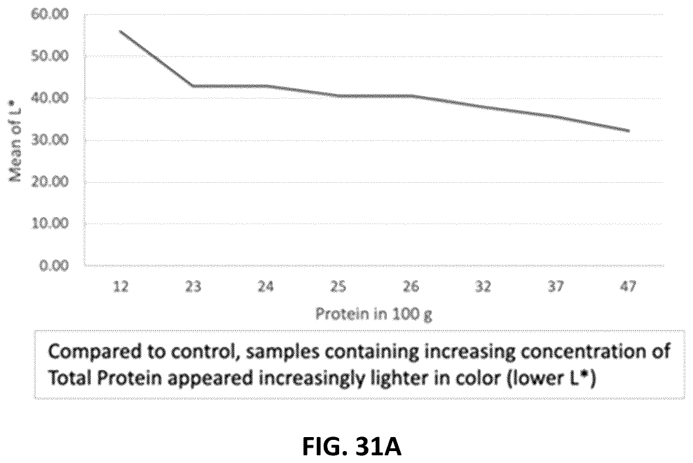

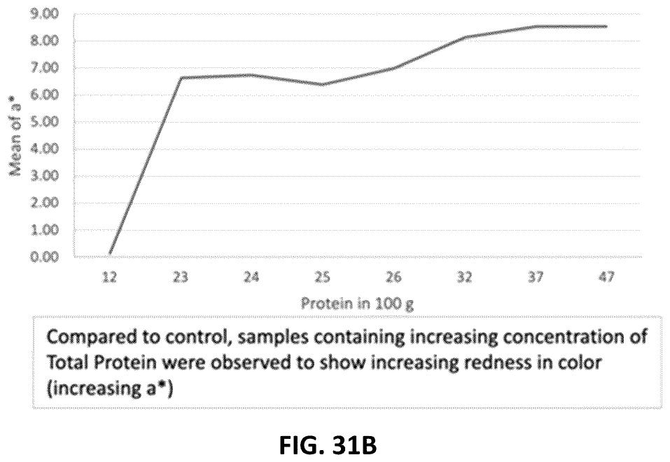

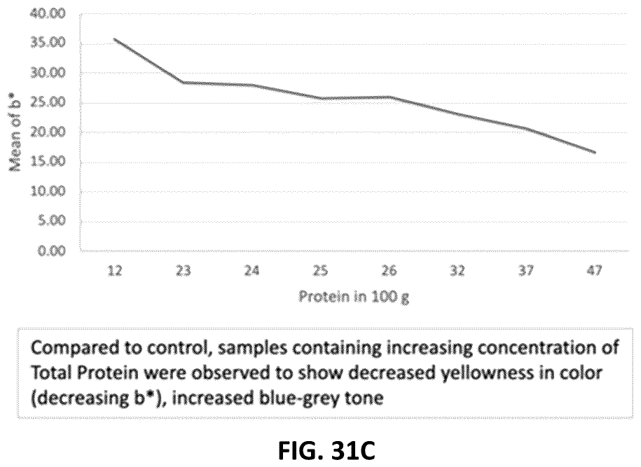

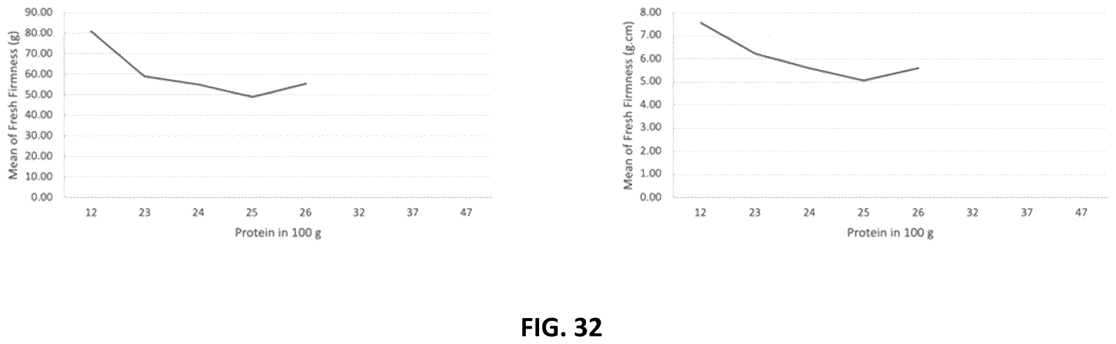

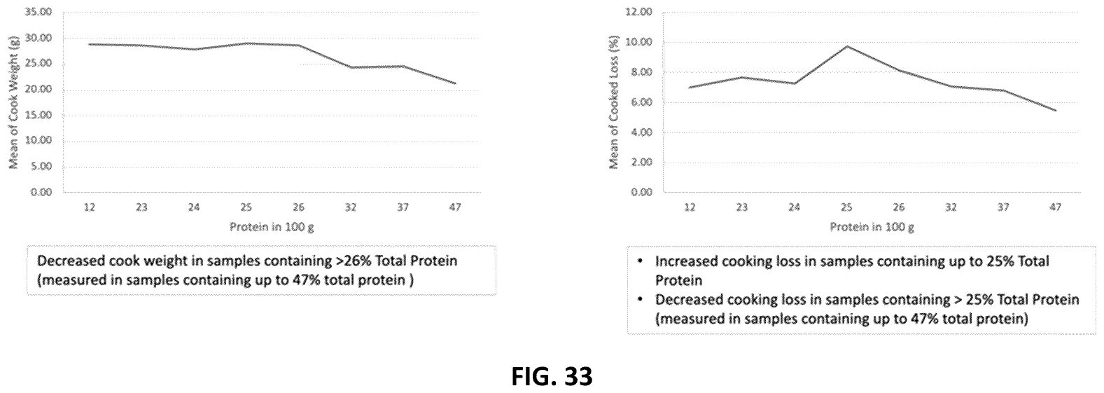

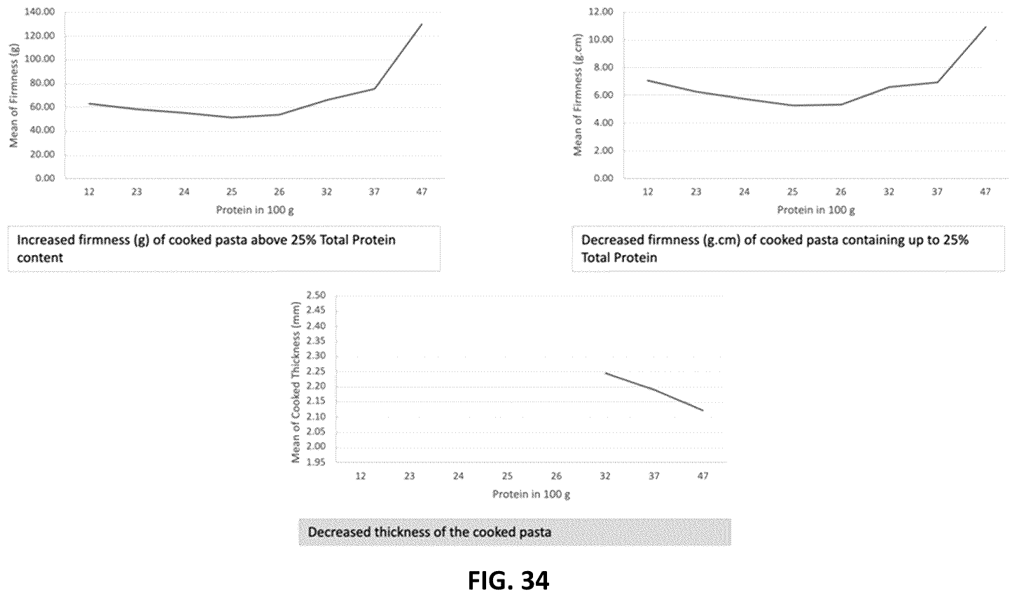

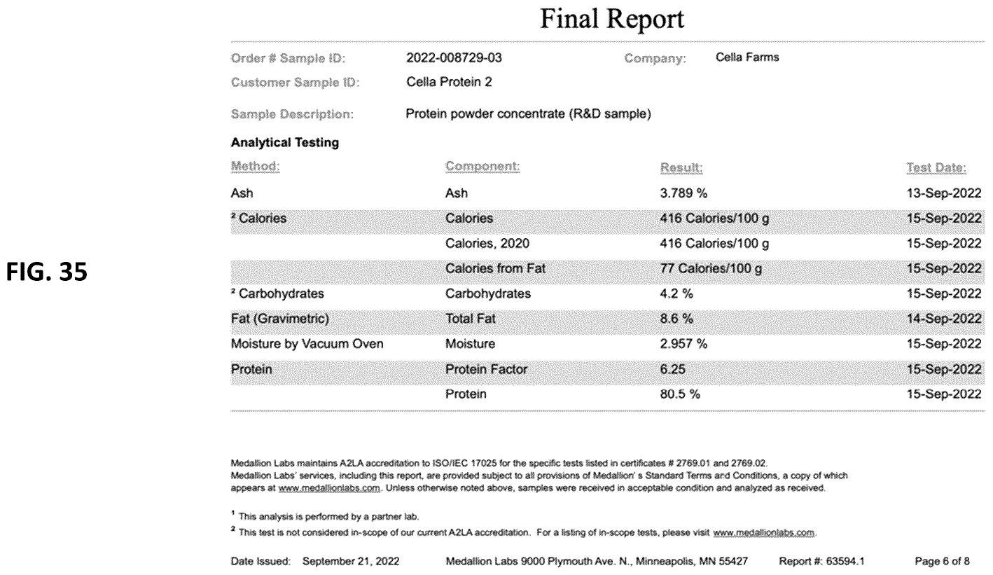

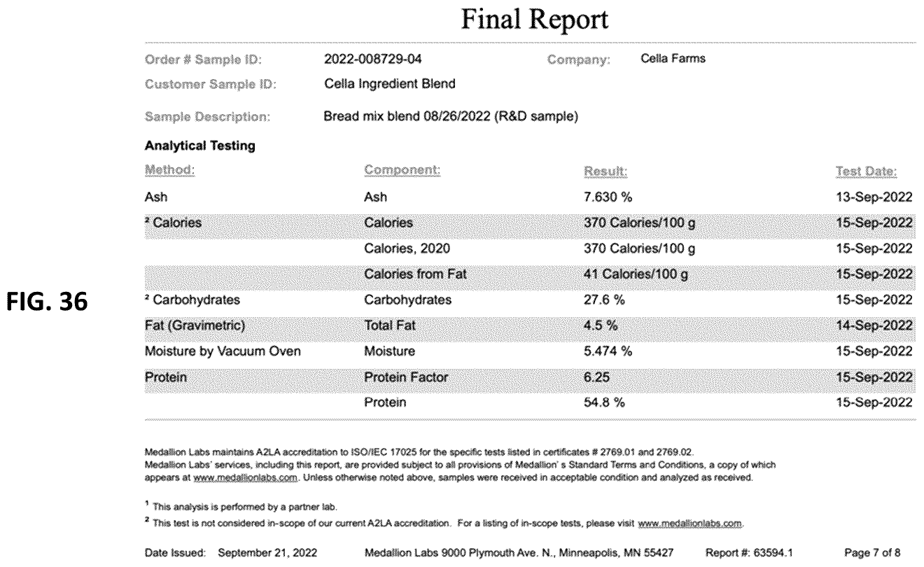

As discussed above, a variety of experiments were carried out to optimize multiple parameters for pasta development, using the protein composition/powder of the present disclosure. The results of these experiments are summarized in FIGS. 26-34. FIG. 26 captures the increased firmness of cooked pasta made by adding 100 g of dried pasta in 1 liter of boiling water for 7 minutes. By modulating ingredients that include flour, xanthan gum, and water, the protein level was steadily increased while maintaining, and even improving, firmness of the pasta. This allowed for formulation and selection of an optimal firmness (FIGS. 26 & 28). Firmness of cooked pasta (Trial 2) made with higher than 20 g Cella Protein in formulation showed higher firmness (FIG. 30). Firmness of cooked pasta is an important texture quality that results in a firmer bite of the pasta when masticated in mouth.

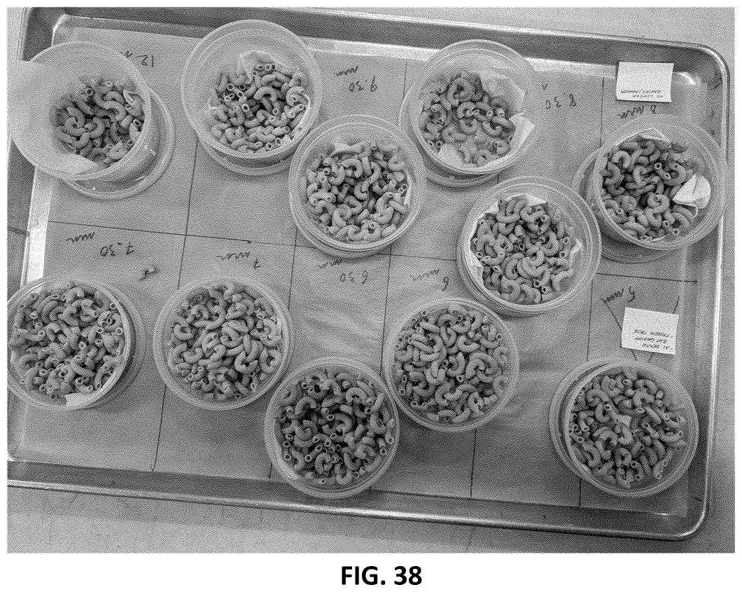

Additional experiments on pasta made with higher than 20 g Cella Protein (e.g., Cella Protein 2) showed that altering the cooking time did not appreciably alter the firmness of said pasta. In particular, pasta made with greater than 20 g Cella Proteins (e.g., Cella protein 2) and cooked at a boil for either 5 minutes, 6 minutes, 6 minutes and 30 seconds, 7 minutes, 7 minutes and 30 seconds, 8 minutes (al dente), 8 minutes and 30 seconds, 9 minutes, 9 minutes and 30 seconds or 12 minutes showed no change in firmness (see FIG. 38).

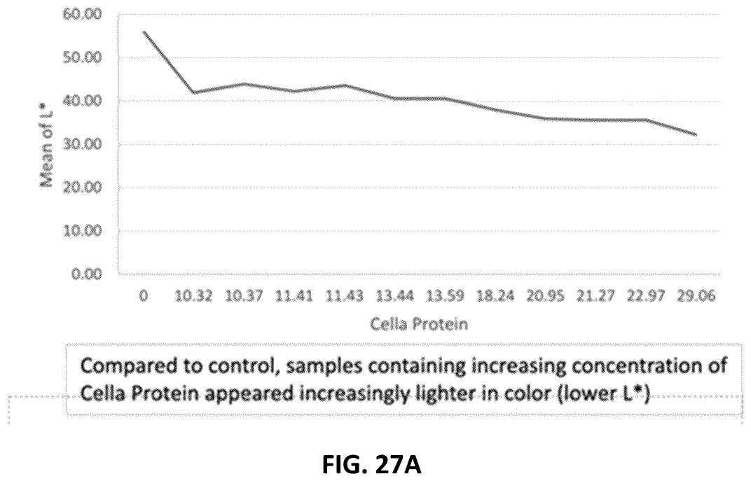

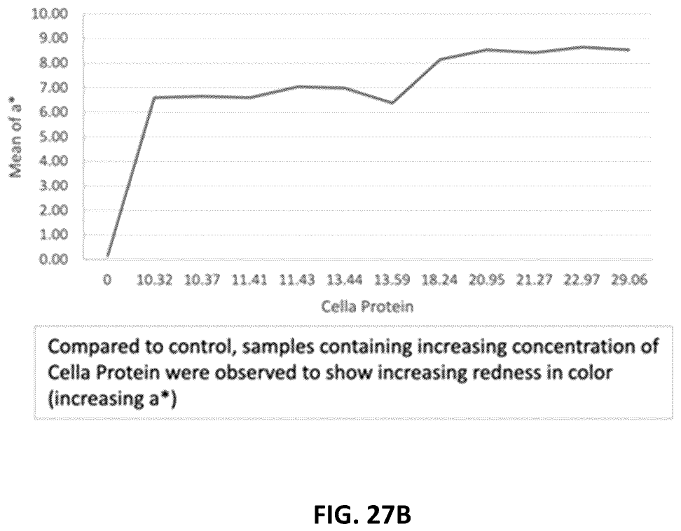

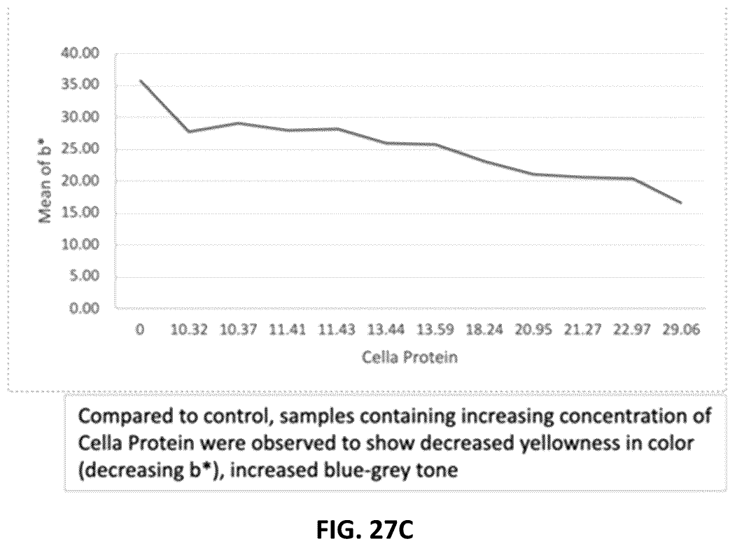

Next, experiments were carried out to analyze color formation in the presence of varying amounts of the aforementioned supplemental protein ingredient (FIGS. 27A-C). This was used to select parameters used for optimal color of the pasta, while providing high levels of protein.

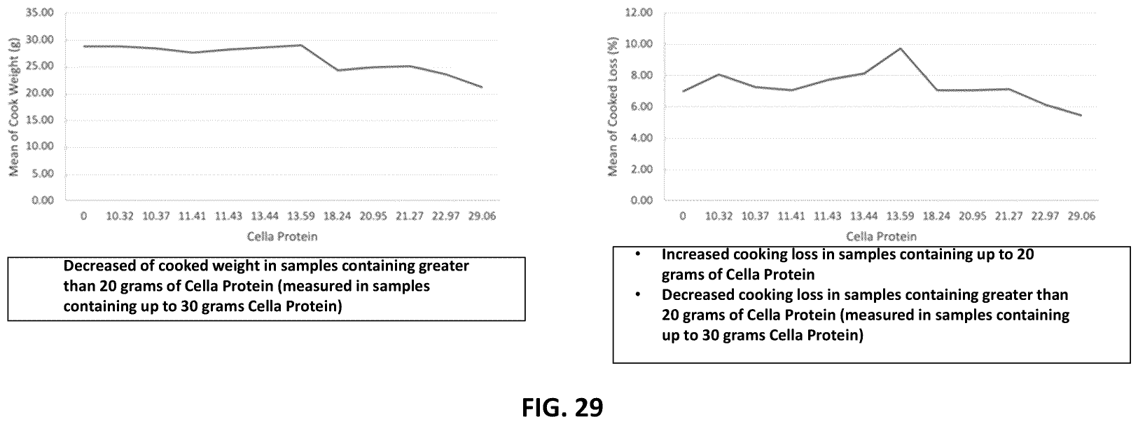

Additionally, cooking loss was assessed by using standard methods known in the art. The composition of the present disclosure also provided for decreased cooking loss (FIG. 29).

Taken together, these optimizations allowed for high levels of protein in pasta that would normally destroy cooking and organoleptic properties, thereby making pasta unpalatable to the consumer. As such, methods for making pasta with much higher levels of protein than previously disclosed have been provided, while maintaining excellent cooking results and organoleptic properties for consumer taste.

In particular, it was noted that pasta made according to formulation 26 in Table 6D was boiled for different times and the firmness was measured subjectively by chewing. Optimal al dente texture was reached after cooking pasta for 8 minutes. Surprisingly, the firmness and chewing properties of pasta cooked for longer time (12 minutes) were retained, demonstrating that the pasta could be cooked longer and retain optimal al dente texture.

### Example 4 Breading & Batter Comprising Protein Powder Provided Herein

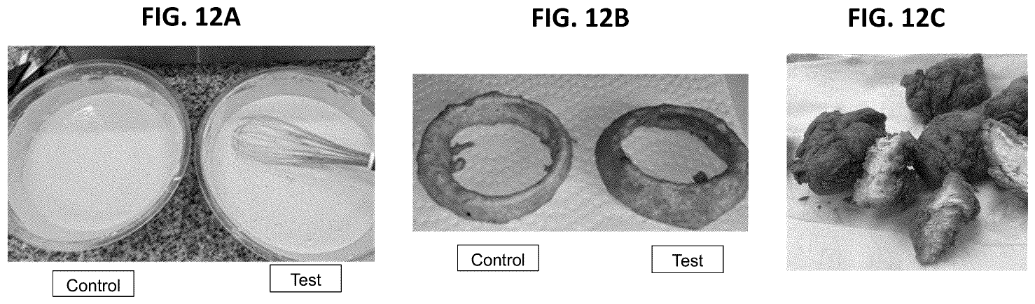

The high protein powders/components disclosed herein were used in breading or batters. The high protein batter formed by incorporating 1:4 parts by wt of Cella Protein-2 and high gluten wheat flour. This formed a high protein dry mix which was further mixed with water at 1:1.5 parts of the dry mix to water to form a semi-liquid, batter consistency. In an alternative embodiment, Cella protein based high protein bread slices as summarized in the examples above was also dried at 40 degree Celsius for 12 hours to a 5% moisture slice. The dried slice was then dry milled to form a powder which contained about 40-45% protein on as is basis. The dry powder was then mixed with water at 1:1.5 solids to water ratio (w/w basis) to form a semi-solid liquid batter. The solids and water were mixed at low speed to form a smooth, uniform flowable liquid batter without any dry lumps. The batter can be seasoned with 1% salt, or other species and condiments can be added to a taste as known in the prior art of batter and breading. The vegetable or meat pieces were then dipped into the liquid batter and then placed on a tray rack to drain any excess liquid. The vegetable or chicken pieces were then fried in heated oil at 350 degree Celsius for 7 mins, or until the nice crunchy, brown crust is formed on the fried products. FIG. 12 summarizes the final products breaded products made with improved texture and nutritional quality, adding extra protein, up to 3 g, per 20 g single portion pieces of chicken, fish, vegetables, onion rings, or any other such breaded processed foods. The dried pieces showed the adhesion properties as required in the finished product as enabled by the protein powders in different formulations of batters and breading. In addition, the final fried breaded products of this invention showed a golden-brown crust without the need to add pre-gelled starches or other stabilizers (egg white) or thickeners such as those described in U.S. Pat. Nos. 4,963,378A and 4,518,620A.

### Example 5 Tortillas Comprising Protein Powder Provided Herein

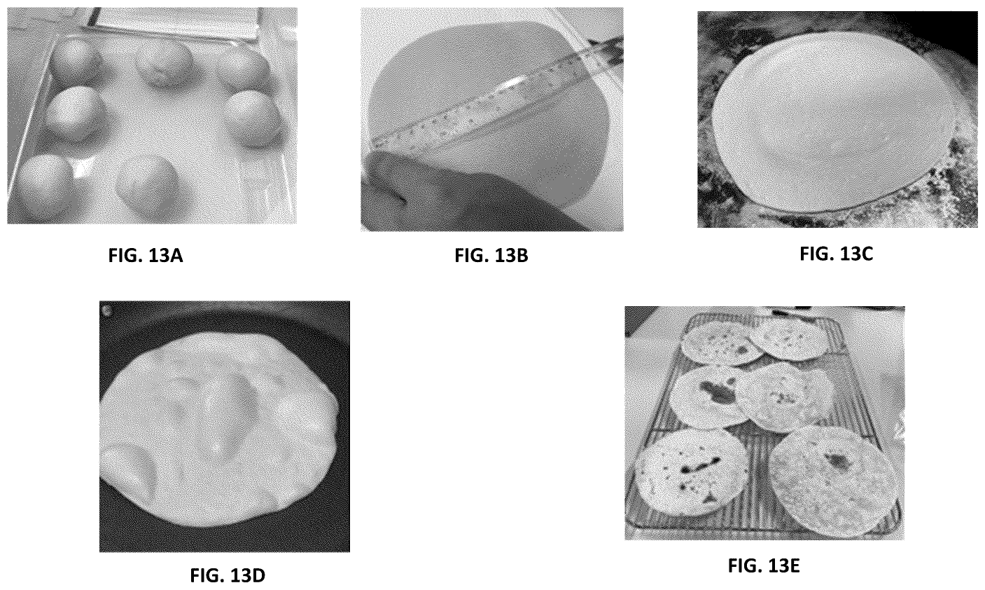

The high protein ingredients described in the above Examples were added to make Tortillas (see FIGS. 13A-13E). In particular, the tortillas provided are high in protein delivering a minimum of 5 g of protein in a 30 g serving of tortilla while maintaining excellent organoleptic properties of tortillas. Thus, the composition of the present disclosure can also be used to provide high protein tortillas with excellent taste, texture, and aroma properties.

### Method of Making Tortillas:

Dry ingredients, including tortilla flour and Cells Protein-2 in a ratio of 4:1, were mixed with wheat gluten (2%), salt (2%), baking powder (2%) and shortening (10%) as shown in Table 7 in a Hobart mixer at speed 1. Water was added and mixed in for another minute at the same speed before increasing the speed to level 2. The dough was covered and allowed to rest for 5 min. Subsequently, 40-45 g of dough was portioned and formed into round balls that were covered and allowed to rest for an additional 20 min. Oil was sprayed on both surfaces of a tortilla press, which was heated to 380° F. for the top plate and 365° F. for the bottom plate. One dough ball at a time was placed in the center of the tortilla press and the top plate was gently pressed for a brief period to generate an 8-inch tortilla with the desired thickness of 18-20 mm. The tortilla was removed from the press using a spatula and allowed to cool on a drying rack. The tortilla was cooked on a flat griddle at a low temperature setting, removed and allowed to cool on a drying rack before being packaged or consumed.

TABLE 7
Sample Formulation for a high protein tortilla

| Formula 5 | Grams |
|---|---|
| Tortilla Flour | 100 |
| Cella Protein-2 from | 25 |
| Example 1 | |
| Total Water | 117.5 |
| Vital Wheat Gluten | 2 |
| Salt | 1.5 |
| Baking Powder | 2 |
| Shortening | 10 |

### Method of Measuring Texture of Tortillas:

The texture profile analysis of tortillas was performed using a TAXTPlus (Stable Micro Systems, Inc.) equipped with TA-108 tortilla puncture rig attachment.

### Example 6—Gluten Free Cake Comprising Protein Powder Provided Herein

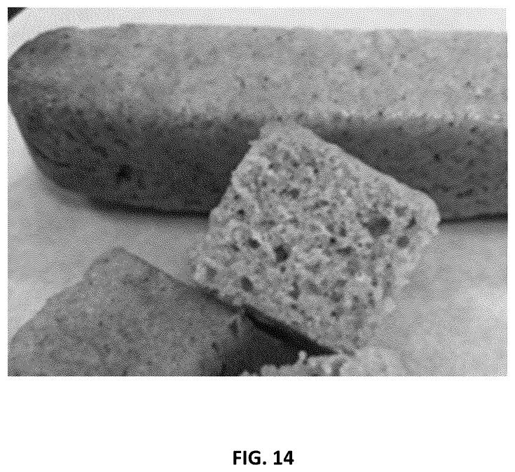

An example of a gluten free cake is provided (FIG. 14). The gluten free cake was made using standard methods known in the art. This cake was high in protein and free of gluten. Accordingly, the composition of the present disclosure can also find application in the development of high-protein, gluten-free cakes.

### Summary & Conclusions for Examples 2-6:

Using the methods taught herein, the protein ingredient compositions disclosed in the present invention find application in a variety of doughs & baked products and demonstrate excellent cooking properties and organoleptic properties including taste, texture, aroma, and crumb structure. Provided herein are ways to incorporate protein powder as provided herein with desired properties (i.e., WHC, SRC, and/or EAAs) in doughs, batters and dried cake and bread mixes with up to 5% to 50% protein while maintaining organoleptic properties nearly identical to traditional breads and other food products.

Managing the hydration of protein ingredient similar to original flour is a key aspect of the invention. A critical part of this is the production of a protein powder with a hydration capacity similar to original flour, where the finished dough or batter is not over hydrated (leading to sticky dough, hard to industrially process and bake) and under hydrated (leading to lack of gluten development and dense gritty baked product). Hydration can be measured by methods such as Solvent Retention Capacity (SRC). Thus, a key aspect of this invention is the use of a protein ingredient (depending on hydration) mixed in dough in proper ratios to deliver high protein dough, batter and dry mixes.

### REFERENCES

EP1643841B1—High-protein, low-carbohydrate bakery products.
U.S. Pat. No. 7,618,667B2—High protein, low-carbohydrate dough and bread products, and method for making same.
US20110256268A1—Oleaginous Yeast food compositions.
U.S. Pat. No. 4,963,378A—Method of cooking involving high protein frying batter that eliminates the need for breading and produces crispy and chewy crust.
U.S. Pat. No. 4,518,620A—Process for breading food.
Dietary protein quality in human nutrition, FAO, April 2011 www.sochob.cl/pdf/libros/Dietary %20protein %20quality %20evaluation %20 in %20human %20nu trition.pdf
Khan et al, Sustainable food industrial waste management through single cell protein production and characterization of protein enriched bread, Food Bioscience, April 2022.
Wojcik et al, Low-carbohydrate, high-protein, and gluten-free bread supplemented with poppy seed flour: physiochemical, sensory and spectroscopic properties, Molecules, February 2022.
Gupta et al, Rheology, fatty acid profile, and quality characteristics of nutrient enriched pizza base, Journal of Food Science and Technology, April 2014.
Sharif et al, Enrichment and fortification of traditional foods with plant protein isolates, Plant Protein Foods, March 2022.
Cuomo et al, Sustainable re-use of brewer's spent grains for the production of high protein and fiber pasta, Foods, February 2022.
Srilekha & Bharati, Formulation of protein rich mixes and evaluation of its sustainability for product development, The Pharma Innovation Journal, Vol 11, 2022.
Mohammed et al, Effects of chickpea flour on wheat pasting properties and bread making quality, J. Food Sci. & Technology, September 2014.
Traynham et al, Evaluation of water-holding capacity for wheat-soy flour blends, Journal of the American Oil Chemists Society, January 2007.
Corey, M. L., Gerdes, D. L., and Grodner, R. M. (1987) Influence of frozen storage and phosphate predips on coating adhesion in breaded fish portions. Journal of Food Science 52, 297-299.
Dogan, S. F., Sahin, S., and Sumnu, G. (2005) Effects of batters containing different protein types on the quality of deep [symbol] fat [symbol] fried chicken nuggets. European Food Research and Technology 220, 502-508.
Labropoulos, A. E., Varzakas, T., Anestis, S., Kostas, T., and Panagiotou, P. (2013) Preparation, storage and distribution of coated and uncoated chicken meat products. International Journal of Food Engineering 9, 209-215.
Maskat, M. Y. and Kerr, W. L. (2004) Effect of breading particle size on coating adhesion in breaded, fried chicken breasts. Journal of Food Quality 27, 103-113.
Mukprasirt, A., Herlad, T. J., Boyle, D. L., and Rausch, K. D. (2000) Adhesion of rice flour [symbol] based batter to chicken drumsticks evaluated by laser scanning confocal microscopy and texture analysis. Poultry Science 79, 1356-1363.
Rayner, M., Ciolfi, V., Maves, B., Stedman P., and Mittal, G. S. (2000) Development and application of soy [symbol] protein films to reduce fat intake in deep [symbol] fried foods. Journal of the Science of Food and Agriculture 80, 777-782.
Suderman, D. R. (1993) Selecting flavorings and seasonings for batter and breading systems. Cereal Foods World, 38, 689-694.
Influence of formulations on textural, mechanical and structural breakdown properties of cooked yellow alkaline noodles. Foo, W T; Yew, H S; Liong, M T; Azhar, M E. International Food Research Journal; Selangor Vol. 18, Iss. 4, (2011): 1295-1301.
Gan, C. Y., Ong, W. H., Wong, L. M. and Easa, A. M. 2009. Effects of ribose, microbial transglutaminase and soy protein isolate on physical properties and in vitro starch digestibility of yellow noodles. Lebensm.-Wiss. u.-Technol. 42: 174-179.
Sozer, N. and Kaya, A. 2003. Changes in cooking and textural properties of spaghetti cooked with different levels of salt in the cooking water. Journal of Texture Studies 34: 381-390.
AACC method 74-09 Measurement of Bread Firmness by Universal Testing Machine (1995).

It is understood that the disclosed invention is not limited to the particular methodology, protocols and materials described as these can vary. It is also understood that the terminology used herein is for the purposes of describing particular embodiments only and is not intended to limit the scope of the present invention which will be limited only by the appended claims.

While the invention has been described in connection with specific embodiments thereof, the foregoing description has been given for clearness of understanding only and no unnecessary limitations should be understood therefrom. It will be understood that the description is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims. Those skilled in the art will recognize or be able to ascertain using no more than routine experimentation, many equivalents to the specific embodiments of the invention described herein. Such equivalents are intended to be encompassed by the following claims.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not, be taken as an acknowledgement or any form of suggestion that they constitute valid prior art or form part of the common general knowledge in any country in the world.

### NUMBERED EMBODIMENTS

Notwithstanding the appended claims, the disclosure sets forth the following numbered embodiments:

Embodiment 1. A method for producing a protein powder using an aqueous extraction method comprising: (a) mixing protein obtained from a biomass in water at a defined ratio to generate a slurry comprising the protein of interest; and (b) subjecting the slurry to one or more of: (i) adding an acid or base to adjust the pH of the slurry to a desired pH; (ii) altering the temperature of the slurry to a desired temperature; (iii) adding a salt to the slurry to a desired % of salt in the slurry; (iv) milling the slurry in order to shear the protein of interest in the slurry; or (v) adding one or more hydrolases to the slurry in order to hydrolyze biological components of the slurry that include the protein of interest and carbohydrates, thereby generating a protein powder comprising a modified protein.

Embodiment 2. The method of embodiment 1, wherein the desired pH is from pH 3 to 10.5.

Embodiment 3. The method of embodiment 1 or 2, wherein the desired temperature is 70, 75, 80, 85, 90 or 95 degrees Celsius.

Embodiment 4. The method of any one of embodiment 1-3, wherein the slurry is incubated at the desired temperature for at least 30 minutes.

Embodiment 5. The method of any one of embodiments 1-4, wherein the desired % of salt is 5% w/w, wherein the salt is sodium chloride or sodium sulfate.

Embodiment 6. The method of any one of embodiments 1-5, wherein the one or more hydrolases is selected from the group consisting of amylase, protease, xylanase, cellulase and any combination thereof.

Embodiment 7. The method of any one of embodiments 1-6, wherein the slurry is incubated with the one or more hydrolases for at least 1 hour.

Embodiment 8. The method of any one of embodiments 1-7, further comprising testing the WHC of the modified protein and repeating steps (a) and (b) until a desired WHC of the modified protein is achieved.

Embodiment 9. The method of embodiment 8, wherein the desired WHC is from 80 g to 300 g of water per 100 g of the modified protein.

Embodiment 10. The method of any one of embodiments 1-9, further comprising: filtering the slurry to recover solids comprising the modified protein; and drying the modified protein following the filtering in order to produce the protein powder comprising the modified protein.

Embodiment 11. The method of any one of embodiments 1-10, wherein the defined ratio of protein to water is 1:1, or 1:2, 1:3, 1:4, 1:5, 1:6, 1:7, 1:8, 1:9, 1:10, 1:11, 1:12, 1:13, 1:14, 1:15 or 1:16, 1:17, 1:18, 1:19, or 1:20 w/w.

Embodiment 12. The method of embodiment 11, wherein the defined ratio of protein to water is 1:10 w/w.

Embodiment 13. The method of any one of embodiments 1-12, wherein the protein obtained from the biomass is a microbial protein obtained from a microbe in the biomass, wherein the biomass is a microbial biomass.

Embodiment 14. The method of embodiment 13, wherein the microbial protein is obtained from the microbial biomass following the fermentation of a plant biomass by the microbe in the microbial biomass.

Embodiment 15. The method of embodiment 13, wherein the microbe is selected from the group consisting of a fungus, a bacterium, an archaea, a protist and any combination thereof.

Embodiment 16. The method of embodiment 15, wherein the microbe is a fungus selected from the group consisting of a yeast or filamentous fungus.

Embodiment 17. The method of embodiment 16, wherein the yeast is a Pichia species or Saccharomyces species.

Embodiment 18. The method of embodiment 16, wherein the yeast is Saccharomyces cerevisiae.

Embodiment 19. The method of embodiment 16, wherein the filamentous fungus is a species of filamentous fungus selected from the group consisting of Aspergillus, Fusarium, Rhizopus or Mucor.

Embodiment 20. The method of embodiment 19 wherein the filamentous fungus is Aspergillus niger.

Embodiment 21. The method of embodiment 15, wherein the microbe is a species of bacterium selected from the group consisting of Lactobacillus, Bacillus, Bifidobacterium, Clostridium, Enterococcus, Corynebacterium and any combination thereof.

Embodiment 22. The method of embodiment 21, wherein the bacterium is Corynebacterium glutamicum.

Embodiment 23. The method of embodiment 21, wherein the bacterium is Clostridium acetobutylicum.

Embodiment 24. The method of any one of embodiments 14-23, wherein the plant biomass is selected from the group consisting of a food crop, an extract of a food crop, seaweed, plankton, phytoplankton, grass crops, agricultural crop waste and residues, spent grain from ethanol production, or spent grain from breweries, spent yeast or microbial biomass from fermented products manufacturing facilities, trees, woody energy crops and wood waste and residue.

Embodiment 25. The method of embodiment 24, wherein the food crop is selected from the group consisting of sugarcane, wheat, tubers, vegetables, lentils, kelp, legumes, soybeans, rice, potato, oats, pea, cassava and maize.

Embodiment 26. The method of embodiment 24, wherein the agricultural crop waste and residue is selected from the group consisting of corn stover, wheat straw, rice straw and sugar cane bagasse.

Embodiment 27. The method of embodiment 24, wherein the wood waste and residue is selected from the group consisting of softwood forest matter, barky wastes, sawdust, paper and pulp industry waste streams and wood fiber.

Embodiment 28. A powder comprising a protein with a desired property, wherein the desired property is a water holding capacity (WHC) selected from the group consisting of at least 80 grams (g) of water per 100 g of protein powder, at least 85 g of water per 100 g of the protein powder, at least 90 g of water per 100 g of the protein powder, at least 95 g of water per 100 g of the protein powder, at least 100 g of water per 100 g of the protein powder, at least 105 g of water per 100 g of the protein powder, at least 110 g of water per 100 g of the protein powder, at least 115 g of water per 100 g of the protein powder, at least 120 g of water per 100 g of the protein powder, at least 125 g of water per 100 g of the protein powder, at least 130 g of water per 100 g of the protein powder and from 80 to 150 grams (g) of water per 100 g of protein powder.

Embodiment 29. The powder of embodiment 28, wherein the powder comprises at least 70%, at least 75%, at least 80%, at least 85%, at least 90%, at least 95%, at least 99% of the protein with the desired property by weight (w/w).

Embodiment 30. The powder of embodiment 28 or 29, wherein the powder consists of 100% of the protein with the desired property by weight (w/w).

Embodiment 31. The powder of any one of embodiments 28-30, wherein the protein is selected from the group consisting of an animal protein, a plant protein, a microbial protein and any combination thereof.

Embodiment 32. The powder of embodiment 31, wherein the protein is an animal protein obtained or isolated from a mammal, an insect, a reptile, a bird and a fish.

Embodiment 33. The powder of embodiment 31 or 32, wherein the protein is an animal protein selected from the group consisting of a diary protein, gelatin, eggs and muscle.

Embodiment 34. The powder of embodiment 31, wherein the protein is a plant protein obtained or isolated from an angiosperm, gymnosperm or fern.

Embodiment 35. The powder of embodiment 31, wherein the protein is a microbial protein obtained or isolated from the fermentation of biomass by a microbe.

Embodiment 36. The powder of embodiment 35, wherein the microbe is selected from the group consisting of a fungus, a bacterium, an archaea, a protist and any combination thereof.

Embodiment 37. The powder of embodiment 35 or 36, wherein the microbe is a fungus selected from the group consisting of a yeast or filamentous fungus.

Embodiment 38. The powder of embodiment 37, wherein the yeast is a Pichia species or Saccharomyces species.

Embodiment 39. The powder of embodiment 37 or 38, wherein the yeast is Saccharomyces cerevisiae.

Embodiment 40. The powder of embodiment 36, wherein the microbe is a bacterium selected from the group consisting of a Lactobacillus bacterium, a Bacillus bacterium, a Bifidobacterium bacterium, a Clostridium bacterium, an Enterococcus bacterium, a Corynebacterium bacterium and any combination thereof.

Embodiment 41. The powder of embodiment 36 or 40, wherein the bacterium is Corynebacterium glutamicum, Clostridium acetobutylicum or a combination thereof.

Embodiment 42. The powder of embodiment 35, wherein the biomass is spent yeast or microbial biomass from fermented products manufacturing facilities.

Embodiment 43. The powder of embodiment 35, wherein the biomass is a plant biomass.

Embodiment 44. The powder of embodiment 43, wherein the plant biomass is selected from the group consisting of a food crop, an extract of a food crop, seaweed, plankton, phytoplankton, grass crops, agricultural crop waste and residues, spent grain from ethanol production, or spent grain from breweries, trees, woody energy crops and wood waste and residue.

Embodiment 45. The powder of embodiment 44, wherein the food crop is selected from the group consisting of sugarcane, wheat, tubers, vegetables, lentils, kelp, legumes, soybeans, rice, potato, oats, pea, cassava and maize.

Embodiment 46. The powder of embodiment 44, wherein the agricultural crop waste and residue is selected from the group consisting of corn stover, wheat straw, rice straw and sugar cane bagasse.

Embodiment 47. The powder of embodiment 44, wherein the wood waste and residue is selected from the group consisting of softwood forest matter, barky wastes, sawdust, paper and pulp industry waste streams and wood fiber.

Embodiment 48. The powder of any one of embodiments 28-47, wherein the powder comprises 5, 6, 7, 8, 9, 10, 11, 12, 13, 14, 15, 16, 17, 18, 19, 20, 21, 22, 23, 24, 25, 26, 27, 28, 29 or 30 grams (g) of the protein per serving.

Embodiment 49. The powder of embodiment 48, wherein the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g).

Embodiment 50. The powder of any one of embodiments 28-49, wherein the protein has a Solvent Retention Capacity (SRC) of at least 60%, at least 70%, at least 80%, at least 90% or at least 100%.

Embodiment 51. The powder of any one of embodiments 28-50, wherein the protein has a Protein Digestibility-Corrected Amino Acid Score (PDCAAS) of at least 0.6, at least 0.7, at least 0.8, at least 0.9 or at least 1.0.

Embodiment 52. The powder of any one of embodiments 28-51, wherein the protein comprises an amino acid distribution profile of between 15% to 50% or between 25% to 50% branched chain amino acids (BCAAs).

Embodiment 53. The powder of any one of embodiments 28-52, wherein the protein comprises an amino acid distribution profile of between 20% to 50% or between 25% to 50% essential amino acids (EAAs).

Embodiment 54. A composition comprising a flour and the powder of any one of embodiments 28-54.

Embodiment 55. The composition of embodiment 54, wherein the flour and the powder are present at a ratio of flour to powder of 1:0.05, 1:0.10, 1:0.15, 1:0.20, 1:0.25, 1:0.30, 1:0.35, 1:0.40, 1:0.45, 1:0.5, 1:0.6, 1:0.7, 1:0.8, 1:0.9, 1:1, 1.5:1, 2:1, 3:1, 4:1 or 5:1.

Embodiment 56. The composition of embodiment 55, wherein the flour and the powder are present at a ratio of flour to powder that produces a WHC that is from 100% to 150% of the WHC of the flour alone.

Embodiment 57. The composition of embodiment 56, wherein the composition comprises a water absorption that is 104-110% of control composition, wherein the control composition comprises the flour without the powder of embodiment 28.

Embodiment 58. The composition of embodiment 57, wherein the composition has a Solvent Retention Capacity (SRC) of at least 60%, at least 70%, at least 80%, at least 90% or at least 100%.

Embodiment 59. A method of producing a food product, the method comprising: (a) mixing a comestible, a liquid and a protein powder into a homogeneous composition, wherein the protein powder has a water holding capacity (WHC) that is at least 80%, at least 85%, at least 90%, at least 95%, at least 100%, at least 110%, at least 120%, at least 130%, at least 140% or at least 150% of the WHC of the comestible; (b) leavening the composition; and (c) heating the composition, thereby producing the food product, wherein the food product has organoleptic properties that are the same as a control, wherein the control is a leavened food product comprising the comestible and the liquid without the protein powder.

Embodiment 60. The method of embodiment 59, wherein the protein powder has a WHC that is selected from the group consisting of 100% of the WHC of the comestible, 150% of the WHC of the comestible and from 100% to 150% of the WHC of the comestible.

Embodiment 61. The method of embodiment 59 or 60, wherein the protein powder comprises protein selected from the group consisting of an animal protein, a plant protein, a microbial protein and any combination thereof.

Embodiment 62. The method of embodiment 61, wherein the protein is a microbial protein derived from the fermentation of biomass by a microbe.

Embodiment 63. The method of embodiment 62, wherein the microbe is selected from the group consisting of a fungus, a bacterium, an archaea, a protist and any combination thereof.

Embodiment 64. The method of embodiment 62 or 63, wherein the microbe is a fungus selected from the group consisting of a yeast or filamentous fungus.

Embodiment 65. The method of embodiment 64, wherein the yeast is a Pichia species or Saccharomyces species.

Embodiment 66. The method of embodiment 65, wherein the yeast is Saccharomyces cerevisiae.

Embodiment 67. The method of embodiment 64, wherein the filamentous fungus is a species of filamentous fungus selected from the group consisting of Aspergillus, Fusarium, Rhizopus or Mucor.

Embodiment 68. The method of embodiment 64 or 67, wherein the filamentous fungus is Aspergillus niger.

Embodiment 69. The method of embodiment 64, wherein the microbe is a species of bacterium selected from the group consisting of a Lactobacillus bacterium, a Bacillus bacterium, a Bifidobacterium bacterium, a Clostridium bacterium, an Enterococcus bacterium, a Corynebacterium, and any combination thereof.

Embodiment 70. The method of embodiment 69, wherein the bacterium is Corynebacterium glutamicum.

Embodiment 71. The method of embodiment 69, wherein the bacterium is Clostridium acetobutylicum.

Embodiment 72. The method of embodiment 64, wherein the biomass is a plant biomass obtained from grains, seeds, tubers, roots, stalks, shoots or other agricultural byproducts.

Embodiment 73. The method of any one of embodiments 59-72, wherein the food product comprises an amino acid distribution profile selected from the group consisting of between 15% to 50% branched chain amino acids (BCAAs), between 25% to 50% branched chain amino acids (BCAAs), between 20% to 50% essential amino acids (EAAs) and between 25% to 50% essential amino acids (EAAs).

Embodiment 74. The method of any one of embodiments 59-73, wherein the comestible and the protein powder are present at a ratio of comestible to protein powder of 1:0.05, 1:0.10, 1:0.15, 1:0.20, 1:0.25, 1:0.30, 1:0.35, 1:0.40, 1:0.45, 1:0.5, 1:0.6, 1:0.7, 1:0.8, 1:0.9, 1:1, 1.5:1, 2:1, 3:1, 4:1 or 5:1.

Embodiment 75. The method of any one of embodiments 59-74, wherein the food product has from 20% to 30% energy derived from protein per serving.

Embodiment 76. The method of any one of embodiments 59-75, wherein the food product comprises at least 5%, at least 10%, at least 15%, at least 20%, at least 25%, at least 30%, at least 35%, at least 40%, at least 45% or at least 50% more protein per serving than a control, wherein the control is a food product comprising the comestible and the liquid but lacking the protein powder.

Embodiment 77. The method of any one of embodiments 59-76, wherein the food product comprises from 5% to 50% more protein per serving than a control, wherein the control is a food product comprising the comestible and the liquid but lacking the protein powder.

Embodiment 78. The method of any one of embodiments 59-77, wherein the food product comprises at least 2 times, at least 3 times, at least 4 times, at least 5 time, at least 6 times, at least 7, at least 8 times, at least 9 times or at least 10 times more protein per serving than a control, wherein the control is a food product comprising the comestible and the liquid but lacking the protein powder.

Embodiment 79. The method of any one of embodiments 59-78, wherein the comestible is a dough or flour.

Embodiment 80. The method of embodiment 79, wherein the dough is a yeast leavened or a chemically leavened dough.

Embodiment 81. The method of any one of embodiments 59-78, wherein the food product is a breading mix, a soup, a shake, a batter or tortilla.

Embodiment 82. The method of embodiment 81, wherein the food product is bread, wherein the bread comprises at least 9 grams of protein per serving.

Embodiment 83. The method of embodiment 81, wherein the food product is bread, wherein the bread comprises at least 10 grams of protein per serving.

Embodiment 84. The method of embodiment 82 or 83, wherein the serving is 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g).

Embodiment 85. The method of embodiment 82 or 83, wherein the serving is 56 g.

Embodiment 86. The method of any one of embodiments 59-85, further comprising heating the food product following step (b), thereby producing a baked food product.

Embodiment 87. The method of embodiment 86, wherein the baked food product comprises the same texture or organoleptic properties as a control, wherein the control is a baked food product comprising the comestible and the liquid but lacking the protein powder.

Embodiment 88. The method of embodiment 87, wherein the organoleptic properties are selected from the group consisting of crust, crumb, oven spring, compression, moisture, shelf-life/staling, and rheology.

Embodiment 89. A bread comprising a protein obtained from a microbe, wherein the protein has a water holding capacity (WHC) of at least 80 g of water per 100 g of protein.

Embodiment 90. The bread of embodiment 89, wherein the protein has WHC of 82 g of water per 100 g of protein.

Embodiment 91. The bread of embodiment 89 or 90, wherein the WHC of the protein is modified prior to addition dough that produces the bread by altering the pH, temperature or salt concentration of a microbial biomass comprising the protein.

Embodiment 92. The bread of embodiment 91, wherein the protein is obtained from the microbe following fermentation of a plant biomass by the microbe.

Embodiment 93. The bread of any one of embodiments 89-92, wherein the microbe is selected from the group consisting of a fungus, a bacterium, an archaea, a protist and any combination thereof.

Embodiment 94. The bread of embodiment 93, wherein the microbe is a fungus selected from the group consisting of a yeast or filamentous fungus.

Embodiment 95. The bread of embodiment 94, wherein the yeast is a Pichia species or Saccharomyces species.

Embodiment 96. The bread of embodiment 95, wherein the yeast is Saccharomyces cerevisiae.

Embodiment 97. The method of embodiment 92, wherein the plant biomass is obtained from flour, grains, seeds, tubers, roots, stalks, shoots or other agricultural byproducts.

Embodiment 98. The bread of any one of embodiments 89-97, wherein the bread comprises 5, 6, 7, 8, 9, 10, 11, 12, 13, 14, 15, 16, 17, 18, 19, 20, 21, 22, 23, 24, 25, 26, 27, 28, 29 or 30 grams (g) of total protein per serving.

Embodiment 99. The bread of embodiment 98, wherein the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g).

Embodiment 100. The bread of embodiment 98, wherein the bread comprises 9 g of total protein per serving, wherein the serving is selected from the group consisting of 48 g, 51 g, and 56 g.

Embodiment 101. The bread of embodiment 98, wherein the bread comprises 10 g of total protein per serving, wherein the serving is selected from the group consisting of 48 g, 51 g, and 56 g.

Embodiment 102. The bread of any one of embodiments 89-101, wherein the bread comprises 14 g of carbohydrate per serving, wherein the serving is 48 g.

Embodiment 103. The bread of embodiment 102, wherein the bread comprises 10 g of protein per serving.

Embodiment 104. The bread of any one of embodiments 89-103, wherein the bread comprises 10 g of protein and 14 g of carbohydrate per serving, wherein the serving is 48 g.

Embodiment 105. The bread of any one of embodiments 89-104, wherein the bread comprises 15 g of carbohydrate per serving, wherein the serving is 51 g.

Embodiment 106. The bread of embodiment 105, wherein the bread comprises 10 g of protein per serving.

Embodiment 107. The bread of any one of embodiments 89-106, wherein the bread comprises 10 g of protein with 15 g carbohydrate per serving, wherein the serving is 51 g.

Embodiment 108. A pasta comprising a protein obtained from a microbe, wherein the water holding capacity (WHC) of the protein is no greater than 144 g of water per 100 g of protein.

Embodiment 109. The pasta of embodiment 108, wherein the pasta consists essentially of, consists of or comprises at least 10%, 11%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% w/w of the protein obtained from the microbe.

Embodiment 110. The pasta of embodiment 108, wherein the pasta consists essentially of, consists of or comprises from 10%-15%, from 15%-20%, from 20%-25%, from 25%-30%, from 30%-35%, from 35%-40%, from 40%-45% or from 45%-50% w/w of the protein obtained from the microbe.

Embodiment 111. The pasta of any one of embodiments 108-110, wherein the pasta further comprises a fiber.

Embodiment 112. The pasta of embodiment 111, wherein the pasta comprises 3, 3.5, 4, 4.5, 5, 5.5, 6, 6.5, 7, 7.5, 8, 8.5, 9, 9.5 or 10% w/w.

Embodiment 113. The pasta of any one of embodiments 108-112, wherein the protein content of the pasta is greater than 17%.

Embodiment 114. The pasta of any one of embodiments 108-113, wherein the PDCAAS value of the pasta is greater than 0.7.

Embodiment 115. The pasta of any one of embodiments 108-114, wherein after cooking the pasta the content of carbohydrates in the pasta is not greater than 64 grams of carbohydrates per 100 grams of cooked pasta.

Embodiment 116. The pasta of any one of embodiments 108-115, wherein the loss of weight occurring when the pasta is cooked is not greater than 6.5 percent.

Embodiment 117. The pasta of any one of embodiments 108-116, wherein firmness and al dente chewing properties of the pasta are retained when the cooking time of the pasta is extended longer than a recommended cooking time when the pasta is cooked at a desired temperature in water.

Embodiment 118. The pasta of embodiment 117, wherein the cooking time is extended by greater than 1%, 2%, 3%, 4%, 5%, 6%, 7%, 8%, 9%, 10%, 11%, 12%, 13%, 14%, 15%, 20%, 25%, 30%, 35%, 40%, 45%, 50%, 55%, 60%, 65%, 70%, 75%, 80%, 85%, 90%, 95%, 99% or 100% of the recommended cooking time.

Embodiment 119. The pasta of embodiment 117, wherein the cooking time is extended by between 1%-5%, between 5%-10%, between 15%-20%, between 20%-25%, between 25%-30%, between 30%-35%, between 35%-40%, between 40%-45%, between 45%-50%, between 50%-55%, between 55%-60%, between 60%-65%, between 65%-70%, between 70%-75%, between 75%-80%, between 80%-85%, between 85%-90%, between 90%-95%, or between 95%-100% of the recommended cooking time.

Embodiment 120. The pasta of any one of embodiments 117-119, wherein the recommended cooking time is the cooking time required to reach optimal or desired al dente properties.

Embodiment 121. The pasta of any one of embodiments 117-120, wherein the desired temperature is boiling.

Embodiment 122. The pasta of embodiment, 108, wherein firmness of the pasta is greater than 600 grams, 605 grams, 610 grams, 615 grams, 620 grams, 625 grams, 630 grams, 635 grams, 640 grams, 645 grams, 650 grams, 655 grams, 660 grams, 665 grams or 670 grams after cooking in boiling water for a desired period of time.

Embodiment 123. The pasta of embodiment 108 wherein firmness of the pasta is between 600 grams-610 grams, between 610 grams-620 grams, between 620 grams-630 grams, between 630 grams-640 grams, between 640 grams-650 grams, between 650 grams-660 grams or between 660 grams-670 grams after cooking in boiling water for a desired period of time.

Embodiment 124. The pasta of any one of embodiments 108 or 122-123, wherein the shear value of the pasta is between 50-55 g/cm, between 55-60 g/cm, between 60-65 g/cm, between 65-70 g/cm, between 70-75 g/cm, between 75-80 g/cm, between 80-85 g/cm, between 85-90 g/cm, between 90-95 g/cm, between 95-100 g/cm, between 100-105 g/cm, between 105-110 g/cm, between 115-120 g/cm, between 120-125 g/cm, between 125-130 g/cm, between 130-135 g/cm, between 135-140 g/cm, between 140-145 g/cm, between 145-150 g/cm, between 150-155 g/cm, between 155-160 g/cm, between 165-170 g/cm or between 170-175 g/cm after cooking in boiling water for a desired period of time.

Embodiment 125. The pasta of any one of embodiments 108 or 122-123 embodiment, wherein the shear value of the pasta is at least 50 g/cm, at least 55 g/cm, at least 60 g/cm, at least 65 g/cm, at least 70 g/cm, at least 75 g/cm, at least 80 g/cm, at least 85 g/cm, at least 90 g/cm, at least 95 g/cm, or at least 100 g/cm after cooking in boiling water for a desired period of time.

Embodiment 126. The pasta of any one of embodiments 108-120, wherein the shear value of the pasta is greater than 90 g/cm after cooking in boiling water for a desired period of time.

Embodiment 127. The pasta of any one of embodiments 122-126, wherein the desired period of time is 3, 4, 5, 6, 7, 8, 9, 10, 11, 12, 13, 14 or 15 minutes.

Embodiment 128. The pasta of embodiment 127, wherein the desired period of time is between 3-5 minutes, between 5-7 minutes, between 7-9, between 9-11, between 11-13 minutes or between 13-15 minutes.

Embodiment 129. The pasta of any one of embodiments 108-128, further comprising a PDCAAS value at least 0.7, at least 0.75, at least 0.80, at least 0.85, at least 0.9, at least 0.95 or at least 1.

Embodiment 130. The pasta of any one of embodiments 108-128, further comprising a PDCAAS value between 0.7-0.80, between 0.80-0.85, between 0.85-0.9, between 0.9-0.95 or between 0.95-1.

Embodiment 131. The pasta of any one of embodiments 108-128, further comprising a PDCAAS value greater than 0.7.

Embodiment 132. The pasta of any one of embodiments 108-131, wherein the pasta comprises an amino acid distribution profile of between 15% to 50% or between 25% to 50% branched chain amino acids (BCAAs).

Embodiment 133. The pasta of any one of embodiments 108-132, wherein the protein content is at least 5, 10, 15, 20, 25, 30, 35, 40, 45, 50 or 55 g/serving.

Embodiment 134. The pasta of any one of embodiments 108-132, wherein the protein content is 8 g or 25 g per/serving.

Embodiment 135. The pasta of embodiment 133 or 134, wherein the serving is 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g).

Embodiment 136. The pasta of embodiment 133 or 134, wherein the serving is 56 g.

Embodiment 137. The pasta of any one of embodiments 108-136, wherein the pasta is resistant to excessive swelling of starch in the pasta.

Embodiment 138. A powder comprising a protein with a desired property, wherein the desired property is an amino acid distribution profile of between 15% to 50% branched chain amino acids (BCAAs), and wherein the protein is obtained from a non-animal source.

Embodiment 139. The powder of embodiment 138, wherein the protein possesses a WHC selected from the group consisting of at least 85 g of water per 100 g of the protein powder, at least 90 g of water per 100 g of the protein powder, at least 95 g of water per 100 g of the protein powder, at least 100 g of water per 100 g of the protein powder, at least 105 g of water per 100 g of the protein powder, at least 110 g of water per 100 g of the protein powder, at least 115 g of water per 100 g of the protein powder, at least 120 g of water per 100 g of the protein powder, at least 125 g of water per 100 g of the protein powder, at least 130 g of water per 100 g of the protein powder and from 80 to 150 grams (g) of water per 100 g of protein powder.

Embodiment 140. The powder of embodiment 138 or 139, wherein the protein is a plant protein, a microbial protein or a combination thereof.

Embodiment 141. The powder of any one of embodiments 138-140, wherein the protein is a plant protein obtained or isolated from an angiosperm, gymnosperm or fern.

Embodiment 142. The powder of any one of embodiments 138-140, wherein the protein is a microbial protein obtained or isolated from the fermentation of biomass by a microbe.

Embodiment 143. The powder of embodiment 142, wherein the microbe is selected from the group consisting of a fungus, a bacterium, an archaea, a protist and any combination thereof.

Embodiment 144. The powder of embodiment 142 or 143, wherein the microbe is a fungus selected from the group consisting of a yeast or filamentous fungus.

Embodiment 145. The powder of embodiment 144, wherein the yeast is a Pichia species or Saccharomyces species.

Embodiment 146. The powder of embodiment 144 or 145, wherein the yeast is Saccharomyces cerevisiae.

Embodiment 147. The powder of embodiment 143, wherein the microbe is a bacterium selected from the group consisting of a Lactobacillus bacterium, a Bacillus bacterium, a Bifidobacterium bacterium, a Clostridium bacterium, an Enterococcus bacterium, a Corynebacterium bacterium and any combination thereof.

Embodiment 148. The powder of embodiment 143 or 147, wherein the bacterium is Corynebacterium glutamicum, Clostridium acetobutylicum or a combination thereof.

Embodiment 149. The powder of embodiment 142, wherein the biomass is spent yeast or microbial biomass from fermented products manufacturing facilities.

Embodiment 150. The powder of embodiment 142, wherein the biomass is a plant biomass.

Embodiment 151. The powder of embodiment 150, wherein the plant biomass is selected from the group consisting of a food crop, an extract of a food crop, seaweed, plankton, phytoplankton, grass crops, agricultural crop waste and residues, spent grain from ethanol production, or spent grain from breweries, trees, woody energy crops and wood waste and residue.

Embodiment 152. The powder of embodiment 151, wherein the food crop is selected from the group consisting of sugarcane, wheat, tubers, vegetables, lentils, kelp, legumes, soybeans, rice, potato, oats, pea, cassava and maize.

Embodiment 153. The powder of embodiment 151, wherein the agricultural crop waste and residue is selected from the group consisting of corn stover, wheat straw, rice straw and sugar cane bagasse.

Embodiment 154. The powder of embodiment 151, wherein the wood waste and residue is selected from the group consisting of softwood forest matter, barky wastes, sawdust, paper and pulp industry waste streams and wood fiber.

Embodiment 155. The powder of any one of embodiments 138-154, wherein the powder comprises 5, 6, 7, 8, 9, 10, 11, 12, 13, 14, 15, 16, 17, 18, 19, 20, 21, 22, 23, 24, 25, 26, 27, 28, 29 or 30 grams (g) of the protein per serving.

Embodiment 156. The powder of embodiment 155, wherein the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g).

Embodiment 157. The powder of any one of embodiments 138-156, wherein the protein has a Solvent Retention Capacity (SRC) of at least 60%, at least 70%, at least 80%, at least 90% or at least 100%.

Embodiment 158. The powder of any one of embodiments 138-157, wherein the protein has a Protein Digestibility-Corrected Amino Acid Score (PDCAAS) of at least 0.6, at least 0.7, at least 0.8, at least 0.9 or at least 1.0.

Embodiment 159. The powder of any one of embodiments 138-158, wherein the protein comprises an amino acid distribution profile of between 20% to 50% or between 25% to 50% essential amino acids (EAAs).

1. A method for producing the powder of claim 28 using an aqueous extraction method comprising:
(a) mixing protein obtained from a biomass in water at a defined ratio to generate a slurry comprising a protein of interest, wherein the defined ratio of protein to water is 1:1, or 1:2, 1:3, 1:4, 1:5, 1:6, 1:7, 1:8, 1:9, 1:10, 1:11, 1:12, 1:13, 1:14, 1:15 or 1:16, 1:17, 1:18, 1:19, or 1:20 w/w; and
(b) subjecting the slurry to one or more of:
(i) adding an acid or base to adjust the pH of the slurry to a desired pH;
(ii) altering the temperature of the slurry to a desired temperature;
(iii) adding a salt to the slurry to a desired % of salt in the slurry;
(iv) milling the slurry in order to shear the protein of interest in the slurry; or
(v) adding one or more hydrolases to the slurry in order to hydrolyze biological components of the slurry that include the protein of interest and carbohydrates, thereby generating the powder comprising the protein comprising the desired property.

2. The method of claim 1, wherein the desired pH is from pH 3 to 10.5.

3. The method of claim 1, wherein the desired temperature is 70, 75, 80, 85, 90 or 95 degrees Celsius.

4. The method of claim 3, wherein the slurry is incubated at the desired temperature for at least 30 minutes.

5. The method of claim 1, wherein the desired % of salt is 5% w/w, wherein the salt is sodium chloride or sodium sulfate.

6.-7. (canceled)

8. The method of claim 1, further comprising testing the protein of interest for the desired property and repeating steps (a) and (b) until the protein comprising the desired property is achieved.

9. (canceled)

10. The method of claim 1, further comprising: filtering the slurry to recover solids comprising the protein of interest; and drying the protein of interest following the filtering in order to produce the protein powder comprising the protein comprising the desired property.

11.-27. (canceled)

28. A powder comprising a protein with a desired property, wherein the desired property is an amino acid distribution profile of between 15% to 50% branched chain amino acids (BCAAs) or a water holding capacity (WHC) selected from the group consisting of at least 80 grams (g) of water per 100 g of protein powder, at least 85 g of water per 100 g of the protein powder, at least 90 g of water per 100 g of the protein powder, at least 95 g of water per 100 g of the protein powder, at least 100 g of water per 100 g of the protein powder, at least 105 g of water per 100 g of the protein powder, at least 110 g of water per 100 g of the protein powder, at least 115 g of water per 100 g of the protein powder, at least 120 g of water per 100 g of the protein powder, at least 125 g of water per 100 g of the protein powder, at least 130 g of water per 100 g of the protein powder and from 80 to 150 grams (g) of water per 100 g of protein powder, and wherein the protein is obtained from a non-animal source.

29.-30. (canceled)

31. The powder of claim 28, wherein the protein is a plant protein, a microbial protein or any combination thereof.

32.-34. (canceled)

35. The powder of claim 31, wherein the protein is a microbial protein obtained or isolated from the fermentation of biomass by a microbe.

36.-38. (canceled)

39. The powder of claim 35, wherein the microbe is Saccharomyces cerevisiae.

40. The powder of claim 35, wherein the microbe is a bacterium selected from the group consisting of a Lactobacillus bacterium, a Bacillus bacterium, a Bifidobacterium bacterium, a Clostridium bacterium, an Enterococcus bacterium, a Corynebacterium bacterium and any combination thereof.

41. (canceled)

42. The powder of claim 35, wherein the biomass is a plant biomass and/or spent yeast or microbial biomass from fermented products manufacturing facilities.

43.-47. (canceled)

48. The powder of claim 28, wherein the powder comprises 5, 6, 7, 8, 9, 10, 11, 12, 13, 14, 15, 16, 17, 18, 19, 20, 21, 22, 23, 24, 25, 26, 27, 28, 29 or 30 grams (g) of the protein per serving, and wherein the serving is 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95 or 100 grams (g).

49.-50. (canceled)

51. The powder of claim 28, wherein the protein has a Protein Digestibility-Corrected Amino Acid Score (PDCAAS) of at least 0.6, at least 0.7, at least 0.8, at least 0.9 or at least 1.0.

52. (canceled)

53. The powder of claim 28, wherein the protein comprises an amino acid distribution profile of between 20% to 50% or between 25% to 50% essential amino acids (EAAs).

54. A composition comprising a flour and the powder of claim 28.

55. (canceled)

56. The composition of claim 54, wherein the flour and the powder are present at a ratio of flour to powder that produces a WHC that is from 100% to 150% of the WHC of the flour alone.

57.-88. (canceled)

89. A bread comprising a protein obtained from a microbe, wherein the protein has a water holding capacity (WHC) of at least 80 g of water per 100 g of protein.

90.-107. (canceled)

108. A pasta comprising a protein obtained from a microbe, wherein the water holding capacity (WHC) of the protein is no greater than 144 g of water per 100 g of protein.

109.-159. (canceled)
